(19) United States
(12) Patent Application Publication
(10) Pub. No.: US 2021/0327009 A1
(43) Pub. Date: Oct. 21, 2021

(54) SYSTEM AND METHOD FOR STUDENT ATTENDANCE MANAGEMENT

(71) Applicant: SCHOOL INNOVATIONS & ACHIEVEMENT, INC., El Dorado Hills, CA (US)

(72) Inventors: Jeffrey C. Williams, El Dorado Hills, CA (US); Susan Cook, Rio Linda, CA (US)

(21) Appl. No.: 17/246,622

(22) Filed: May 1, 2021

Related U.S. Application Data
(63) Continuation-in-part of application No. 15/702,406, filed on Sep. 12, 2017, now Pat. No. 11,062,410.
Application No. 15/702,406 is a continuation-in-part of application No. 15/343,039, filed on Nov. 3, 2016, now Pat. No. 10,963,845.
Application No. 15/343,039 is a continuation-in-part of application No. 14/250,314, filed on Apr. 10, 2014, now Pat. No. 9,767,440.

(51) Int. Cl. G06Q 50/20; G06Q 10/10; G06Q 30/02; G06F 16/25; H04W 4/12

(52) U.S. Cl. CPC G06Q 50/205; G06Q 10/1095; H04W 4/12; G06F 16/258; G06Q 30/0201

(57) ABSTRACT

A system and method for student attendance management are disclosed. A particular embodiment includes: installing a site-resident data collection module in a site location, the site-resident data collection module including instructions executing within an executable environment of the site location, the site-resident data collection module further including a first data interface enabling data communication between the site-resident data collection module and a legacy data processing system of the site location; using the site-resident data collection module to collect student information, attendance data, and other site data from the site location; transferring the site data to a host location; performing, by a data processor, data transformation and normalization operations on the site data to convert the site data to a common format, the data transformation and normalization operations including district-specific data transformation rules; performing, by the data processor, district configuration operations to configure rules specifying how and when alerts can be sent to recipients based on the site data; performing, by the data processor, scheduling and reporting operations to generate and distribute alerts, including attendance letters, to recipients based on the site data and the configured rules; and creating and sending custom text messages to recipients based on the site data.

### PRIORITY PATENT APPLICATIONS

This is a continuation-in-part (CIP) patent application of U.S. patent application Ser. No. 15/702,406, filed Sep. 12, 2017; which is a continuation-in-part of Ser. No. 15/343,039, filed Nov. 3, 2016 by the same applicant; which is a continuation-in-part patent application of U.S. patent application Ser. No. 14/250,314; filed Apr. 10, 2014 by the same applicant. The present patent application draws priority from the referenced patent applications. The entire disclosure of the referenced patent applications is considered part of the disclosure of the present application and is hereby incorporated by reference herein in its entirety.

### TECHNICAL FIELD

This patent application relates to computer-implemented software and networked systems, according to one embodiment, and more specifically to a system and method for student attendance management.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2012-2021 School Innovations & Achievement Inc., All Rights Reserved.

### BACKGROUND

In recent years, numerous states have passed laws requiring school districts to more closely monitor student attendance and truancy. This includes monitoring students who are chronically truant and frequently absent from the classroom. Many school districts are instituting new policies regarding permitted absenteeism and redefining unacceptable truancy. These laws and policies require that schools take certain specified actions immediately upon a student reaching a threshold of unacceptable truancy. However, due to lack of funding, shortage of personnel, and lack of availability of sophisticated technology, most schools and school districts are ill-equipped to compare, analyze and measure the effectiveness with the goal of improving student attendance.

Additionally, each school within a school district can track attendance in a different manner, using different absence codes. Further, schools across a school district do not always label an “unexcused absence” as recognized by state law or school district policy as an absence, but rather as a tardy, late arrival, early dismissal, and medical excuse without documentation, among others. Such variance among attendance tracking also makes it nearly impossible for school districts to correctly track truancy and take appropriate, timely action as required by their own policies and by state law.

Finally, monetary incentives, reimbursements and other funding for schools are often linked in one way or another to student enrollment and attendance. Thus, districts unable to implement systems for reliable and continuous attendance tracking will be unable to maximize the monetary benefits received.

### BRIEF DESCRIPTION OF THE DRAWINGS

The various embodiments are illustrated by way of example, and not by way of limitation, in the figures of the accompanying drawings in which:

FIG. 1 illustrates an example embodiment of a student attendance management system in a network-enabled ecosystem;

FIG. 2 illustrates an example embodiment of the student attendance management system including a site-resident data collection module configured to execute within an executable environment of a site location;

FIGS. 3 and 4 are flow diagrams illustrating the letter printing workflow in an example embodiment;

FIGS. 5 and 6 are flow diagrams illustrating the conference scheduling workflow in an example embodiment;

FIG. 7 illustrates another example embodiment of a networked system in which various embodiments may operate;

FIG. 8 is a processing flow chart illustrating an example embodiment of a method as described herein;

FIG. 9 shows a diagrammatic representation of machine in the example form of a computer system within which a set of instructions when executed may cause the machine to perform any one or more of the methodologies discussed herein;

FIG. 10 is an operational or processing flow chart illustrating an example embodiment of a method as described herein for block conferencing workflow;

FIG. 11 is an operational or processing flow chart illustrating an example embodiment of a method as described herein for configuring bulk status and conference updates;

FIG. 12 is an operational or processing flow chart illustrating an example embodiment of a method as described herein for configuring the Got New Triggers feature;

FIG. 13 is an operational or processing flow chart illustrating an example embodiment of a method as described herein for effecting additional student filters;

FIG. 14 is an operational or processing flow chart illustrating an example embodiment of a method as described herein for automatic Attendance Improvement Plan (AIP) configuration;

FIG. 15 is an operational or processing flow chart illustrating an example embodiment of a method as described herein for effecting a chronic student absence flag;

FIG. 16 is an operational or processing flow chart illustrating an example embodiment of a method as described herein for generating a fiscal year report;

FIG. 17 is an operational or processing flow chart illustrating an example embodiment of a method as described herein for generating an attendance summary report;

FIG. 18 is an operational or processing flow chart illustrating an example embodiment of a method as described herein for effecting updates to important dates to accommodate year-round sites;

FIG. 19 is an operational or processing flow chart illustrating an example embodiment of a method as described herein for generating a student overview report;

FIG. 20 is an operational or processing flow chart illustrating an example embodiment of a method as described herein for effecting changes to optional letter configurations;

FIGS. 21 through 32 illustrate the additional features and enhancements for the My Dashboard User Interface (UI) supported by an example embodiment;

FIGS. 33 through 40 illustrate the additional features and enhancements for the Configurator supported by an example embodiment;

FIGS. 41 through 48 illustrate the additional features and enhancements for the texting features supported by an example embodiment;

FIGS. 49 through 57 illustrate the additional features and enhancements for the Student Tags supported by an example embodiment;

FIGS. 58 through 65 illustrate the additional features and enhancements for the reports and letter generation features supported by an example embodiment;

FIGS. 66 through 68 illustrate the additional features and enhancements for the Student Overview features supported by an example embodiment; and

FIG. 69 illustrates the additional features and enhancements for the Student Tags Filter for Optional Letters features supported by an example embodiment.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In the various embodiments described herein, a system and method for student attendance management are disclosed. The various embodiments provide the ability to detect chronic absenteeism early, and then intervene or deter chronic absenteeism before it affects monetary distributions or results in drop out, which would otherwise result in decreased enrollment (also negatively impacting a school's financial resources). The various embodiments also standardize absence records of all schools within a school district and all districts in a given area, automatically track absences on a daily basis, and provide automatic and prompt notification when an individual student's truancy reaches a threshold requiring a response.

In various embodiments described in detail below, a software application program is used to gather, process, and distribute school information, including attendance data, using a computer system, a web appliance, and/or a mobile device. As described in more detail below, the computer or computing system on which the described embodiments can be implemented can include personal computers (PCs), portable computing devices, laptops, tablet computers, personal digital assistants (PDAs), personal communication devices (e.g., cellular telephones, smartphones, or other wireless devices), network computers, set-top boxes, consumer electronic devices, or any other type of computing, data processing, communication, networking, or electronic system.

### Overview of an Example Embodiment

An example embodiment as described herein is a student attendance management network focused on the gathering, processing, and distribution of school information, including attendance data. The processing of the school district data can prevent or substantially reduce future K-12 student absences. In the embodiments described herein, there is a consistent, defined process that when followed, dramatically reduces the number of student absences. This process uses a combination of student data collected at the school sites, customized database scripts, custom application code, and letter printing processes. This process as a whole is referred to as Attention2Attendance or A2A.

In the example embodiments described herein, data is extracted from the school student information systems using a site-resident data collection module. This data can be extracted using pre-defined database select and join statements allowing the relevant student information to be accessed and retrieved. This data is then transferred to a host system using the site-resident data collection module and a host-resident data collection module as described in more detail below.

At the host site, the school student information can be normalized and otherwise transformed into a consistent form. A data transformation module uses customized rules and processes to aggregate the data into a common format. Because each school district can uniquely set up and store their data, this normalization and data transformation process is specific for each district. The normalized data is then uploaded into host databases. This upload can use standard database scripts and processes. The databases described herein can be implemented using well-known applications or systems, such as Microsoft® Access or Excel, SQL, spreadsheets, tables, flat files, or any other type of structured data storage.

Once the normalized school student information is resident in the host database, the scheduler and reporting modules of an example embodiment can be used to generate notifications based on prescribed rules. In a particular embodiment, specific rules and alerts can be set up within the student attendance management system to identify trends, events, and instances when a student, a school, or a district should be notified of an identified situation. These notifications are the drivers for improving school attendance. The specific rules and alerts can be pre-defined within the student attendance management system application. These rules and alerts can be customized to address specific school district needs if requested. In some cases, some notifications can be suppressed or delayed to implement a pre-defined policy. In most cases, the notifications are sent on regular intervals to ensure consistency. A district configuration module can be used to specify the particular rules and processes used to generate and distribute notifications. For example, the manner of distribution (e.g., physical letter, email, or the like) can be pre-defined in a configurable way.

### Details of an Example Embodiment

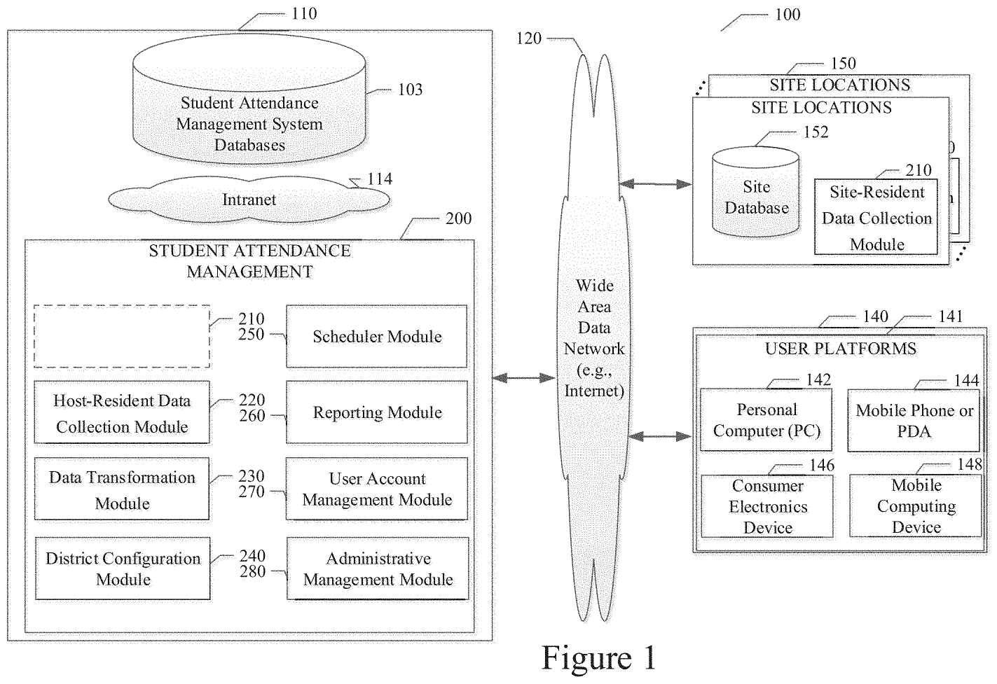

Referring now to FIG. 1, in an example embodiment, a system for student attendance management 100 in a network-enabled ecosystem is disclosed. In various example embodiments, an application or service, typically provided by or operating on a host site (e.g., a website) 110, is provided to simplify and facilitate the downloading or hosted use of the student attendance management system 200 of an example embodiment. In a particular embodiment, the student attendance management system 200, or a portion thereof, can be downloaded from the host site 110 by a user at a user platform 140. Alternatively, the student attendance management system 200 can be hosted by the host site 110 for a networked user at a user platform 140. The details of the student attendance management system 200 of an example embodiment are provided below.

Referring again to FIG. 1, the student attendance management system 200 can be in network communication with a plurality of user platforms 140. The host site 110 and user platforms 140 may communicate and transfer data and information in the data network ecosystem 100 shown in FIG. 1 via a wide area data network (e.g., the Internet) 120. Various components of the host site 110 can also communicate internally via a conventional intranet or local area network (LAN) 114.

In an example embodiment, the student attendance management system 200 can also be in network communication with a plurality of site locations 150. Site locations 150 can represent school district offices or school administrative offices where student information and attendance data is stored in site databases. As conventionally done in existing schools and district offices, student attendance data is recorded in site databases 152. Unfortunately, the attendance data in these site databases can be inaccurate, incomplete, recorded in non-standard data formats, recorded in non-standard data structures or databases, or otherwise rendered very difficult to reconcile and combine with data from other sites. As described in more detail below, the various embodiments disclosed herein can retrieve, reformat, re-structure, and process the site data to produce useful information aggregated among a plurality of districts, schools, and other site locations.

Networks 120 and 114 are configured to couple one computing device with another computing device. Networks 120 and 114 may be enabled to employ any form of computer readable media for communicating information from one electronic device to another. Network 120 can include the Internet in addition to LAN 114, wide area networks (WANs), direct connections, such as through an Ethernet port or a universal serial bus (USB) port, other forms of computer-readable media, or any combination thereof. On an interconnected set of LANs, including those based on differing architectures and protocols, a router and/or gateway device acts as a link between LANs, enabling messages to be sent between computing devices. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communication links known to those of ordinary skill in the art. Furthermore, remote computers and other related electronic devices can be remotely connected to either LANs or WANs via a wireless link, WiFi, Bluetooth, satellite, or modem and temporary telephone link.

Networks 120 and 114 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 120 and 114 may also include an autonomous system of terminals, gateways, routers, and the like connected by wireless radio links or wireless transceivers. These connectors may be configured to move freely and randomly and organize themselves arbitrarily, such that the topology of networks 120 and 114 may change rapidly and arbitrarily.

Networks 120 and 114 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as one or more of client devices 141, with various degrees of mobility. For example, networks 120 and 114 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 120 and 114 may also be constructed for use with various other wired and wireless communication protocols, including TCP/IP, UDP, SIP, SMS, RTP, WAP, CDMA, TDMA, EDGE, UMTS, GPRS, GSM, UWB, WiFi, WiMax, IEEE 802.11x, and the like. In essence, networks 120 and 114 may include virtually any wired and/or wireless communication mechanisms by which information may travel between one computing device and another computing device, network, and the like. In one embodiment, network 114 may represent a LAN that is configured behind a firewall (not shown), within a business data center, for example.

The student attendance management system can be implemented using any form of network transportable digital data. The network transportable digital data can be transported in any of a group of file formats, protocols, and associated mechanisms usable to enable a host site 110 and a user platform 140 to transfer data over a network 120. In one embodiment, the data format for the user interface can be HyperText Markup Language (HTML). HTML is a common markup language for creating web pages and other information that can be displayed in a web browser. In another embodiment, the data format for the user interface can be Extensible Markup Language (XML). XML is a markup language that defines a set of rules for encoding interfaces or documents in a format that is both human-readable and machine-readable. In another embodiment, a JSON (JavaScript Object Notation) format can be used to stream the interface content to the various user platform 140 devices. JSON is a text-based open standard designed for human-readable data interchange. The JSON format is often used for serializing and transmitting structured data over a network connection. JSON can be used in an embodiment to transmit data between a server, device, or application, wherein JSON serves as an alternative to XML. The Hypertext Transfer Protocol (HTTP) or secure HTTP (HTTPS) can be used as a network data communication protocol.

In a particular embodiment, a user platform 140 with one or more client devices 141 enables a user to access data and provide data and/or instructions for the student attendance management system 200 via the host 110 and network 120. Client devices 141 may include virtually any computing device that is configured to send and receive information over a network, such as network 120. Such client devices 141 may include portable devices 144, such as, cellular telephones, smart phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. Client devices 141 may also include other computing devices, such as personal computers 142, multiprocessor systems, microprocessor-based or programmable consumer electronics, network PC's, and the like. Client devices 141 may also include other processing devices, such as consumer electronic (CE) devices 146 and/or mobile computing devices 148, which are known to those of ordinary skill in the art. As such, client devices 141 may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and many lines of color LCD display in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and/or send digital information. In other embodiments, mobile devices can be configured with applications (apps) with which the functionality described herein can be implemented.

Client devices 141 may also include at least one client application that is configured to send and receive content data or/or control data from another computing device via a wired or wireless network transmission. The client application may include a capability to provide and receive textual data, graphical data, video data, audio data, and the like. Moreover, client devices 141 may be further configured to communicate and/or receive a message, such as through an email application, a Short Message Service (SMS), direct messaging (e.g., Twitter), Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like.

As one option, the student attendance management system 200, or a portion thereof, can be downloaded to a user device 141 of user platform 140 and executed locally on a user device 141. The downloading of the student attendance management system 200 application (or a portion thereof) can be accomplished using conventional software downloading functionality. As a second option, the student attendance management system 200 can be hosted by the host site 110 and executed remotely, from the user's perspective, on host system 110. In one embodiment, the student attendance management system 200 can be implemented as a service in a service-oriented architecture (SOA) or in a Software-as-a-Service (SAAS) architecture. In any case, the functionality performed by the student attendance management system 200 is as described herein, whether the application is executed locally or remotely, relative to the user.

Referring again to FIG. 1, the host site 110 and student attendance management system 200 of an example embodiment is shown to include a student attendance management system database 103. The database 103 is used in an example embodiment for data storage of information related to district records, school records, student records, attendance data, letter templates, calendar data, configuration data, scheduling data, reporting data, and the like. It will be apparent to those of ordinary skill in the art that the database 103 can represent multiple datasets and can be used for the storage of a variety of data in support of the student attendance management system 200 of an example embodiment.

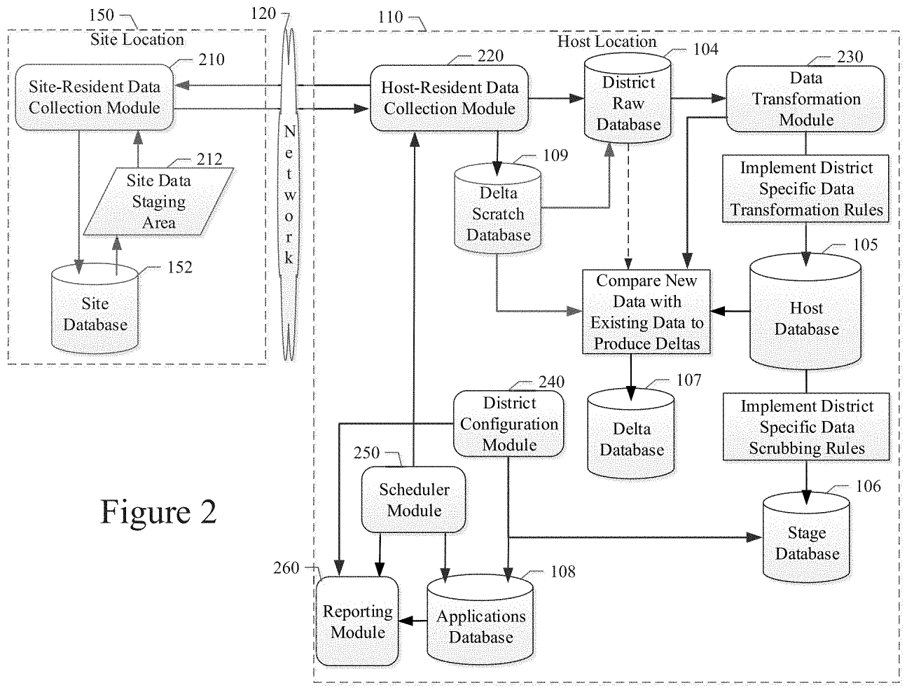

Referring again to FIG. 1, host site 110 of an example embodiment is shown to include student attendance management system 200. Student attendance management system 200 can include a site-resident data collection module 210, a host-resident data collection module 220, a data transformation module 230, a district configuration module 240, a scheduler module 250, a reporting module 260, a user account management module 270, and an administrative management module 280. Each of these modules can be implemented as software components executing within an executable environment of student attendance management system 200 operating on host site 110 or user platform 140. As shown in FIGS. 1 and 2, the site-resident data collection module 210 of an example embodiment can be configured to execute within an executable environment of site location 150. Each of these modules of an example embodiment is described in more detail below in connection with the figures provided herein.

Referring to FIGS. 1 and 2, the student attendance management system 200 of an example embodiment can include a site-resident data collection module 210. As described above, the site-resident data collection module 210 of an example embodiment can be configured to execute within an executable environment of site location 150. The site-resident data collection module 210 is configured to interface with a legacy system running at a particular district site or school location 150. The site-specific legacy system performs the standard collection and processing of student information and attendance data for the specific site and stores the data in a site database 152. Because the site-specific data stored in the site database 152 can be in an arbitrary format, incomplete, or inaccurate, the site-resident data collection module 210 is used to extract, collect, and marshal the site-specific data for transfer to the host-resident data collection module 220. In an example embodiment, the site-resident data collection module 210 can be a downloaded or otherwise installed executable that runs on the legacy system at a particular district site or school location 150. The site-resident data collection module 210 can also be a pre-installed executable, a dynamically installed plug-in, a mobile application (app), or a dynamically linked element that runs on the legacy system at a particular district site or school location 150. The site-resident data collection module 210 can be configured to check and verify that needed processing and memory space is available on the site's legacy system. Once the site-resident data collection module 210 is up and running on the site system, the site-resident data collection module 210 can access the site database 152 and validate and review the data structures and schema being used in the site database 152. In this manner, the site-resident data collection module 210 can dynamically determine the database record structures and record attributes being used for the particular site. Once the site database 152 structure is determined, the site-resident data collection module 210 can run a test data request with a configurable XML extraction document. The test data request can be configured by an administrator at the site or at the host location. The test data request is used to confirm that the site database 152 structure has been properly determined by the site-resident data collection module 210. At the conclusion of this test, the site-resident data collection module 210 is ready to begin transferring site-specific data to the host location 110.

Referring again to FIGS. 1 and 2, the student attendance management system 200 of an example embodiment can include a host-resident data collection module 220. The host-resident data collection module 220 cooperates with the site-resident data collection module 210 to periodically transfer site-specific data to the host location 110. The host-resident data collection module 220 and the site-resident data collection module 210 can be configured to wake up at pre-determined times to transfer any data updates that may have occurred since the prior data transfer. In this manner, the host location 110 and the host-resident data collection module 220 therein can receive timely updates of student and attendance information being changed at a particular site. These updates can occur with little, if any, involvement by site-specific resources.

The site-resident data collection module 210 can be configured to interface with and collect data from a wide variety of different site-specific legacy systems. Such legacy systems can be hosted, non-hosted, distributed, internal systems, and/or the like. The site-resident data collection module 210 can collect the data in a site data staging area 212, where the data is encrypted, zipped, and delivered to the host-resident data collection module 220 via a secure network 120 connection (e.g., HTTPS). In one embodiment, the data can be delivered to the host-resident data collection module 220 via an encrypted data file.

The site-resident data collection module 210 can be configured to receive a request from the host-resident data collection module 220 for an immediate data update. In this way, the host-resident data collection module 220 can trigger an ad hoc data update from the site location 150 at a time of the host location's 110 choosing. Thus, as described above, the site-resident data collection module 210 and the host-resident data collection module 220 can operate collaboratively to effect the transfer of raw site-specific data from the site location 150 and the site database 152 therein to the host location 110. This raw site-specific data (denoted herein as raw district data) can be transferred to a district raw database 104 and a delta scratch database 109 at host location 110 by the host-resident data collection module 220. In the example embodiment, the raw district data can be decompressed, decrypted, and stored in district raw database 104 and made available to the other processing modules of host location 110. The data in the delta scratch database 109 can be used in the process to identify changes in the received data. At each data collection interval, each new set of raw district data can replace and overwrite a prior set of raw district data stored in district raw database 104 and delta scratch database 109.

Referring again to FIGS. 1 and 2, the student attendance management system 200 of an example embodiment can include a data transformation module 230. The data transformation module 230 has access to the raw district data stored in district raw database 104. The raw district data can comprise student information, attendance data, school or district information, and other information specific to site location 150. Because this raw district data can be in an arbitrary format, incomplete, or inaccurate, the data transformation module 230 is used to normalize and otherwise transform the raw district data into a consistent form. The data transformation module 230 can be configured to use customized rules and processes to aggregate the raw district data into a common format. Because each school district can uniquely set up and store their data, this normalization and data transformation process is specific for each district or school. The normalized data is then uploaded into host databases, such as host database 105.

In an example embodiment, the data transformation module 230 can compare a newly received set of data stored in district raw database 104 and delta scratch database 109 against a corresponding set of data previously received from the same site location 150 and stored in database 105. This comparison can result in a set of differences or deltas (e.g., a configurable delta row key map) that define the data elements that have changed from a previous data update. These deltas can be stored in a delta database 107. Additionally, the data transformation module 230 can also aggregate the set of raw district data stored in district raw database 104 and implement district-specific data transformation rules to normalize the data and store the processed district data into the host database 105. In an example embodiment, these district-specific data transformation rules can be implemented as configurable join rules. The district-specific data transformation rules in an example embodiment are described in more detail below.

In an example embodiment, the data transformation module 230 can implement district-specific data transformation rules to validate and normalize the raw district data received from a site location 150. For example, the data transformation module 230 can implement rules to test the data for particular conditions known to require intervention by remedial software or host administrative personnel. These validation tests can include the following:
Do both Student and Attendance tables contain all the site codes expected? If not, troubleshoot with Software Engineer, Implementation Coordinator, and district Information Technologists (IT) as needed.
Are there any configuration codes present that were not accounted for in the configuration files received previously? If so, inform Implementation Coordinator.
Has attendance data for all sites been received as expected? If not, troubleshoot with Software Engineer, Implementation Coordinator, and district IT as needed.
Examine Period Frequency table and determine if any Validation rules will need to be created, such as moving attendance data from one of the periods to the AllDayCode field for the Elementary sites (most common example).
Review the raw district data received from a site location 150 for particular values that may be indicative of validation issues. Validation of these particular values can include the following:
   Missing Sites—This means data for one or more sites that is expected was not received.
   Non-Configured Codes—This means some type of code (e.g., language, ethnicity, grade, attendance, etc.) is showing up in the data and is not defined. Attendance & Language codes could affect letter production.
   Attendance on Holidays and Weekends—This means the received raw data is showing attendance on a date that is configured in the Scheduler as a district non-school day. This is rarely anything other than accidental pre-filled attendance.
   Total Attendance Record count—This should show a steady pattern of attendance up through the data the data was pulled for all active sites.
   Active Student Count by Site—This should show relatively similar student counts per site type.
   Ethnicity—The ethnic breakdown should be as expected (e.g., are there missing ethnicities).
   Attendance Outside School Year—There should be no attendance showing up outside of the school year
   Student Entry Dates>School Year End Date—There should be none or very few students (pre-enrolls) with entry dates after the end of the current school year.
   Upload Summary—Any upload errors will need to be investigated in a Batch Services process.
   Attendance at Non-Participating Sites—There should not be any attendance showing up for non-participating sites.
   Letter Count—Most sites should produce letters. Any sites that don't produce letters should be investigated to be sure their configuration is correct and none of their students should be triggering any letters yet.
   Exit date before entry date
   Valid email addresses
   Valid Names

As the data transformation module 230 implements the district-specific data transformation rules, such as those described above, sites that send raw district data with validation errors can be flagged. At a designated time, the flagged sites can be sent alerts notifying them of the data discrepancies.

The particular validation and normalization rules used by the data transformation module 230 can be configured and/or modified using a particular user interface provided by the district configuration module 240. The district configuration module 240 is described in more detail below. Once the data transformation module 230 validates and normalizes the raw district data, the normalized site data can be uploaded into host database 105. The data transformation module 230 can further implement data scrubbing rules to filter out site data not needed for letter generation, site reporting, or otherwise not needed by the host application. The site data needed for letter generation, site reporting, or otherwise used by the host application can be transferred to the stage database 106. Only site data for active sites is moved to the stage database 106. An additional level of data scrubbing can be performed on the site data in the stage database 106. The resulting data can be transferred to the applications database 108. As described in more detail below, the validated, normalized, filtered, and scrubbed site data in the applications database 108 can be used by the district configuration module 240, the scheduler module 250, and the reporting module 260 to generate appropriate attendance letters and notifications to students, site administrative personnel, and third-party administrators as needed.

Referring again to FIGS. 1 and 2, the student attendance management system 200 of an example embodiment can include a district configuration module 240. In a particular embodiment, specific rules and alerts can be set up within the student attendance management system to identify trends, events, and instances when a student, a school, or a district should be notified of an identified situation. These notifications are the drivers for improving school attendance. The specific rules and alerts, and associated codes and triggers, can be pre-defined within the student attendance management system application. These rules and alerts can be customized to address specific school district needs if requested.

The district configuration module 240 can be used to specify and manage the particular rules and processes used to generate and distribute alerts, such as attendance letters and notifications. For example, the manner of distribution of an attendance letter or notification (e.g., physical letter, email, or the like) can be pre-defined in a configurable way. Additionally, whether a letter or notification is generated at all for a particular student, site administrator, or third party administrator can also be configured. Finally, the content of a letter or notification can be customized for a particular recipient based on a variety of factors that can be encoded into a plurality of codes the district configuration module 240 can make configurable and customizable. In an example embodiment, these codes, triggers, and related data can include the following:
Ethnicity codes
Language codes
Site codes
Attendance codes—configurable attendance codes that trigger specific letter types
Grade codes
Status codes (active/inactive)
Attendance triggers
   Attendance follows student from previous site within a district (Follow Me)
   Send letters to multiple guardians
   Send conference notifications
   Exclude sending letters to students under N years of age
   Exclude absences that occurred before the student turned N years old.
   Exclude sending letters to students over the age of N
   Attendance tracking (all day vs. period attendance)
   Suppressing letters options
   Set number of ‘NEW’ absences that triggers the next letter.
Letter codes
   Letter types
   Pre-requisite
   Attendance threshold
   Printing of letter
   Emailing of letter
   Generate a conference
   Letter Templates
   Merge Fields
   Logo
   Conference logo
   Return address
   Number of absences in District Policy
Letter Contacts—merge field on printed letter
   Signers
   Contacts

The district configuration module 240 provides the ability within the same district school site to set different attendance triggers, letters, and contacts based on grade. For example, grades K-5 can have an attendance trigger based on the all-day attendance code and grades 6-8 have an attendance trigger based on attendance in periods 1-6.

The district configuration module 240 of an example embodiment also provides the ability to configure a letter code to trigger an attendance letter if an event occurs within a designated timeframe, such as a number of days (e.g., school days), weeks (e.g., calendar weeks) or months (e.g., calendar weeks). For example, a code can be configured to trigger an attendance letter on three unexcused absences within a four week period. The district configuration module 240 provides the flexibility to choose when to send subsequent attendance letters. For example, a subsequent attendance letter can be printed only if a pre-requisite letter was printed or a closed conference was completed. For example, a code can be defined to enable a second letter to be printed prior to the first letter being printed, or a code can be defined to disable the printing of a second letter prior to the printing of the first letter. Thus, in a similar manner, a variety of codes, triggers, and rules can be created and managed using the district configuration module 240 of an example embodiment.

Referring again to FIGS. 1 and 2, the student attendance management system 200 of an example embodiment can include a scheduler module 250. Once the normalized school student information is resident in the host database (e.g., applications database 108), the scheduler module 250 and the reporting module 260 of an example embodiment can be used to generate attendance letters, notifications, and other alerts according to a defined schedule and to schedule conferences based on prescribed rules configured using the district configuration module 240. In some cases, some notifications can be suppressed or delayed to implement a pre-defined policy. In most cases, the notifications are sent on regular intervals to ensure consistency.

The scheduler module 250 of an example embodiment can be used to define and manage a schedule for the generation and distribution of alerts, including attendance letters and notifications. In a particular embodiment, the scheduler module 250 can be configured to schedule around U.S. holidays, district events, or host location non-operational days. Additionally, the scheduler module 250 can be configured to schedule in production delays, personnel review/processing delays, data processing delays, mailing delays, and other foreseeable delay scenarios that may affect the production of alerts.

In an example embodiment, the scheduler module 250 can be configured to view a district's schedule for previous fiscal years. A user of the scheduler module 250 can add, delete, and/or edit an attendance letter or notification production schedule. In addition, the scheduler module 250 can impose some limitations on the user's configuration of a production schedule. For example, in a particular embodiment, the following restrictions can be imposed on the user:
When editing a production schedule, a user cannot select a date for a production event if the date falls on a weekend, a US holiday, an important district date, or an important date for the host location.
Cannot schedule a production run with the same attendance data as a previous run through, data processing, client review, or print date.
Users cannot delete a past run without the role ‘Can delete past tasks in Scheduler’.
Users with the role ‘Can delete past tasks in Scheduler’ cannot delete past runs where letters are associated to the run.
Users cannot schedule same day tasks without the role ‘Can Schedule same day tasks in Scheduler’.
User has the ability to delete a whole production run (only future production runs unless the user has the role to delete past runs).
Cannot have a production run when the data processing date is less than the previous run's print date.
Cannot have a production run when the Client Review date is before the previous run's print date.
Cannot have a production run when the Attendance Through date is before the previous run's attendance through date.

Thus, using a variety of features and automatically imposed restrictions provided by the scheduler module 250, a user can configure, schedule, and manage production runs for producing alerts or scheduling conferences in an example embodiment. The scheduler module 250 can also be configured to perform several suppression functions. Suppression functions are used by a host administrator to temporarily or permanently prevent the generation and distribution of attendance letters, notifications, or other alerts to particular students, particular schools, particular districts, or other groups or locations. In a particular embodiment, several letter suppression types are supported: 1) One-Time: only suppresses the letter for the current production run, 2) Extended: suppresses a letter for a configured number of additional absences, or 3) Indefinite: suppress a letter for the remainder of the current school year. In addition, the example embodiment can suppress a letter from being generated for a particular student for the current school year.

Referring again to FIGS. 1 and 2, the student attendance management system 200 of an example embodiment can include a reporting module 260. In an example embodiment, the reporting module 260 can be configured to associate a unique student identifier with every student in the host databases 103. This student identifier is unique for a particular student across all districts, schools, and locations serviced by the host system 110. As a result, the student attendance management system 200 can track and report on the same student year over year within the same district, within different districts, and across different States as students move to different locations. This feature of an example embodiment enables better tracking of students over time, even if students change locations, addresses, or names.

The reporting module 260 is used to generate reports, attendance letters, notifications, other alerts, or schedule conferences according to the schedule configured using the scheduler module 250. In an example embodiment, the reporting module 260 can access the data in the applications database 108, or other host databases 103, to generate reports that highlight trends in student attendance for a variety of comparative factors, including: trends for particular students or student groups, trends qualified by student demographic factors, trends qualified by time periods, trends qualified by historical data vs. current data, trends by location, district, school, or State, trends qualified by funding levels, and a variety of other reports generated from the attendance and student data maintained in the host databases 103. As a result, the student attendance management system 200, and the reporting module 260 in particular, can produce a wealth of attendance information aggregated across wide variations in time and location. For example, a particular embodiment can generate a Save Rate report that highlights the percentage of students that do not continue on a path toward chronic absenteeism after an A2A intervention. The Save Rate report can measure the change in behavior of at-risk students as they are exposed to the benefits of the A2A processes, such as attendance letters and scheduled conferences. In another report, the reporting module 260 can generate a comparative analysis that compares a district's performance in managing student attendance against other districts or regions managed by the student attendance management system 200. In particular, the comparative analysis report can compare a district's performance against a State average of: truancy (unexcused absences), excessive excused absences, and chronic absenteeism.

In an example embodiment, the reporting module 260 can include a user interface for configuring and enhancing the reporting operation. In a particular embodiment, the user interface of the reporting module 260 can be used to add notes to attendance letters, notifications, or other alerts. For example, letter notes can be associated with a specific letter for a student, student notes can be associated with a specific student, and conference notes can be associated with a specific conference for a student. In addition, the user interface of the reporting module 260 can be used to add, edit, or delete guardian information associated with a particular student. The user interface of the reporting module 260 can also be used to configure the manner in which notifications are sent (e.g., by letter, email, or text message).

In a particular embodiment, the user interface of the reporting module 260 in concert with the scheduler module 250 can be used to generate and schedule a conference for particular individuals as part of the A2A attendance management process. For example, an attendance letter, notification, or other alert can be configured to automatically queue a student for conference scheduling when the letter, notification, or other alert is printed. The user interface of the reporting module 260 in concert with the scheduler module 250 can be used to schedule individual conferences or group conferences (e.g., more than one student in a conference). The user interface can also be used to add and edit a conference schedule item, specify a date, time, and location, and configure the reporting module 260 to send a conference notification to a student, parent or guardian, or school/district administrator. The user interface of the reporting module 260 in concert with the scheduler module 250 can also be used to update the status of a scheduled conference, reschedule a conference, or cancel/close a scheduled conference. Upon closing a conference, the user can also add a reason or a note related to the closure of the conference.

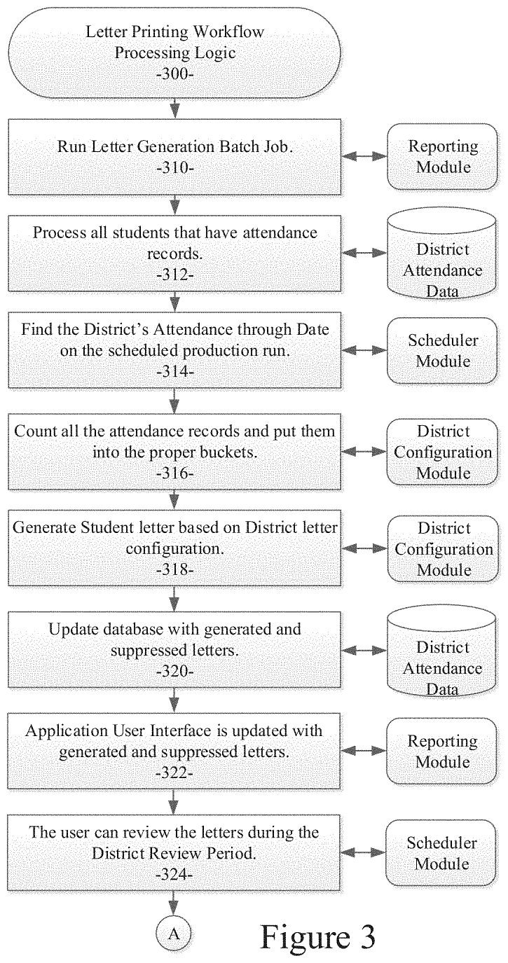

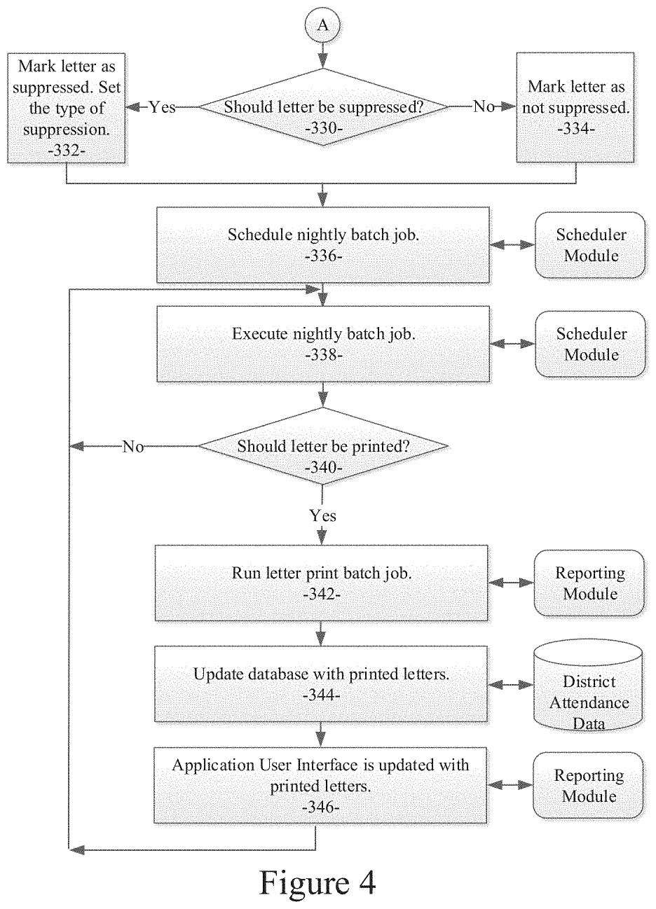

Referring now to FIGS. 3 and 4, a flow diagram illustrates the letter printing workflow in an example embodiment. As described above, the reporting module 260 in concert with the scheduler module 250 and attendance and student data stored in host databases 103 can be used to generate attendance letters, notifications, and other alerts, which can be distributed to students, parents or guardians, and school or district representatives. The letter generation process can be performed in real time or as a batch job run on off-peak hours.

Referring now to FIG. 3, processing starts for the letter printing workflow of an example embodiment. At processing block 310, the workflow process runs a letter generation batch job. The batch job processes all students that have attendance records (processing block 312). The process finds the district's attendance through date on the scheduled production run (processing block 314). All the attendance records are counted and classified into the proper buckets (processing block 316). Student letters are generated based on the district letter configuration (processing block 318). The host database is updated with the generated and suppressed letters (processing block 320). The application user interface is updated with generated and suppressed letters (processing block 322). The user can review the generated letters during a district review period (processing block 324).

Referring now to FIG. 4, processing continues at bubble A for the letter printing workflow of an example embodiment. At decision block 330, a query is processed. Should the letter be suppressed? (decision block 330). If yes, the letter is marked as suppressed. The type of suppression can be set by the user (processing block 332). If no, the letter is marked as not suppressed (processing block 334). Then, the nightly letter processing batch job is scheduled (processing block 336). The nightly letter processing batch job is executed (processing block 338). Should the letter be printed? (decision block 340). If yes, the letter print batch job is run (processing block 342). The host databases are updated with the printed letters (processing block 344). The application user interface is updated with the printed letters (processing block 346). Processing then terminates for the letter printing workflow of an example embodiment.

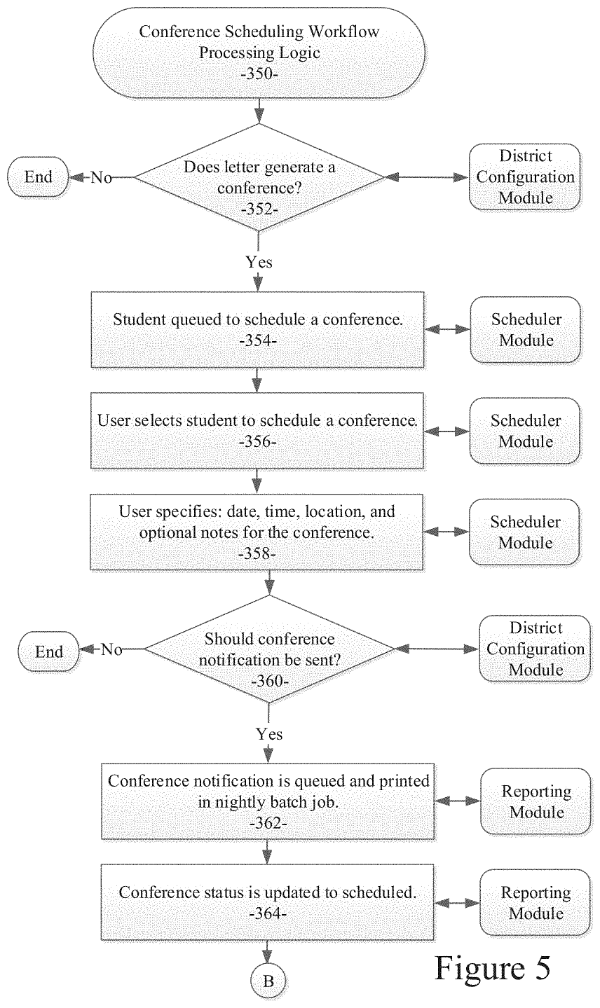

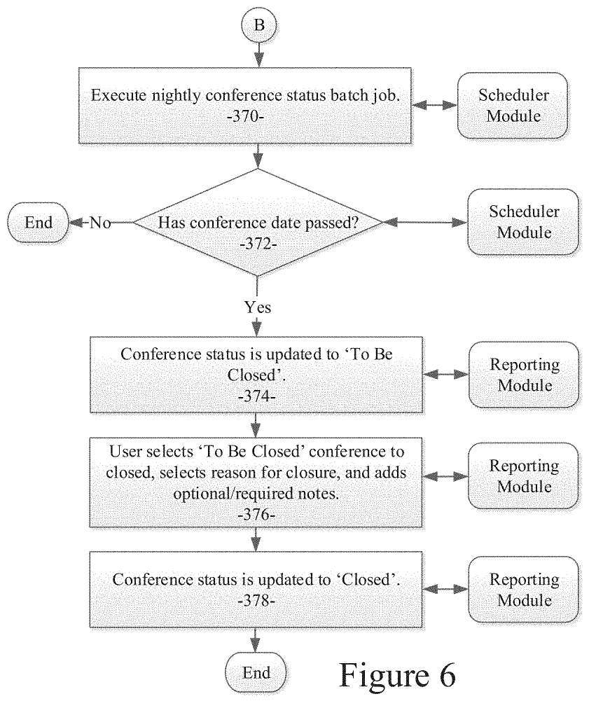

Referring now to FIGS. 5 and 6, a flow diagram illustrates the conference scheduling workflow in an example embodiment. Referring to FIG. 5, processing starts for a conference scheduling workflow of an example embodiment. At decision block 352, a query is processed. Does the letter generate a conference? If yes, the student corresponding to the letter is queued to schedule a conference (processing block 354). The user can select a particular student for whom a conference is scheduled (processing block 356). The user can specify: date, time, location, and optional notes for the conference (processing block 358). Should a conference notification be sent? (decision block 360). If yes, a conference notification is queued and printed in a nightly batch job (processing block 362). The conference status is updated to scheduled (processing block 364).

Referring to FIG. 6, processing continues at bubble B for the conference scheduling workflow of an example embodiment. At processing block 370, the workflow executes a nightly conference status batch job. Has the conference date passed? (decision block 372). If yes, the conference status is updated to ‘To Be Closed’ (processing block 374). The user can select ‘To Be Closed’ to close the conference to be closed. The user can also select a reason for the closure, and can add optional/required notes (processing block 376). The conference status is updated to ‘Closed’ (processing block 378). Processing terminates for the conference scheduling workflow of an example embodiment.

As described above, a user platform 141 can include a mobile device on which a mobile application (app) can be executed. An example embodiment 400, implemented as a mobile device app, can be used to support a mobile device user interface for the student attendance management system 200 of an example embodiment. It will be apparent to those of ordinary skill in the art that other embodiments can also be implemented as a web application (app) with one or more webpages or other types of user interfaces. A mobile version of an example embodiment provides a user-friendly interface from which the user can easily view the relevant school information from a mobile device. As described in more detail below, a mobile software application (app) embodying a mobile version of an example embodiment as described herein can be installed and executed on a mobile device, such as a smart phone, laptop computer, tablet device, or the like. In an example embodiment, a splash screen appears whenever the user opens or launches the mobile application on the mobile device. This splash screen displays a host logo and wallpaper image while opening the login screen or a live feed of processed school information.

User log-in functionality in the mobile app provides a user-friendly user interface in which the user provides the email address and password associated with the user account. If the user does not have an account, the user can create an account from this user interface. The process of creating a user account in an example embodiment is simple and only requires the user to provide the following information: name, surname, e-mail address, and password. By completing this information, the user can create an account and get access to processed school information.

Referring again to FIG. 1, the student attendance management system 200 of an example embodiment is also shown to include a user account management module 270. The user account management module 270 can be used to create and maintain a user account on the host site 110. The user account management module 270 can also be used to configure user settings, create and maintain a user/user profile on host site 110, and otherwise manage user data and operational parameters on host site 110. In the example embodiment described herein, a user can register as an identified user in order to share information, documents, communications, or other content. The registered user can enter their name, email address, and password. Once this information is entered, a user account is created and the user can share information, documents, communications, or other content.

Referring again to FIG. 1, the student attendance management system 200 of an example embodiment is shown to include an administrative management module 280. The administrative management module 280 can be used by an agent of the student attendance management system 200 to manage user accounts and to manage the student attendance management system. The administrative management module 280 can also be used to enforce privacy protections and content controls for users. Moreover, the administrative management module 280 can also be used to generate and/or process a variety of analytics associated with the operation of the student attendance management system 200. For example, the administrative management module 260 can generate various statistical models that represent the activity of the community of users and related districts, schools, students, and the like. These analytics can be shared, licensed, or sold to others.

Although the various user interface displays provided by the example embodiments described herein are nearly infinitely varied, several sample user interface displays and sequences are provided herein and in the corresponding figures to describe various features of the disclosed embodiments. These sample user interface displays and sequences are described herein and in the accompanying figures. It will be apparent to those of ordinary skill in the art that equivalent user interface displays and sequences can be implemented within the scope of the inventive subject matter disclosed and claimed herein.

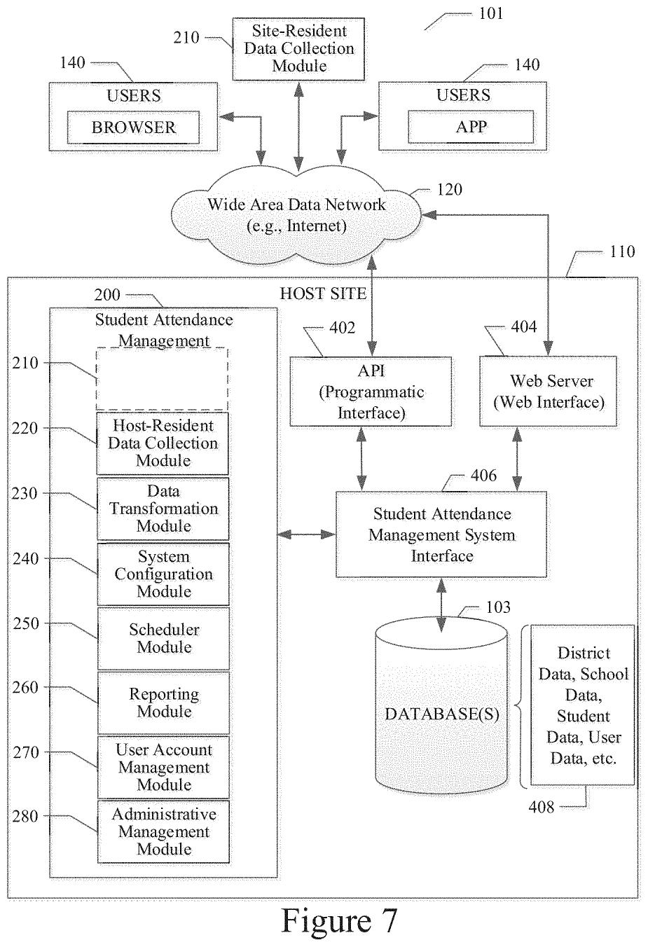

Referring now to FIG. 7, another example embodiment 101 of a networked system in which various embodiments may operate is illustrated. In the embodiment illustrated, the host site 110 is shown to include the student attendance management system 200. The student attendance management system 200 is shown to include the functional components 210 through 280, as described above. In a particular embodiment, the host site 110 may also include a web server 404, having a web interface with which users may interact with the host site 110 via a user interface or web interface. The host site 110 may also include an application programming interface (API) 402 with which the host site 110 may interact with other network entities on a programmatic or automated data transfer level. The API 402 and web interface 404 may be configured to interact with the student attendance management system 200 either directly or via an interface 406. The student attendance management system 200 may be configured to access a data storage device 103 and data 408 therein either directly or via the interface 406.

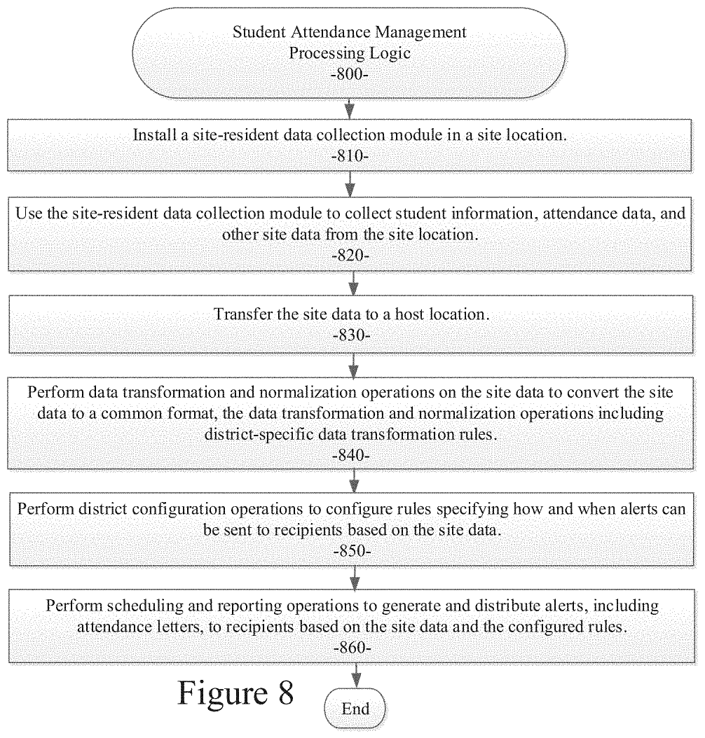

Referring now to FIG. 8, a processing flow diagram illustrates an example embodiment of a student attendance management system 200 as described herein. The method 800 of an example embodiment includes: installing a site-resident data collection module in a site location (processing block 810); using the site-resident data collection module to collect student information, attendance data, and other site data from the site location (processing block 820); transferring the site data to a host location (processing block 830); performing data transformation and normalization operations on the site data to convert the site data to a common format, the data transformation and normalization operations including district-specific data transformation rules (processing block 840); performing district configuration operations to configure rules specifying how and when alerts can be sent to recipients based on the site data (processing block 850); and performing scheduling and reporting operations to generate and distribute alerts, including attendance letters, to recipients based on the site data and the configured rules (processing block 860).

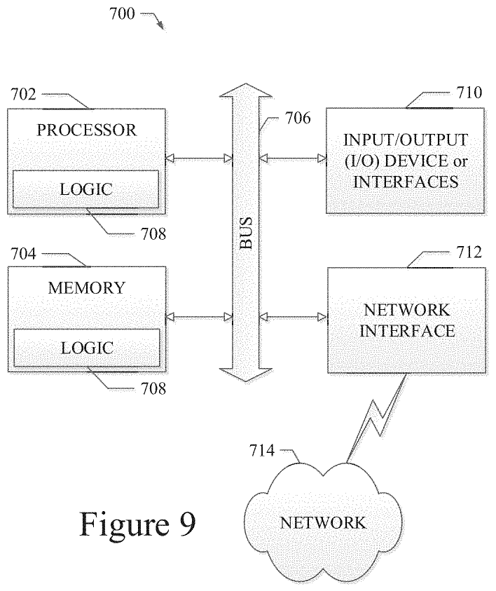

FIG. 9 shows a diagrammatic representation of a machine in the example form of a stationary or mobile computing and/or communication system 700 within which a set of instructions when executed and/or processing logic when activated may cause the machine to perform any one or more of the methodologies described and/or claimed herein. In alternative embodiments, the machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a web appliance, a set-top box (STB), a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example stationary or mobile computing and/or communication system 700 includes a data processor 702 (e.g., a System-on-a-Chip (SoC), general processing core, graphics core, and optionally other processing logic) and a memory 704, which can communicate with each other via a bus or other data transfer system 706. The stationary or mobile computing and/or communication system 700 may further include various input/output (I/O) devices and/or interfaces 710, such as a monitor, touchscreen display, keyboard or keypad, cursor control device, voice interface, and optionally a network interface 712. In an example embodiment, the network interface 712 can include one or more network interface devices or radio transceivers configured for compatibility with any one or more standard wired network data communication protocols, wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth, IEEE 802.11x, and the like. In essence, network interface 712 may include or support virtually any wired and/or wireless communication mechanisms by which information may travel between the stationary or mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the stationary or mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

Conferencing

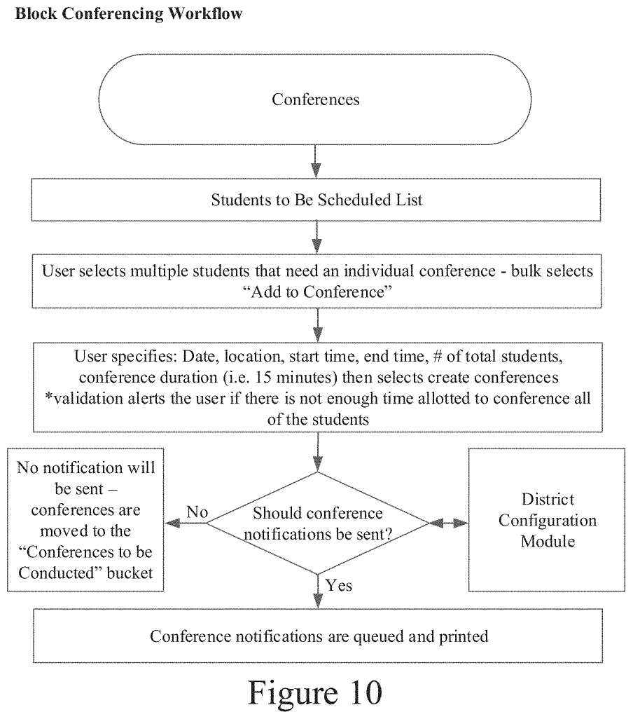

Referring now to FIG. 10 in an example embodiment, the Block Conferencing features of the example embodiment are illustrated. FIG. 10 is an operational or processing flow chart illustrating an example embodiment of a method as described herein for block conferencing workflow. In the example embodiment, a block conferencing feature is provided to assist district users or other users in quickly scheduling multiple conferences with few clicks. As described above, the reporting module 260 can be used to generate reports, attendance letters, notifications, other alerts, or schedule conferences according to the schedule configured using the scheduler module 250. The scheduler module 250 can be used to generate and schedule a conference for particular individuals as part of the A2A attendance management process. In an example embodiment, the scheduler module 250 can also provide additional processing to schedule individual conferences in blocks to minimize the actions required via the user interface. In the example embodiment, the current workflow of scheduling individual or group conferences can be implemented as described above. Additionally, the block conferencing feature of an example embodiment is compatible with the student filters on the conferencing pages. As provided in an example embodiment, a variety of bulk or block actions can be applied to multiple entities (e.g., students, student groups, staff, etc.) for the purpose of scheduling a conference, modifying a scheduled conference, or canceling a scheduled conference. In the example embodiment, the block conferencing feature may not assist users in mass scheduling group conferences—only multiple individual conferences may be scheduled via the block conferencing feature. Selections made, such as Date/Location/Staff/Note Text, will apply to all conferences for the selected group.

Referring to FIG. 10, a user can navigate to a Conferences page and then navigate to either the ‘Students To Be Scheduled’ or a ‘Students To Be Rescheduled’ tab. The user can then apply filters, if needed, to refine the student list for the set of targeted students.

The user can select the students for whom conferences are to be scheduled by checking a box to the left of an ‘Add to Conference’ symbol, or select all students by checking a box to the left of an ‘Actions’ column. The user can select an ‘Add to Conference’ option from a drop down bulk action menu. A ‘Select Conference’ pop-up window will appear in response to the ‘Add to Conference’ user selection. The user can be prompted to click on a radio button ‘Block Conference Scheduler’ and to select ‘Continue.’

Referring still to FIG. 10, a new screen will open to prompt the user to set the conference details. A list of students selected can be displayed in a list like when scheduling an individual or a group conference. By use of a user interface, the user can enter the conference details accordingly. For example, the user can specify among the following conference details:
Date: the user can enter the date on which to schedule the conferences. In response to this action, the date will show on all the student notification letters for the selected students;
Location: the user can enter the conference location. In response to this action, the location will show on all the student notification letters for the selected students;
Begin Time: the user can enter the time at which the conference will start on the date selected;
End Time: the user can enter the time at which the conference will end on the date selected;
Number of Students: the user can enter the number of students to be scheduled in the specified time slot. The value entered determines how many students will be scheduled in each time slot. The user can enter “1” to book one student in each time slot; enter “2” or more to book multiple students in one time slot. Entering a number equal to or greater than “2” will not schedule the students in group conferences. All conferences scheduled through this feature will be individual conferences even if they start at the same time; and
Conference Duration: the user can enter the length (in minutes) of each conference. All conferences for the selected students must be the same length.

Once all conference details have been entered by the user, the user can select a “Create Conferences” option of the user interface. If any information is invalid, a warning will appear and the user will not be allowed to create the conferences until the invalid information is corrected. For example, entering an end time that is prior to the start time will receive an error. Additionally, not allocating enough time to schedule all students selected will produce an error. Particular students can be removed from the block conference by clicking on the trash can next to the student's name (e.g., same process as group conferencing).

Once valid details have been set and the “Create Conferences” option has been selected, a pop-up window will be displayed to confirm the scheduling of multiple conferences. The user can select “Ok” to proceed. In response to this user selection, another pop-up window will be displayed to present a list of the students and their scheduled conference dates and times. The user can select “Close” to proceed back to the ‘Students To Be Scheduled’ tab as described above. The user can click on a ‘Conferences To Be Conducted’ tab to schedule students in their own individual conferences at different times as scheduled in block form as described above.

It may be beneficial to double book multiple conferences at the same time. Double booking a conference may be useful if, for example, the district has a high no-show rate. In this case, the user can enter “2” or more in a “# of Students” conference details box as shown in the user interface. After filling out the rest of the details and clicking a “Create Conferences” option, a pop-up window is displayed to confirm for the user that multiple students have been booked for each time slot.

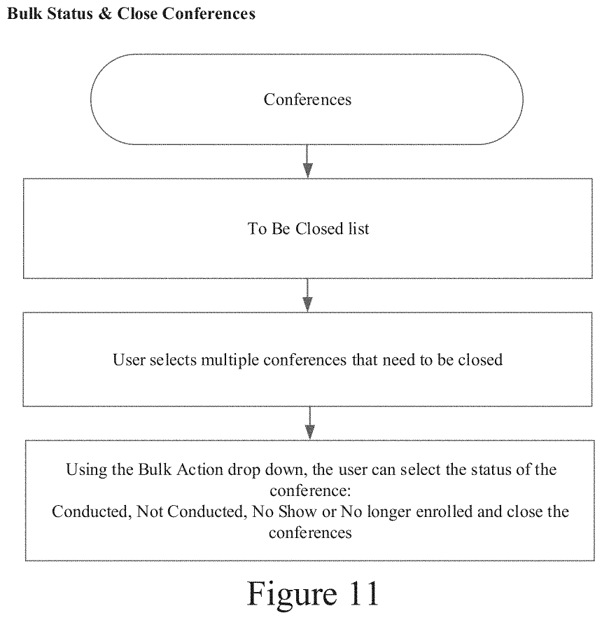

Referring now to FIG. 11 in an example embodiment, the Bulk Status and Close Conferences features of an example embodiment are illustrated. FIG. 11 is an operational or processing flow chart illustrating an example embodiment of a method as described herein for configuring bulk status and conference updates. Client users can be frustrated by the amount of ‘clicks’ or other user interface actions needed to determine status and close out multiple conferences in one sitting. The solution provided by the example embodiments described herein reduces the number of user interface actions required to close out conferences. There is no change to the requirements to close a conference. Conferences can still be closed using the process of clicking on each individual conference as described above. To remove a student from a conference, the user must open the individual conference. In the example embodiment, students cannot be bulk ‘Removed From Conferencing’ or one click ‘Removed From Conferencing’.

As part of the Bulk Status and Close Conferences features of an example embodiment, a user can navigate to a conferences ‘To Be Closed’ page as shown in the user interface. The user can select the conferences to close out by clicking the boxes to the left of the conference. Then, the user can click on the ‘Bulk Actions’ button at the top of the conference list. The user can select the appropriate conference status that will be given to all students who were selected. A warning pop-up window can be presented to the user to prompt the user to confirm the status and the selected action of closing the conferences. The user can click ‘Yes’ and the selected conferences will be closed with the status selected. If the user clicks ‘No’, no change will occur. Users are also able to close out individual and group conferences directly from the ‘To Be Closed’ tab without opening the conference by clicking on the ‘Close Conference’ icon and selecting the status.

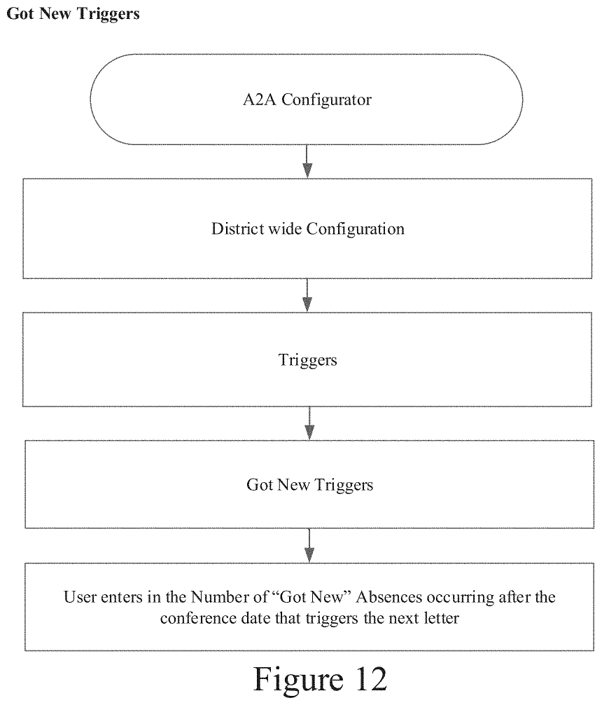

Referring now to FIG. 12 in an example embodiment, the Got New Triggers: Got New Absences After Conference Date Before Next Letter Generates features in the example embodiment are illustrated. FIG. 12 is an operational or processing flow chart illustrating an example embodiment of a method as described herein for configuring the Got New Triggers feature. In some circumstances, parent/district relationships can be strained when parents receive a letter of the student's absences directly after meeting together with district representatives and deciding on an attendance plan. As such, an example embodiment provides a feature (denoted the Got New trigger feature) to provide a client with an option to set a variable threshold of new absences that must occur after the district has met with the student before the next truancy letter generates. As shown in the example illustrated in FIG. 12, the feature includes the capability for a user to configure one or more triggers by site or location. In an example embodiment, a user can choose to select a number of absences that the student must incur after the actual conference date as a pre-requisite for the next truancy letter in the sequence (in addition to the letter trigger). The related conference must be CLOSED-‘Conducted’ or CLOSED-‘Removed From Conferencing’ for the next letter to generate. The feature is compatible even if the district conferences off multiple letters with multiple closed conference pre-requisites.

In an example embodiment, District A can be configured to send a first letter (L1) to the parents/student at the accrual of three student absences, a second letter (L2) at six absences, and a third letter (L3) at nine absences. For example, the student can receive L2 on Apr. 1, 2015 and is queued up to be scheduled in a conference. In this example, the student can be scheduled for a conference on May 1, 2015, but may miss two more school days in mid-April before his/her conference date. After attending the conference, the student is given a status of ‘Conducted’ and the conference is closed on May 2, 2015. However, in the example, the student may miss another day of school on May 3, 2015 (two days after the conference). In this example, the student technically has nine absences at this point and without the Got New trigger feature of the example embodiment, the L3 letter would be generated and sent, which may cause confusion and other problems.

In the example embodiment disclosed herein, if the district user chose a Got New trigger of three (3), the student would need to miss three (3) days of school after the conference date (May 1, 2015 in the example above) for the next letter to be automatically generated. For the student in the example described above, the L3 letter would be automatically generated once the student missed eleven days of school.

The Got New trigger feature of the example embodiment can be configured by use of the user interface actions described in more detail below. The user can configure the Got New trigger feature by initially navigating to the A2A Configurator function of the Configuration page from an Administration page. Upon selection of the A2A Configurator function, a user interface page is displayed for the user. At this point, the user can select the desired district from the left hand navigation panel. The user can click on ‘District Wide Configuration’ or a specific site if the trigger is not district-wide. The user can scroll down to the ‘Got New Triggers’ section and type the number of absences to be configured in the manner described above and shown in FIG. 12.

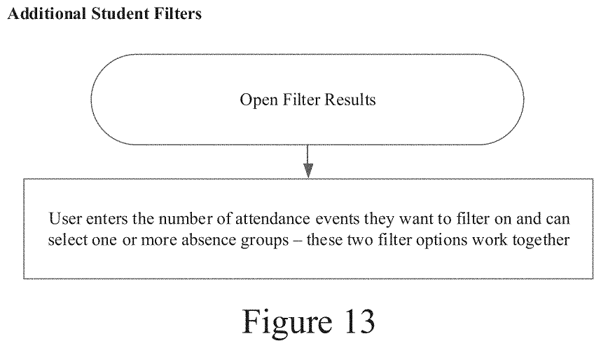

Referring now to FIG. 13 in an example embodiment, a variety of additional student filter features in the example embodiment are provided. FIG. 13 is an operational or processing flow chart illustrating an example embodiment of a method as described herein for effecting additional student filters. A quantity (Attendance Count) and type (Absence Group) of attendance events can be specified by the user via the user interface. In an example embodiment, the student filters are configured to enable the ‘Attendance Count’ and the ‘Absence Group’ to be selected/specified by the user and configured to work together to filter a desired result. In an example embodiment, absence groups are by letter triggers, not reporting type. Only absence groups that are configured will be on display (if the district does not send tardy letters, then this option will not be displayed). The user can hold the ‘CTRL’ key to select multiple absence groups.

In a first example of the student filters of an example embodiment, the Attendance Count can be set to ten (10) and the Absence Group can be set to Truant. In this example, this filter will return all students with ten or more truant absences.

In a second example of the student filters of an example embodiment, the Attendance Count can be set to ten (10) and the Absence Group can be set to both Truant and EEA. In this second example, the user can enter 10 for the Attendance Count and hold the ‘CTRL’ key to select the multiple Absence Groups. In this second example, this filter will return all students with a combination of ten or more truant and/or EEA absences.

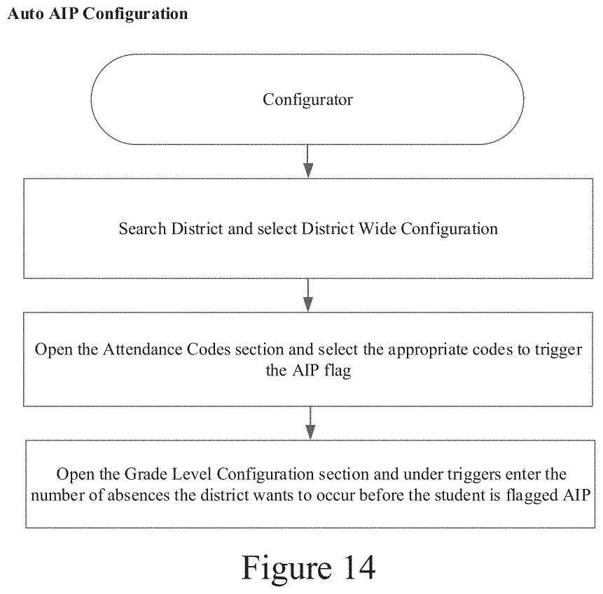

Referring now to FIG. 14 in an example embodiment, the Automatic Attendance Improvement Plan (AIP) Configuration features of an example embodiment are illustrated. FIG. 14 is an operational or processing flow chart illustrating an example embodiment of a method as described herein for automatic Attendance Improvement Plan (AIP) configuration. In an example embodiment, the Attendance Improvement Plan (AIP) flag can be manually turned on and off by navigating the user interface to each individual student's student overview page. As an alternative, the example embodiment allows an operations user to configure the AIP flag to automatically turn on for a district as the students upload on each letter run. In the example embodiment, the automatic AIP flag can be configured by district, site, and/or attendance codes. The automatic AIP flag will only put students on AIP; it does not clear existing AIP flags. Automatic configuration will ignore students that are already on AIP. If attendance is cleared for a student, the AIP flag will not automatically clear. A user must go to the student overview page and manually remove the student from AIP, if necessary. Users can update flags that have been placed on the student automatically. A default configuration will be to set the AIP flag to a value of ‘0’—no automatic AIP flag.

The Automatic AIP Flag feature of the example embodiment can be configured by use of the user interface actions described in more detail below. The user can configure the Automatic AIP Flag feature by initially navigating to the A2A Configurator function of the Configuration page from an Administration page. Upon selection of the A2A Configurator function, a user interface page is displayed for the user. At this point, the user can search then select the desired district from the left hand navigation panel. The user can click on ‘District Wide Configuration’ to configure all sites, or select each site individually. Upon selection of the ‘District Wide Configuration’, a user interface page is displayed for the user. The user can click on the ‘Attendance Codes’ and configure the Automatic AIP Flag feature using an ‘AIP’ column provided in the user interface. Based on the district desires and goals, the user can select the appropriate codes to trigger the Automatic AIP flag. The user can double-click, then check a box to select the function. The user can then click Save′ to save the configured selections.

The user can further navigate to the ‘Grade Level Configuration’ and select the ‘Triggers’ function. Upon selection of the ‘Triggers’ function, a user interface page is displayed for the user. The user can enter the number of AIP absences for which the district wishes to put a student on automatic AIP. Finally, the user can click Save′ again to retain the configuration.

The Auto AIP flag will most likely need to be set by site if some sites are all day and some are period counting. For example, the district may want nine absences to be the threshold for the Auto AIP function. If the site uses period counting with five periods for a day, for example, then the user would need to increase the AIP trigger accordingly (e.g., to 9×5=45) for that site. Once the site(s) have been configured as described above, the flag will appear on qualified students throughout the user interface. Additionally, the flag is populated during letter generation.

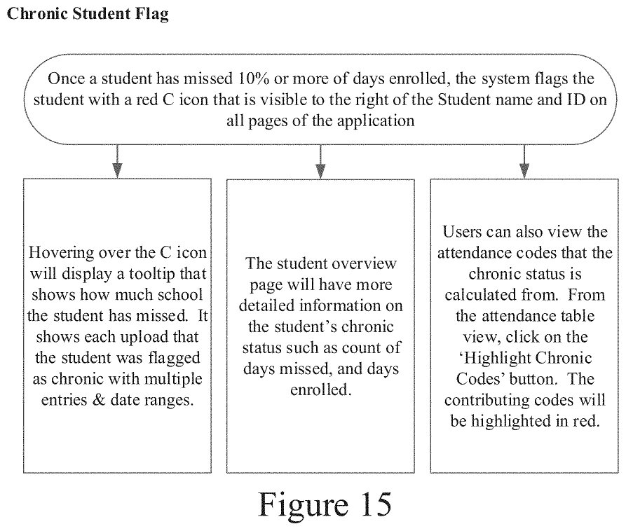

Referring now to FIG. 15 in an example embodiment, the Chronic Student Flag in the user interface of an example embodiment is illustrated. FIG. 15 is an operational or processing flow chart illustrating an example embodiment of a method as described herein for effecting a chronic student absence flag. In the example embodiment, the Chronic status indicator is provided in the user interface so users can readily see at a glance which students are chronically absent. This allows the user to focus on the chronic student population for more specifically directed interventions. In the example embodiment, the chronic indicators will only be as accurate as the last letter run. The data will be refreshed in concert with the print schedule. If the student is not considered chronically absent in the current letter run, the student will not have a chronic icon displayed in the user interface, even if the student did in prior letter runs. In an example embodiment, Chronically Absent is defined as a student who has missed 10% or more of days enrolled. Once a student has missed 10% or more of school days enrolled, the system automatically flags the student with a red ‘C’ icon (e.g., the Chronic status indicator) to the right of the student name and ID. The flag appears next to the student name in all pages of the application (Students Page, Letters Pages, Conferencing Pages, etc.).

As shown in FIG. 15, hovering over the icon (e.g., the Chronic status indicator) displays a tooltip that shows how much school the student has missed, represented as a percentage (%) of school days enrolled that have been missed. The tooltip will show each upload for which the student was flagged as chronic with multiple entries and date ranges. For example, a particular student may have only been flagged as chronic once. Another student may have been flagged multiple times and we can view the history and percentage of enrolled days missed each time the student was flagged.

A student overview page, in an example embodiment, displays detailed information on the student's chronic status, such as a count of days missed, and days enrolled.

Users can also view the attendance codes from which the chronic status is calculated. From the attendance table view, the user can click on the ‘Highlight Chronic Codes’ button. The contributing codes will be highlighted. Users may filter the information displayed in the user interface by chronic status from the list pages (Students Page, Letters Pages, and Conferencing Pages).

Reports

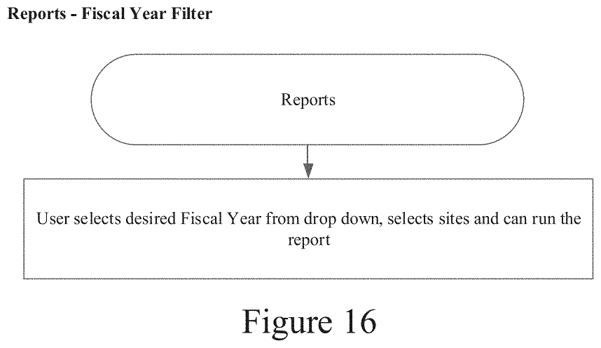

Referring now to FIG. 16 in an example embodiment, the features of the Client Reports—Fiscal Year Filter of an example embodiment are illustrated. FIG. 16 is an operational or processing flow chart illustrating an example embodiment of a method as described herein for generating a fiscal year report. In an example embodiment, a feature is provided with which clients can run all client-facing reports in the user interface for multiple years. Clients can start running reports from the 2014-15 school year onward. Only years the district was active on A2A will be available for selection. If the district started A2A in the 2015-16 school year, the district will only be able to view and select 2015-16 from the drop-down filter as shown in the user interface.

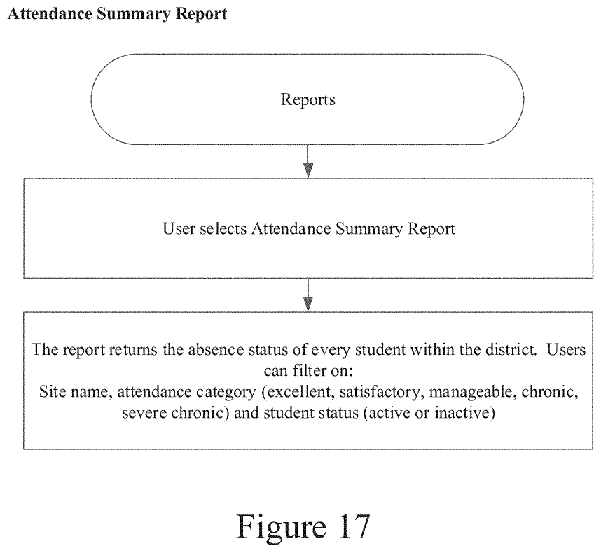

Referring now to FIG. 17 in an example embodiment, the Attendance Summary Report in the user interface of the example embodiment is illustrated. FIG. 17 is an operational or processing flow chart illustrating an example embodiment of a method as described herein for generating an Attendance Summary Report. The example embodiment is configured to provide a client-facing report as part of the user interface, wherein users can run (on demand) a report to list and display key student information. This information allows district users to easily identify students that need targeted interventions, or to reward students with great attendance. The report also helps districts fulfill state education report requirements. The Attendance Summary Report provides attendance information that is as current as the client's last attendance through the date from their production schedule, which provides district users with time relevant knowledge about each student's attendance behavior. In the example embodiment, users can filter the displayed information by: site name, attendance category (excellent, satisfactory, manageable, chronic, and severe chronic), and student status.

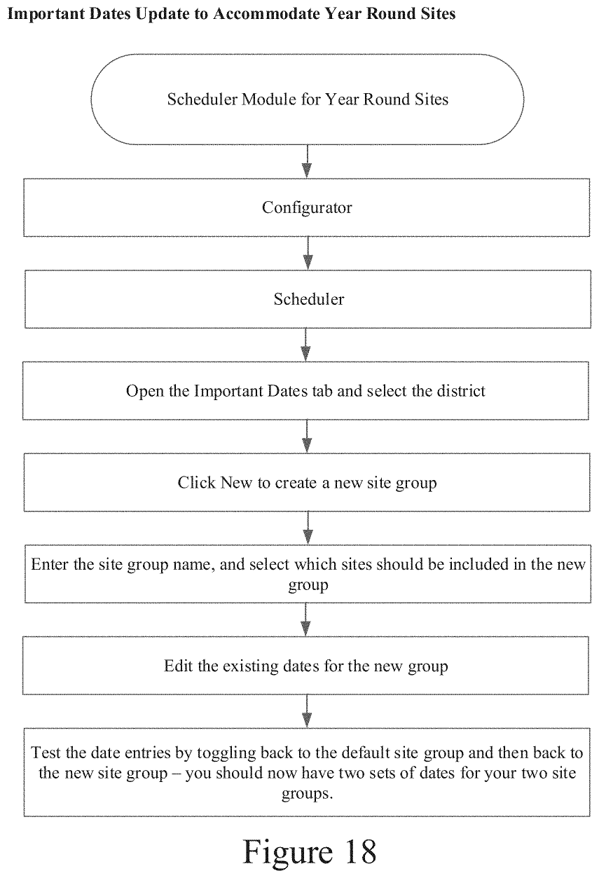

Referring now to FIG. 18 in an example embodiment, the Important Dates Update to Accommodate Year Round Sites features of an example embodiment are illustrated. FIG. 18 is an operational or processing flow chart illustrating an example embodiment of a method as described herein for effecting updates to important dates to accommodate year-round sites. Many A2A districts have sites with differing school calendars. There can be districts with traditional school calendars as well as sites with year-round school calendars. There can also be districts that allow sites to choose black out days that may occur on different dates. In an example embodiment, a capability is provided to add and configure multiple important date schedules by site.

The feature of the example embodiment for managing multiple important date schedules by site can be configured by use of the user interface actions described in more detail below. The user can configure the date schedules by site feature by initially navigating to the Scheduler function of the Configuration page from an Administration page. Upon selection of the Scheduler function, a user interface page can be displayed for the user. At this point, the user can click on the ‘Important Dates’ tab and select a desired district. The user can then click on the ‘New’ button to create a new site group. A display area is presented in the user interface under the selected district called ‘Add New Site Group Date’.

As an example of the embodiment disclosed herein, a user can be working with a particular district (e.g., Hayward USD), which has four year round sites and the rest of the sites in the district have traditional school calendars. In this example, the user can leave the default school year as the year round dates of Jul. 21, 2014-Jun. 11, 2015. Next, the user can click on a ‘New’ button to create the important date entries for the traditional sites. The user can click on the ‘New’ button and enter the site group name. The site group name should not have any spaces. The new site group name can be specified by the user as ‘Traditional_Sites.’ It will be apparent to those of ordinary skill in the art that any arbitrary name for the new site group can be entered by the user.

The user can select which sites are included in this new group (denoted in the example as ‘Traditional_Sites’) by checking the sites to include. The user can scroll down to the bottom of the site list and click ‘SAVE’ to retain the site selection.

The user can add and edit the existing dates for the ‘Traditional_Sites’ group. The end result is an edited school year to start in August with a blackout date specifically configured for the Traditional_Sites site group of the example as described. The user can test the date entries by toggling back to the ‘Default’ site group and then back to the new site group. As described for these examples, there are now two sets of dates for the two defined site groups: ‘Default’ and ‘Traditional_Sites.’ In this manner, the example embodiment enables the user to define and configure a variety of site groups to manage the various school calendars and important dates at sites within a district.

The user can delete a site group by picking the desired site group from the drop-down Site Group menu, navigating to the bottom of the site list, and selecting the delete button. A confirmation prompt can also be displayed to the user.

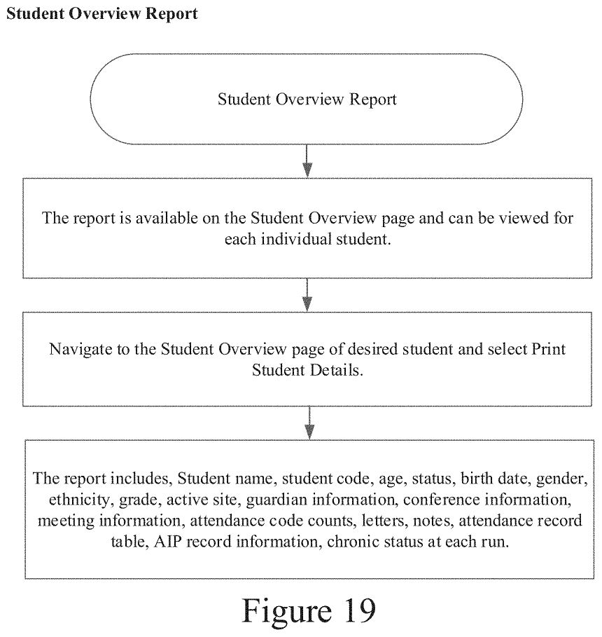

Referring now to FIG. 19 in an example embodiment, the Student Overview Report features of an example embodiment are illustrated. FIG. 19 is an operational or processing flow chart illustrating an example embodiment of a method as described herein for generating a student overview report. In an example embodiment, an updated version of the student overview report is available for clients to access through the user interface. The Student Overview Report is available for each individual student and shows all pertinent information regarding the student and their attendance. For example, the Student Overview Report can be configured to present among the following items of information via the user interface:
Student Information (name, student code, age, student status, birth date, gender, ethnicity, grade, active site, etc.)
Guardian Information (name, language, home phone, email, send email, address, etc.)
Conference Information (conference status, conference date, letter, location, etc.)
Meeting Information (meeting date, meeting type, meeting location, etc.)
Attendance Code Counts by type, code, and description
Letters (date, absences, letter, status, site, etc.)
Notes (date, comments, etc.)
Attendance Records Table (site, date, period, attendance code, etc.)
AIP Record Information
Table of chronic status at each run

The user can navigate to the Student Overview page of a desired student via the user interface and select an ‘Open Student Overview Report’ option from the dropdown menu. A PDF file of the report can be downloaded for the user to open and print.

In an example embodiment, users can see a summary of chronic absence percentages over time. Users can filter the report to drill down to a particular site, grade, ethnicity, or even down to each student.

Letters

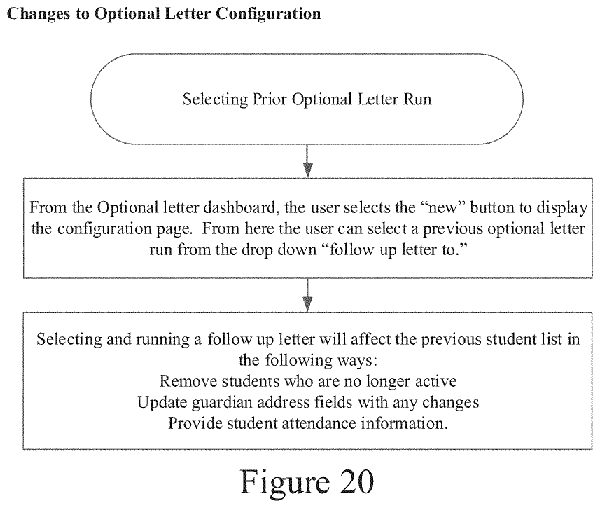

Referring now to FIG. 20 in an example embodiment, the Changes to Optional Letter Configuration—Selecting Prior Optional Letter Run features of an example embodiment are illustrated. FIG. 20 is an operational or processing flow chart illustrating an example embodiment of a method as described herein for effecting changes to optional letter configurations. The example embodiments provide some changes to the optional letter configuration features for selecting a prior optional letter run. The example embodiment provides the ability to send optional letters to a group of students who previously received an optional letter. This feature can be used for Attendance Improvement (AI) Tipping Point letters where two optional letters can be sent to the same group of students in a given school year. For example, the user can access the Optional Letter Dashboard in the user interface and click on the ‘New’ button to display the configuration page. From the configuration page, the user can select a previous optional letter run from the drop-down ‘Follow-up Letter to’ (the list-box will only show runs for the district selected). User selection and running of a follow-up letter will affect the previous student list in the following ways:
Removes students who are no longer active.
Updates guardian address fields with any changes.
Gives student attendance information including (chronic category, percent of school year missed, number of student instructional days, number of days missed, attendance start date, attendance through date, number of absences prior to last letter, and number of absences since last letter).

Back-End/Database Enhancements

In an example embodiment, the back-end system and database enhancements provides a variety of new features. A few of these features are listed below:
Student chronic absenteeism levels can be calculated during upload to the database—Student chronic absenteeism levels (Chronic, Manageable, Satisfactory, and Excellent) can be calculated each time a district uploads its truancy data. The Report Repository can use this calculation instead of calculating on its own so the chronic levels for each student will match up as long as they are run with the same attendance through date.
Year over year student tracking logic can be implemented in the database—An ID is provided in the database to link one student year over year. A user can follow distinct students year-over-year within a district.
Former A2A client data can be anonymized in the database—An administrator can anonymize identifiable (student/faculty) data. This includes inbound data, stored data, as well as backups.
The database can be configured to support fiscal year handling—Fiscal year handling to A2A back-end configuration tables is provided in the database, as well as to the configurators in the administration screens. The example embodiment can account for configuration changes made each year, which will benefit all year over year reporting.

In an example embodiment, a configuration utility separate from the ‘District Configurator’ is provided as part of the administration section of A2A. This configuration utility is called the ‘Code Configurator’. The Code Configurator can be used to map code definitions for additional data elements that an administrator may want to report on for A2A clients. The configuration utility enables normalization of the data between all clients for comparison. Codes from the District Configurator can be moved over to the Code Configurator so that all codes for a given district can be configured in the same area. Attendance codes can be housed in the District Configurator as they have a direct tie to letter generation.

Additional Features

In the various embodiments described herein, the system and method for student attendance management can be further configured to provide the additional features described below.

Course Schedules

In an example embodiment, the student attendance management system 200 is configured to include student level course schedule information. The student attendance management system 200 can be configured to collect information such as course code and course name, and link the student level course schedule information to each student's attendance data. For example, an example embodiment can determine and list the student level course schedule information for a particular student along with the student's absence information. For example, the example embodiment can display that the particular student had an unexcused absence in period 1 on June 8th, and that the class they missed was Math. The student level course schedule information is pulled into the student attendance management system 200 using the site-resident data collection module 210 and the same methodology that all other student and attendance data uses. Example embodiments have the flexibility to turn course schedules on or off by district. Currently, the course information is displayed in the Student Overview Page, described above, where the district or site user can toggle course information on or off. The course information displays with the attendance information. Course information can also be displayed in a pie chart to summarize what courses were missed. When the computer mouse hovers over each color of the pie chart, a tooltip appears to indicate the course type and the count of absences.

An example embodiment includes a configuration that allows the operations team to configure each period for normalized reporting. Configuration can be applied by district, site, fiscal year, and district course code. For example, a course Math 105-B can be configured to be labeled simply as ‘Math’. This way, an example embodiment can provide reporting by core subjects (e.g., Math, Science, English or Language Arts, Social Studies, Foreign Language, and Other) back to the district as well as compare attendance at multiple sites or districts.

Fiscal Year Dropdown in Student Overview Page

Districts frequently request the ability to view student level information year over year from within the user interface of the student attendance management system 200. To fulfill this request, an example embodiment includes a fiscal year filter within the Student Overview Page where the user can toggle back and forth between years. The client is able to access and view all student and attendance information for the same student across multiple years with the click of a button.

Calendar View

In an effort to better display attendance information for consumption, an example embodiment can be configured to allow the district or site user to view a student's attendance in a calendar format in addition to the existing table view. This allows the user a new perspective to easily digest attendance trends by student on a given day, week or month. This feature also allows the administrator to filter based on letter, attendance code and chronic status (same as the existing attendance table).

Meeting Ad Hoc Conferencing Feature

An example embodiment can be further configured to include a function for documenting a meeting that allows the district or site user to close an associated conference for a given student and document the meeting at the same time. If the user decides to close the conference, the student meeting will be marked as conducted on the back-end. If the student was already in a scheduled group conference, the system will automatically convert them to an individual conference.

Bookmarking a Student

To provide an ease of use to our clients, an example embodiment includes a bookmark feature that allows district users to save students to the left navigation bar. This feature will benefit users who are monitoring specific students, as the students they bookmark will always show up on the left navigation bar every time the user logs in.

Chronic Letters

An example embodiment can be further configured to include a feature for generating a chronic absence letter to be sent once a student misses 10% of the school year (with at least 9 full day equivalent absences). This feature provides a letter option that can be configured should a district sign up for this letter type. The trigger of 10% with at least 9 full day equivalent absences is a recommended configuration for sending chronic letters; however, the example embodiment provides a mechanism to adjust the percentage of the year missed in combination with a whole number integer of absences. The example embodiment enables this trigger adjustment to be configurable by district, site, and/or grade.

Letter Attendance Window

An example embodiment can be further configured to support the generation of specific letters based on attendance during a specific period of time. For example, a district may implement a letter of type ‘mid-year’ if it only wants to send off attendance from that point forward to avoid a large influx of letters triggered off past attendance. This feature is also helpful for configuring special letters that are only sent to students at the beginning of the year.

Configurable Student Age Letter Triggers

California compulsory attendance requires students to attend school from ages 6 to 18. The student attendance management system 200 can be configured to handle exclusion of students outside of this age range from receiving letters. However, the compulsory attendance laws vary across states; the starting age can range from 5 to 7 years old, and the ending age ranges from 16 to 18 years old. The student attendance management system 200 can be configured to support the particular districts according to compulsory education laws that apply to the given state. Additionally, an example embodiment includes the ability for the internal users to edit age triggers.

Period Configuration Utility

An example embodiment can be further configured to support an expanded district configuration by adding sections that allow an internal operations team to manage and manipulate attendance periods by year, district, site, and even grade code. This allows the example embodiment to be compatible with all unique attendance methods encountered thus far. This configuration is essential to the operations team as there are many sites that have unique attendance practices. There are many unique attendance practices and manipulations that happen in the raw data the student attendance management system 200 receives from various districts. This period configuration feature allows the student attendance management system 200 to adjust for these instances so that the district and site users will always see the attendance as they entered it, and the letters will generate off the correct attendance as well. In various embodiments, the period configuration feature can be used for:
Designating one period as all day;
Shifting periods or renaming periods;
Flagging periods to trigger/not trigger letters and chronic calculations;
Flagging periods to display/not display in the user interface; and
Designating a period range.

This is not a limited list as the example embodiments may come across more unique attendance configurations as more clients are gained. This period configuration feature is built to be flexible and different configurations can be applied without changing the basic framework of the system. Just like all other configuration utilities of the various example embodiments, the period configuration feature only needs to be set up once upon district implementation and maintained annually.

My Dashboard Feature

An example embodiment can be further configured to support a user interface denoted ‘My Dashboard’. This user interface feature allows district and site end users to build their own reports using student and attendance data to fulfill unique needs. For example, the following capabilities are provided by the ‘My Dashboard’ user interface feature:
Users may build and create their own charts/reports;
Users may save reports they created to a ‘Favorites’ section;
Users may delete and reorganize reports they built;
District specific reports can be stored and shared between users at that district;
The operations team can build and display reports to end users; and
Help tooltips and messages throughout the My Dashboard user interface feature assist and guide users in building their own reports.

Fiscal Year Filter for Interactive Reports

An example embodiment can be further configured to support ‘Fiscal Year’ filters to both client facing Interactive Reports: Interactive Chronic Absenteeism Analysis and Attendance Analysis Reports. This filter allows a user to access prior year reports to view trends based on attendance data.

Monthly Filter for Interactive Reports

An example embodiment can be further configured to support a filter added to interactive reports to allow clients the ability to view attendance trends by month or attendance through date. This feature has been provided to align with state reporting requirements as well as provide a metric for future year over year reports in the user interface.

Client Site Verification Report

An example embodiment can be further configured to support a client site verification report. This internally accessed report can be created for the operations team to export and send to clients in order to verify important configuration details. This report is part of the verification process at the start of each school year with existing clients, or with new client implementations. The report is purposefully formatted in an easily digestible format with directions so that clients can easily review and send back to confirm their configuration details.

Monthly Chronic Calculation Logic

An example embodiment can be further configured to calculate each student's chronic absence level during data upload and letter generation. As a result, monthly chronic absence calculations can be performed down to the student level. The student attendance management system 200 can leverage this data by allowing monthly filters in the user interface reports as well as monthly analysis on reports prepared for clients.

Automated End of Year Data Pull Run

Most districts stop their letter runs about a month before the end of school. This means that the last data pull is out of date once the end of the school year is reached. To remedy this, an example embodiment can be configured to manually or automatically pull an updated data set a week after the end of school for each district. In example embodiments, the timeframe for performing the manual or automatic data pull after the end of school for each district is configurable and adjustable. This manual or automatic data pull at the configured time allows us to have a full year's worth of data, which is imperative to have for reporting. To streamline these ‘End of Year Data Pulls’, an example embodiment can be configured to update the scheduler module so that a manual or automatic data pull is no longer needed. An example embodiment can be configured to update the internal scheduler module so that the end of year data pull for each district is automatically added to the production schedule when it is created by the operations team. This streamlines the end of year data pulls by eliminating the need for the operations team to manually enter end of year runs into the scheduler module for each district.

Other Consolidated Features and Enhancements

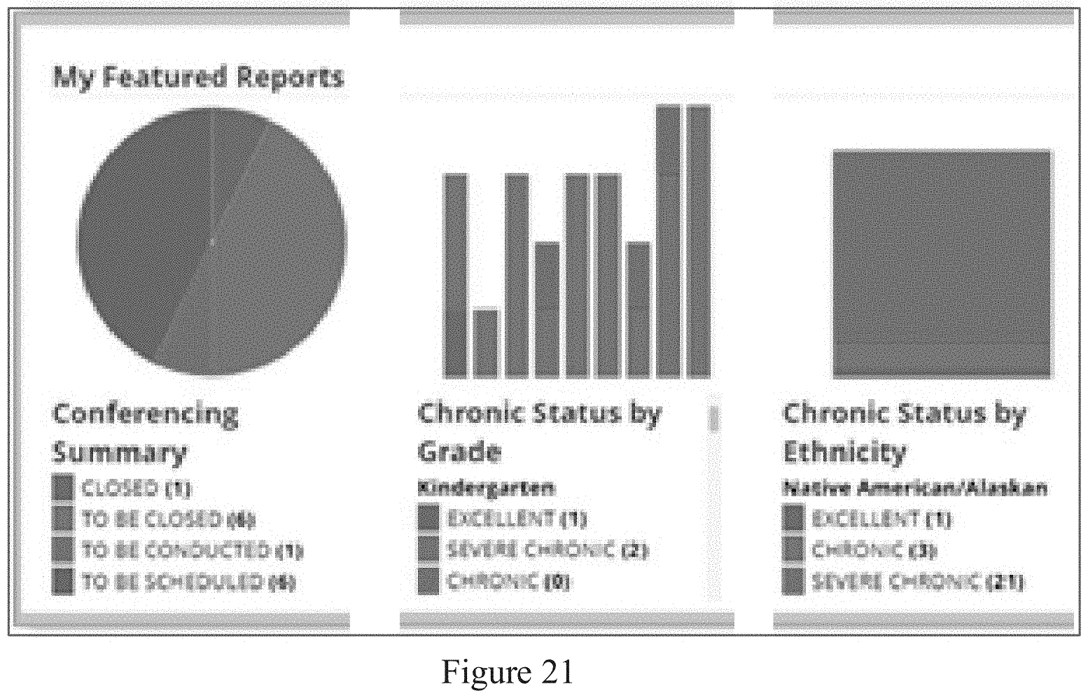

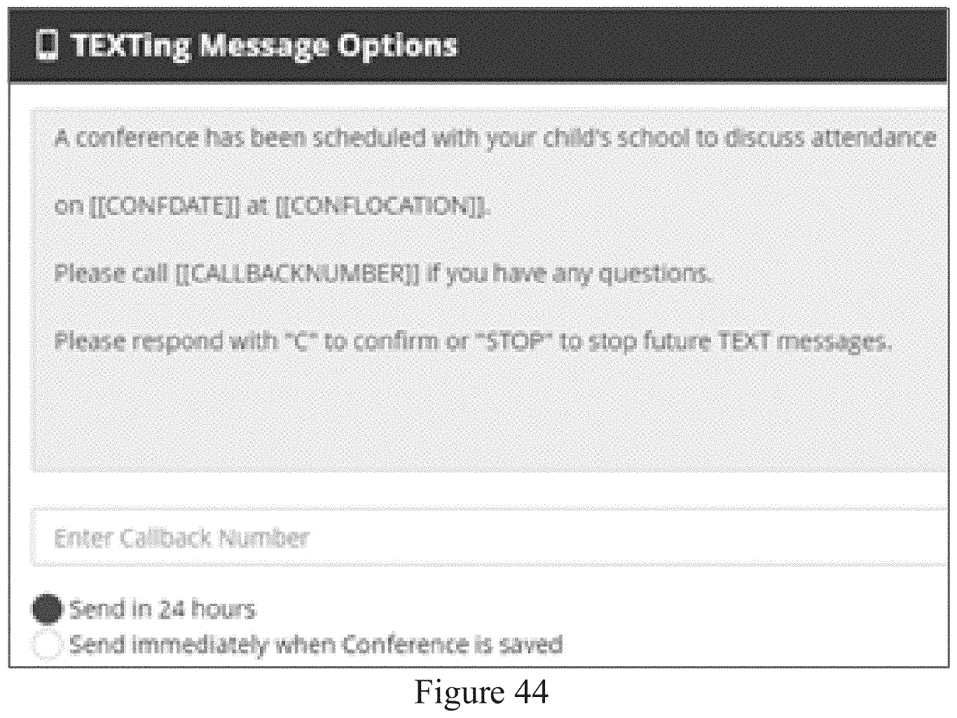

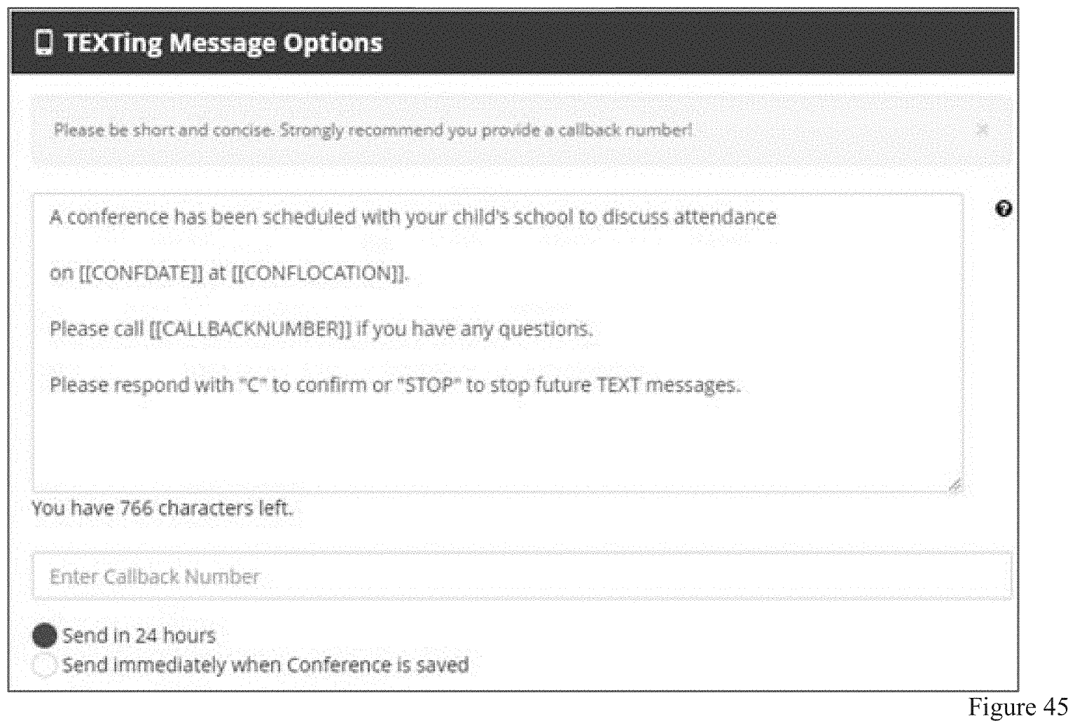

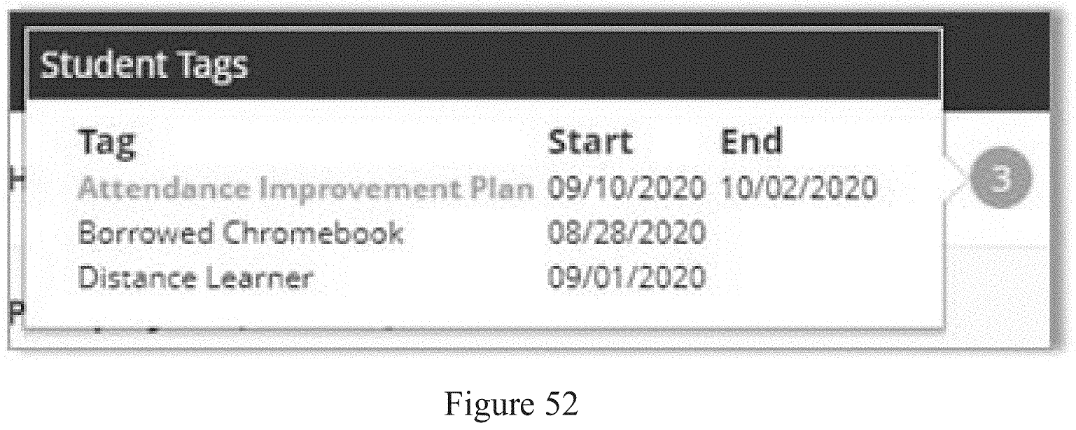

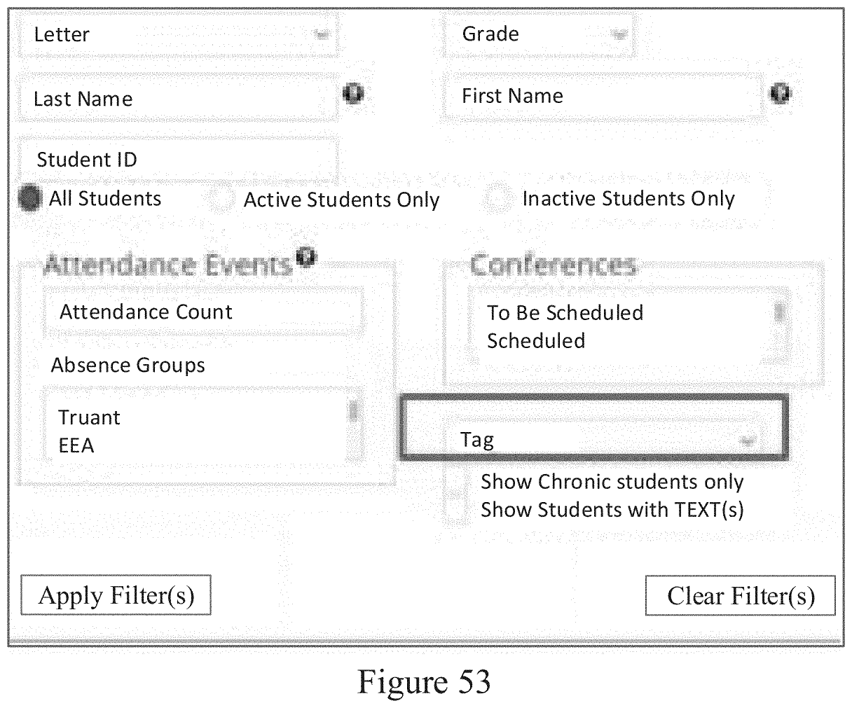

In the various embodiments described herein, the system and method for student attendance management can be further configured to provide the additional features and enhancements described below. In particular, the user interface (UI) provided by an example embodiment (also designated A2A) incorporates and enables these additional features and enhancements through user prompts, information displays, and report generation. These UI features and enhancements are described below and illustrated in FIGS. 21 through 69.

My Dashboard Enhancements—Nightly Upload, Featured Reports & Drill Level

Referring now to FIGS. 21 through 32, the additional features and enhancements for the My Dashboard UI supported by an example embodiment are illustrated. The My Dashboard feature and format has been changed to match the A2A Reports page more closely. The particular enhancements are described below.

My Featured Reports

Referring now to FIG. 21, similar to the A2A Reports ‘At a Glance’ visualizations, the My Dashboard module will have three targeted ‘My Featured Reports’ at the top of the page. We will have three default charts available at the top for all districts to see. These charts can come from the Reports tab and can be changed by unpinning the current charts and pinning the desired default charts. Changing default charts will impact all districts.

Pinning Charts

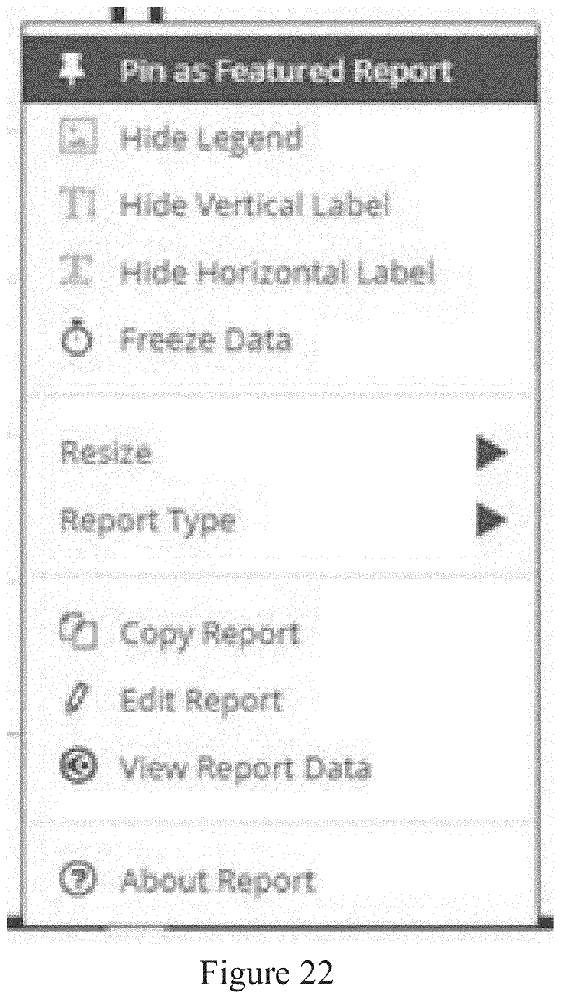

Referring now to FIG. 22, because we would like clients to customize their dashboard to meet their needs, we have created the ability pin different reports to the top of the page.

Steps Required for Pinning Reports
Identify the report they would like to pin to the top of the page, from their ‘Favorite Reports’ tab.
Click on the gear wheel on the bottom right-hand corner of the chart.
Select the ‘Pin as Featured Report’.
See FIG. 22

The page will swap out a default report for the user's featured report choice.

Unpinning Featured Reports

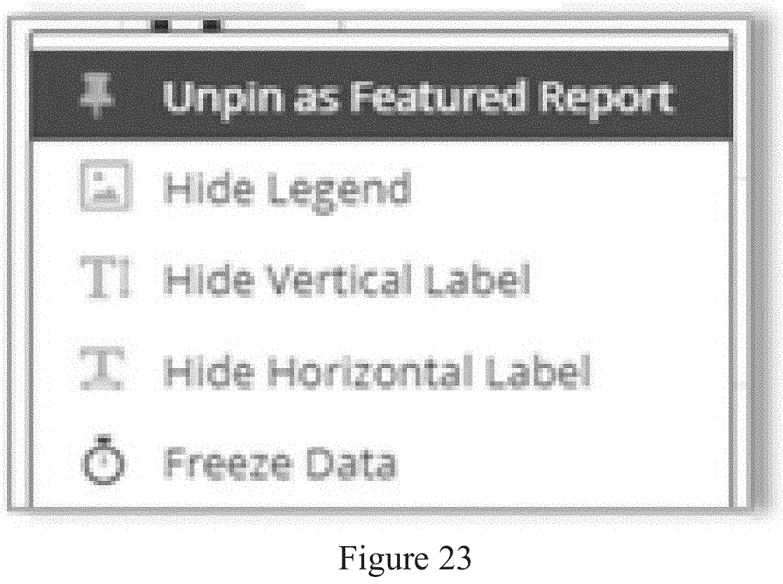

Referring now to FIG. 23, if a user would like to change or remove their choice of featured reports, the user can simply identify the report they would like to remove from the top of the page (These will be found in their ‘Favorite Reports’ tab), click on the gear icon, and select ‘Unpin as Featured Report’. A default report will automatically replace the recently unpinned feature report, until it is replaced with another user selected report.

New Oversight Reports Tab

This new tab will be available for districts with nightly uploads. The objective of this tab is to have a central location for users to monitor attendance trends on a daily basis. We will build out reports in this tab as we add attendance filters to the My Dashboard module.

Report Builder Moved to ‘Customize’ Button

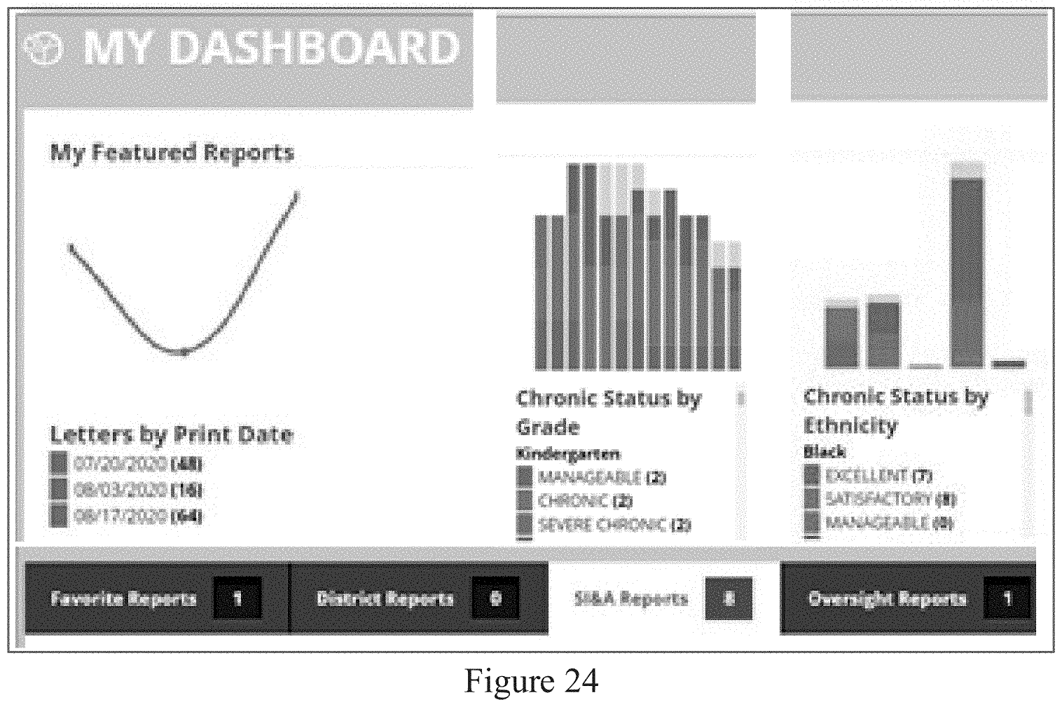

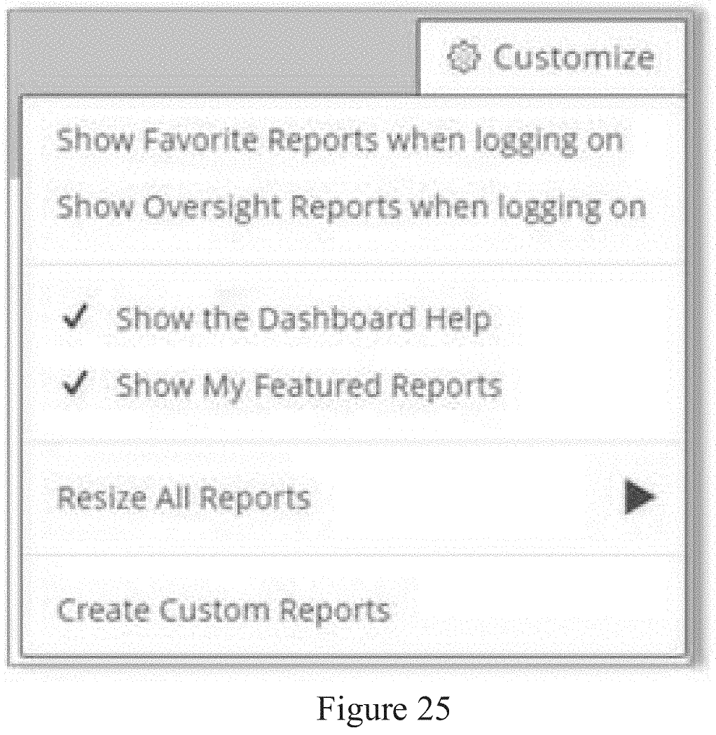

Referring now to FIGS. 24-25, the report builder has been moved from one of the My

Dashboard Tabs to a ‘Customize’ button on the top, right-hand side of the page. Menu options are available in the ‘Customize’ button. Within this button, users will be able to set their ‘Favorites’ tab, or the ‘Oversight Reports’, for district enabled for nightly uploads, as their landing page when logging into A2A. The ‘Create Custom Report’ at the bottom will link to the report builder.

Drill-Down Capability in My Dashboard

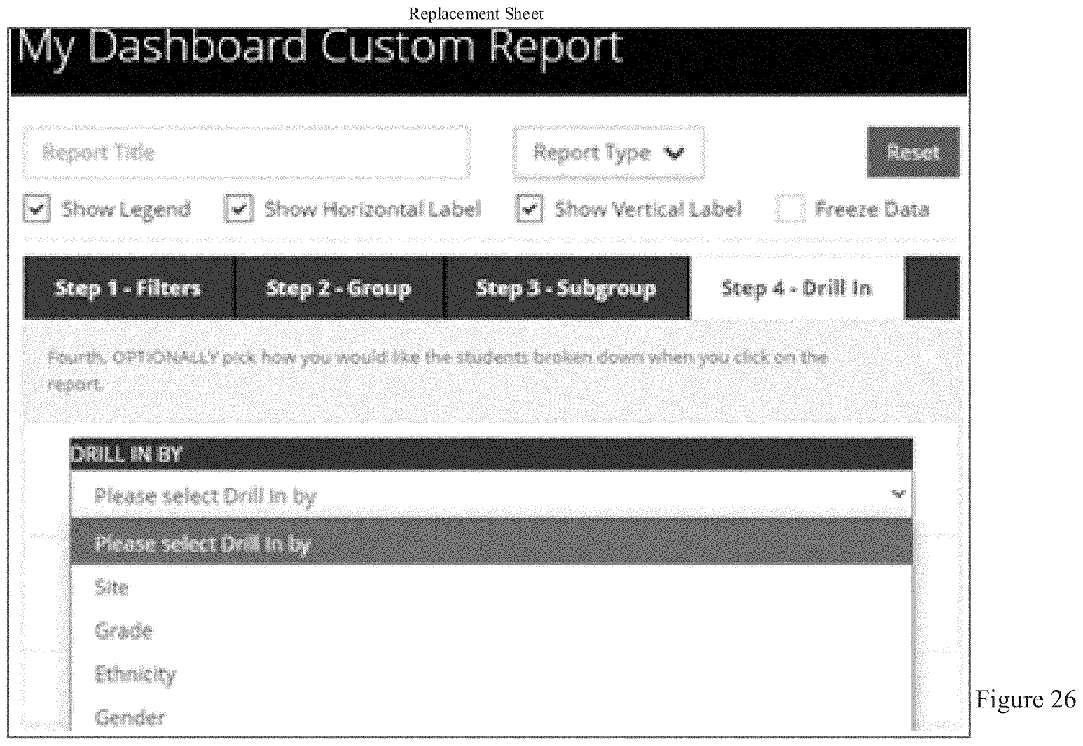

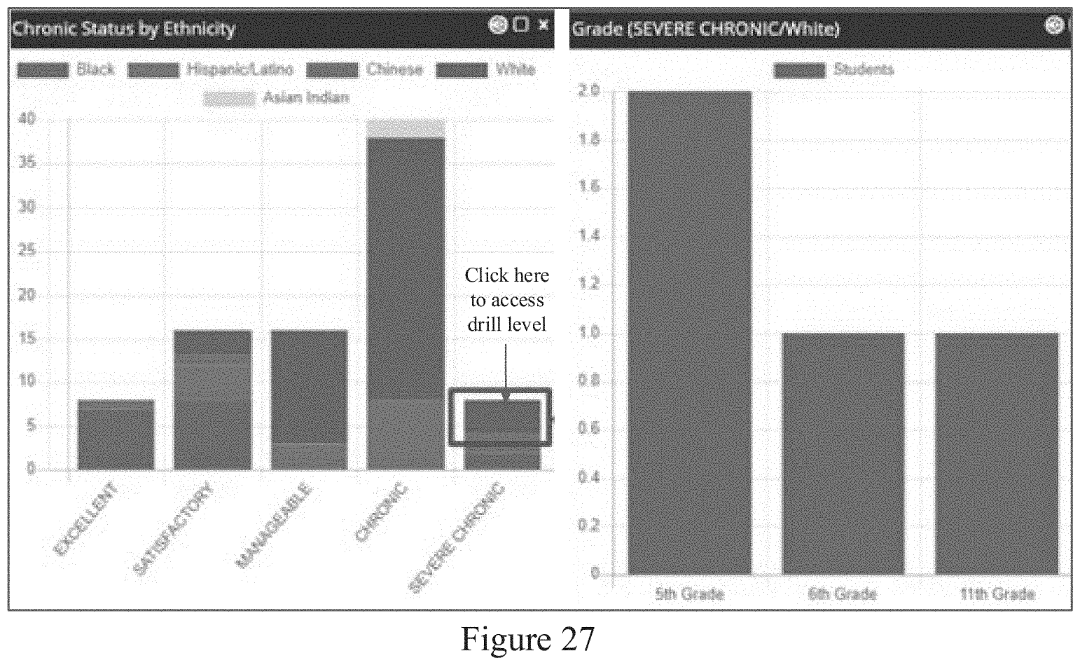

Referring now to FIGS. 26-27, we have also made the My Dashboard reports interactive. Instead of creating different charts for multiple different variables, users can now drill down a level into a report. Within the report builder (now accessible via the ‘Create Custom Report’ option in the ‘Customize’ button), there is now an optional ‘Step 4—Drill In’. This step is not required to create a My Dashboard report. Users can decide to drill in by:
Site
Grade
Ethnicity
Gender

When a report with a drill level is successfully created, users can access the drill level by clicking on a specific variable within the chart. For example, a chart was created (see FIG. 27) showing the Chronic Status by Ethnicity, with a grade drill level. If a user wanted to investigate the white students who have a severe chronic status, he or she could simply click on the corresponding bar in the report. The report will take the user to a separate screen showing the grade breakout of white students with a severe chronic status. When drilling into a report, the title will change to first display the drill in type, and in parentheses, the specific variable the user selected to drill into. If a user would like to return to the main report level, perhaps to investigate a different subgroup of students, he or she would simply click on the arrow in the lower left-hand side of the drill-in chart.

Document Meetings—Add Virtual Meeting Type

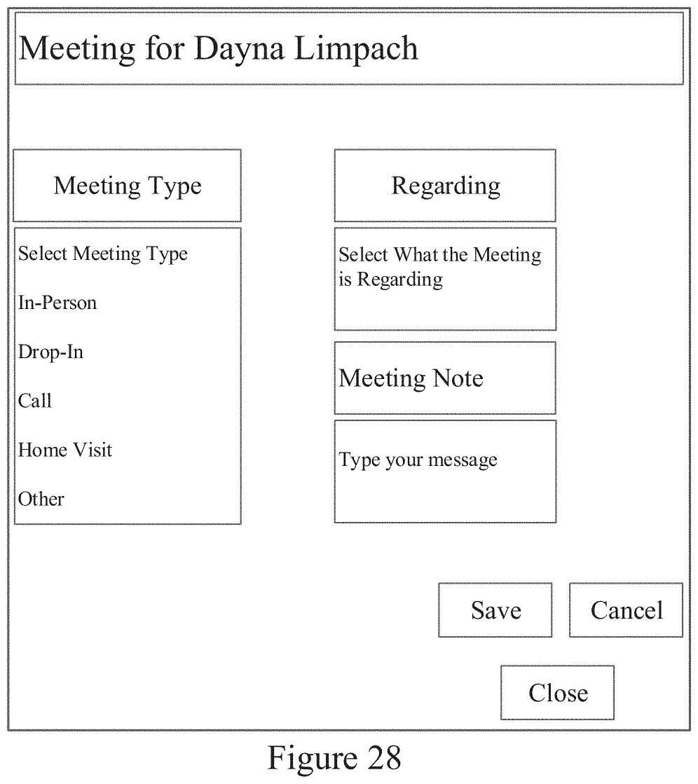

Referring now to FIG. 28, many clients are holding meetings online via Zoom™ or alternative platforms. In order to document meetings more accurately, we have added a ‘Virtual’ meeting type within the Documents Meetings feature in A2A. This option has also been added to the meeting filter in the My Dashboard feature.

Oversight Dashboard Enhancements

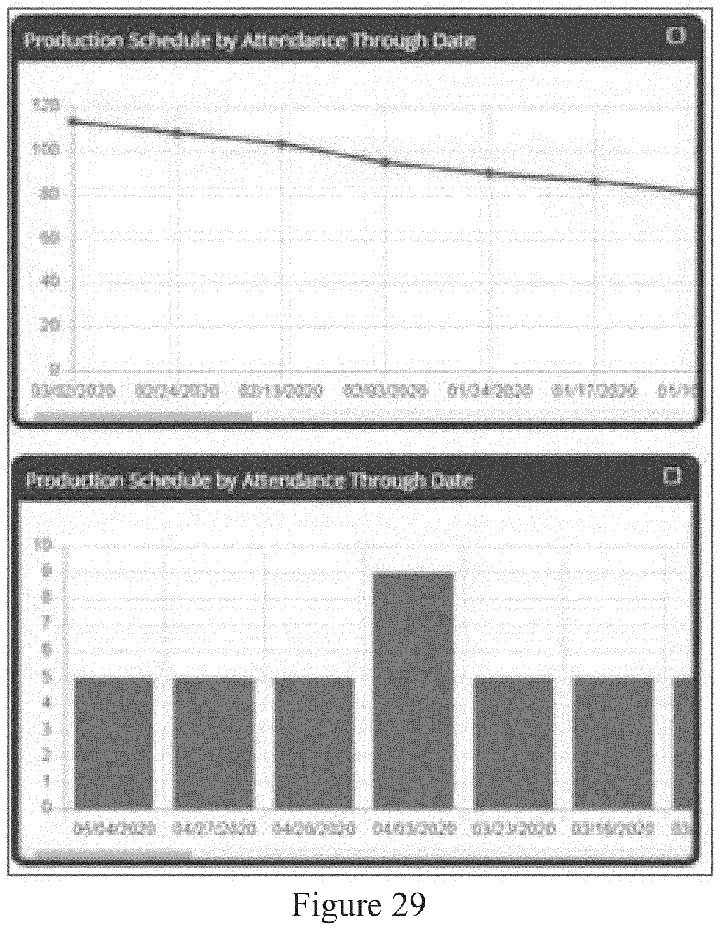

In an attempt to improve the usability of the Oversight Dashboard for data validations, we have made enhancements to some of the existing charts. FIG. 29 illustrates an example of a Production Schedule Chart. Instead of showing a cumulative count of instructional days, we have changed the chart to show the number of active school days within each run. This will exclude any holidays or important dates found in the district schedule. When a user clicks on the bar for a given print run, the drill-in chart will show a breakdown of the print run, including any important dates that were excluded from the count.

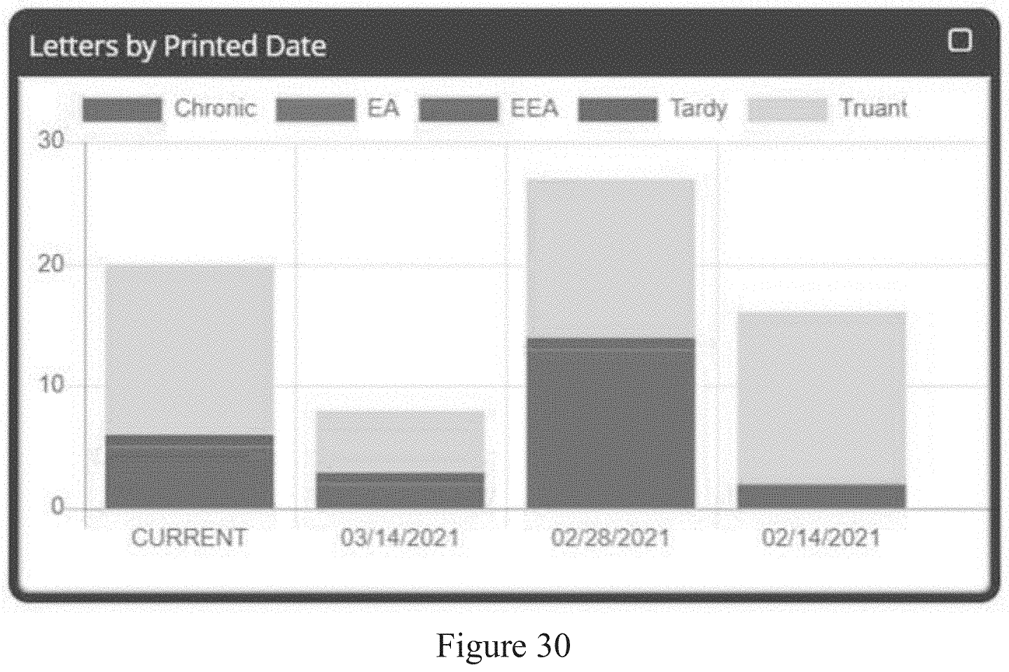

Referring now to FIG. 30, an example embodiment can be further configured to support changes to letter counts. The ‘Letters by Printed Date’ counts will now include all letters generated, including those with extended suppressions. This chart will not include counts for pre-loaded letters.

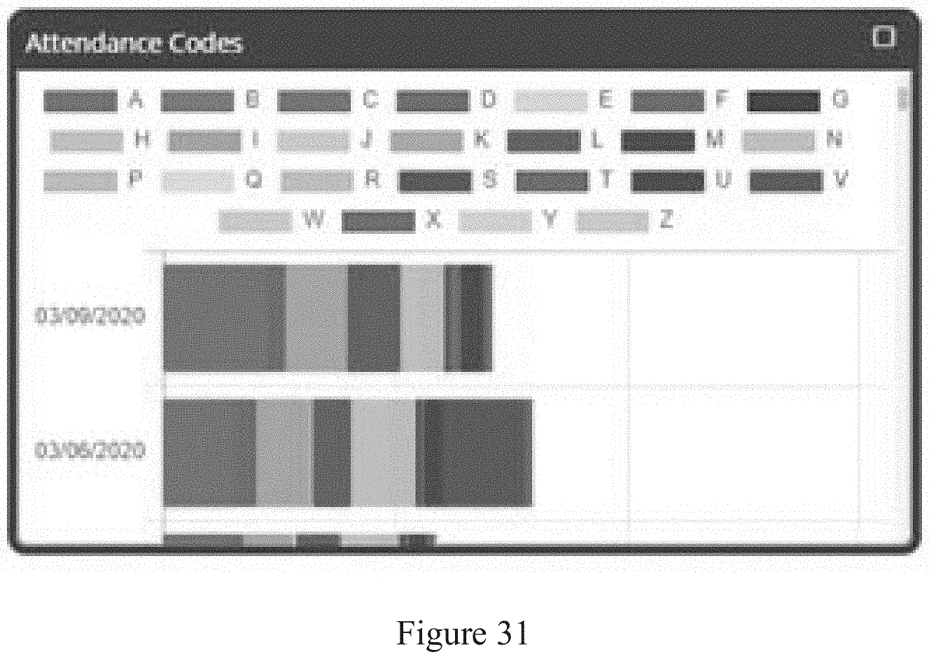

Referring now to FIG. 31, an example embodiment can be further configured to support a new attendance code chart. We now have the ability to view all letter codes, not just the letter generating codes. When attempting to view all letter codes to determine an overall spike or drop in code usage, a team can use the ‘Attendance Codes’ chart (preferable chart type: vertical or horizontal stacked bar chart). The chart can still be edited by clicking on one or more codes at the top of the chart area to filter them out of the count.

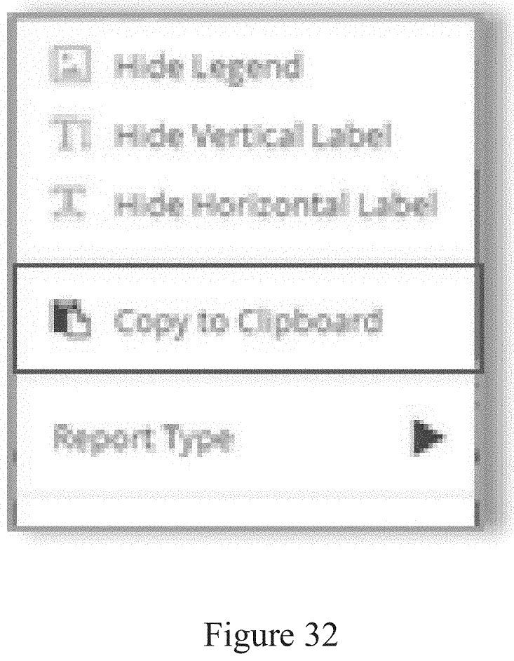

Referring now to FIG. 32, an example embodiment can be further configured to support copy to clipboard. The team now has the ability to easily copy these charts and include them in their emails to the Account Reps. In order to copy the chart, the user can click on the report options gear at the bottom right-hand side of any chart. The user can select the ‘Copy to Clipboard’ item and the chart will be automatically copied to the user's clipboard. The user will be able to paste it into a document or email.

Configurator

Custom/Generic Letter Types

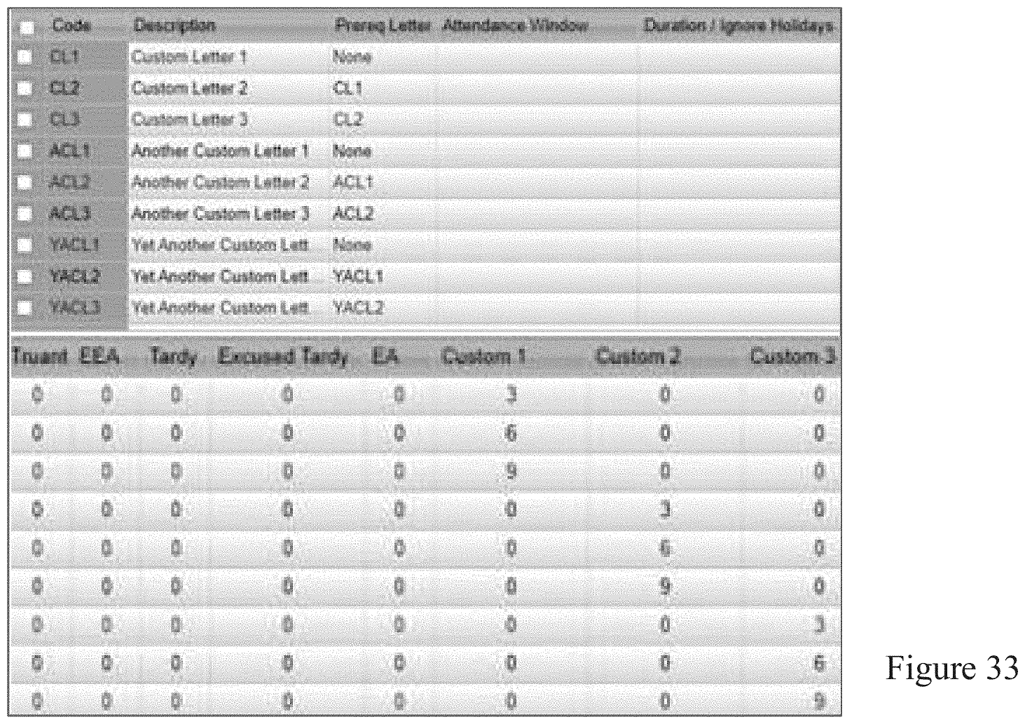

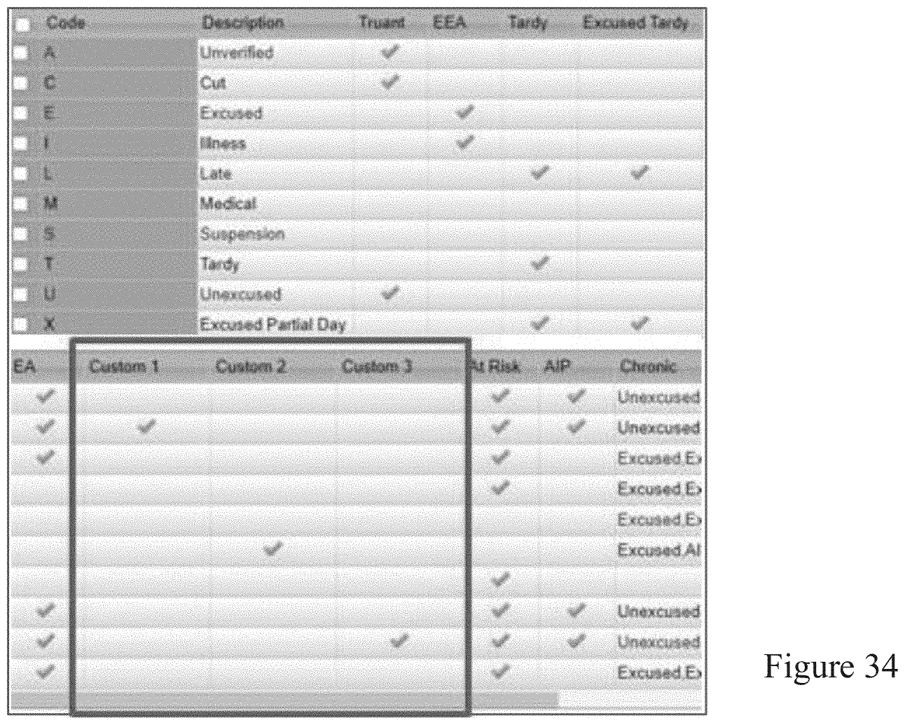

Referring now to FIGS. 33-34, an example embodiment can be further configured to provide three new letter types. They are set up as custom letter types that can be used for various different reasons. These letters use the same configuration structure as the other attendance letters. In the A2A Configurator, the user can select up to three new letters for the following letter types:
A Custom Letter (CL)—This letter type uses the Custom 1 column
B Custom Letter (ACL)—This letter type uses the Custom 2 column
C Custom Letter (YACL)—This letter type uses the Custom 3 column

The letter descriptions can be changed for each of these letter types to a specific letter name (designated by the district). Three new columns are also available in the attendance code section of the district level configuration to accommodate each of the three new custom letter types. Custom 1, Custom 2, Custom 3 values were added to the column headers and legend of this report. These pertain to the letter code to which these letters are configured. These new letter types will show up in the following reports:
Attendance Summary Report—Note: This report will pull the Letter Description from the district level letter configuration for the first letter in each of the series. If Custom Letter 1 description is ‘Distance Learning Letter’ the column header in the attendance summary report for that series will be Distance Learning.
Absence Accrual Report
Letter Detail Report
Generated Letter Report
Client District Site Report
Letter List Exports

Nightly Upload UI & Configuration Changes

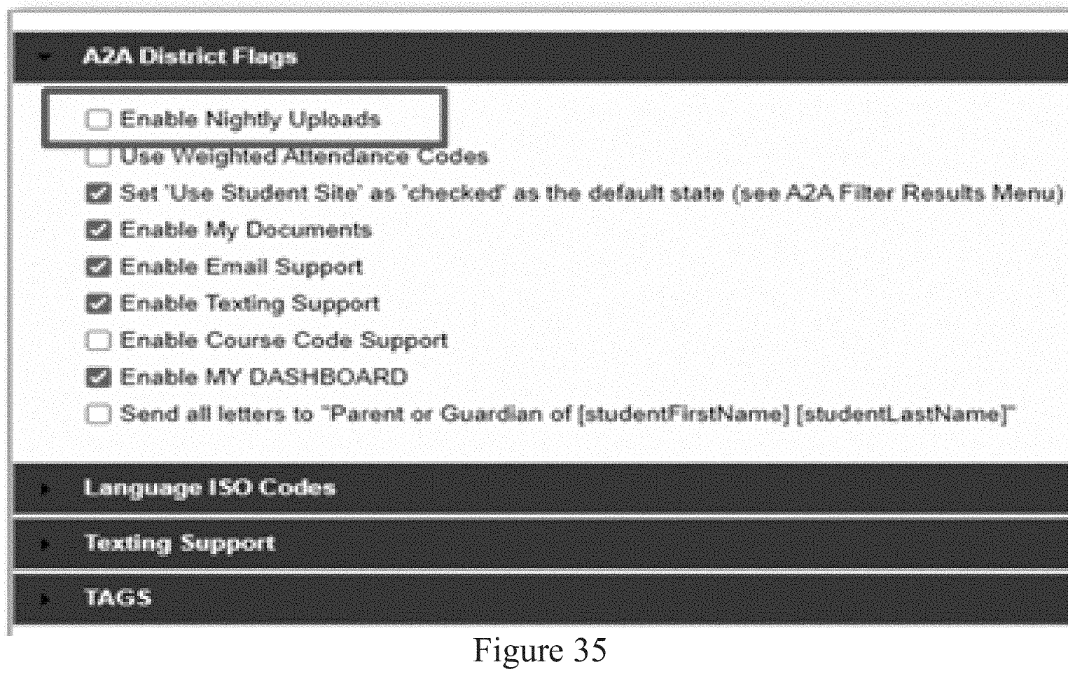

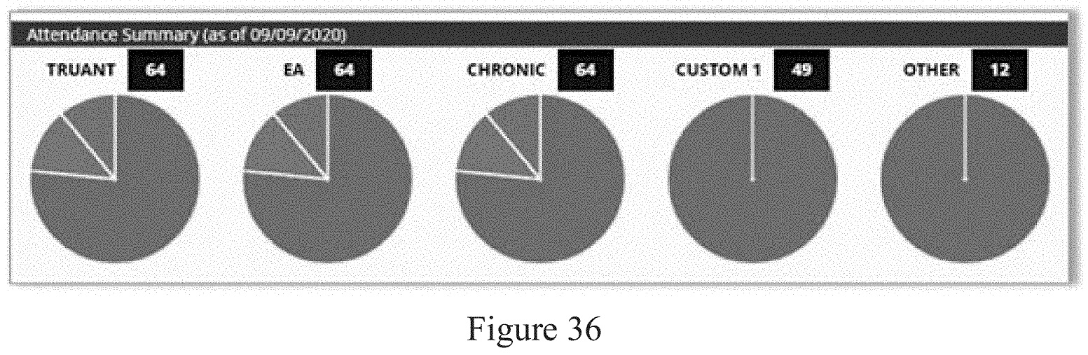

Referring now to FIGS. 35-36, an example embodiment can be further configured to implement changes to the A2A Configurator and the A2A UI to accommodate daily upload data. There is a new district level configuration available in the A2A Configurator under the ‘A2A District Flags’ accordion menu to enable nightly uploads. The attendance through date, review period, and print date have been added to the ‘To Be Printed’ tab to provide clarity as to what data triggered letters. The student details page will also include a ‘Data as of’ date next to the attendance summary pie charts. This date will list the most recent successful upload date.

Add Letter Contacts

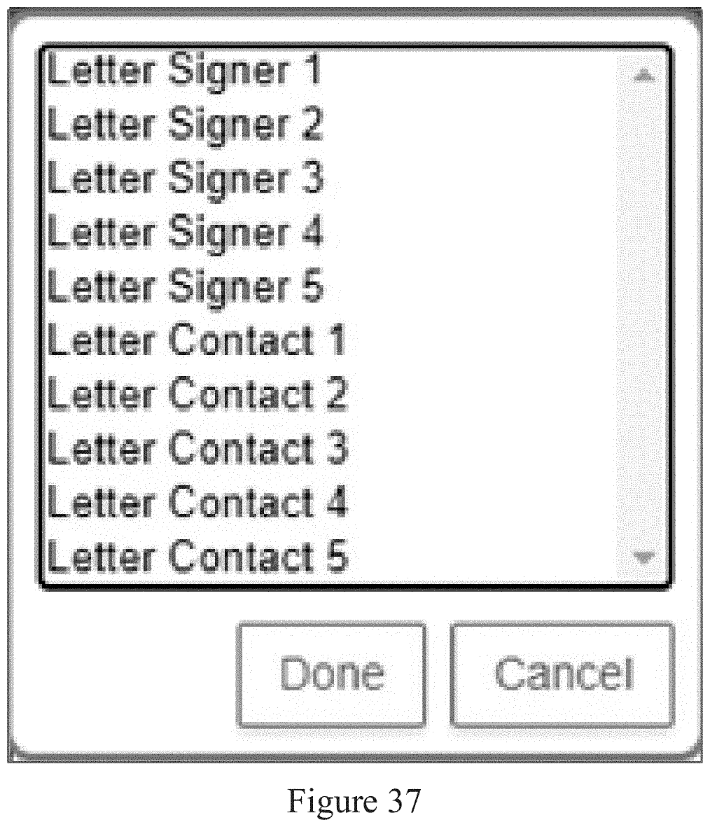

Referring now to FIG. 37, an example embodiment can be further configured to add letter contacts. In order to accommodate additional contact information in the distance learning letter templates, we have added three new letter contact fields and three new letter signer fields in the Configurator>>Letter Contacts menu. We can now map up to five different letter contacts and letter signers for each site.

Copy Site Level Configurations

Internal users now have the ability to copy the configuration of another site, in a respective district. This feature is intended to reduce the amount of time it takes to fully configure a district, by allowing account reps to copy certain site level configurations that differ from the district wide configuration.

Configurator Changes

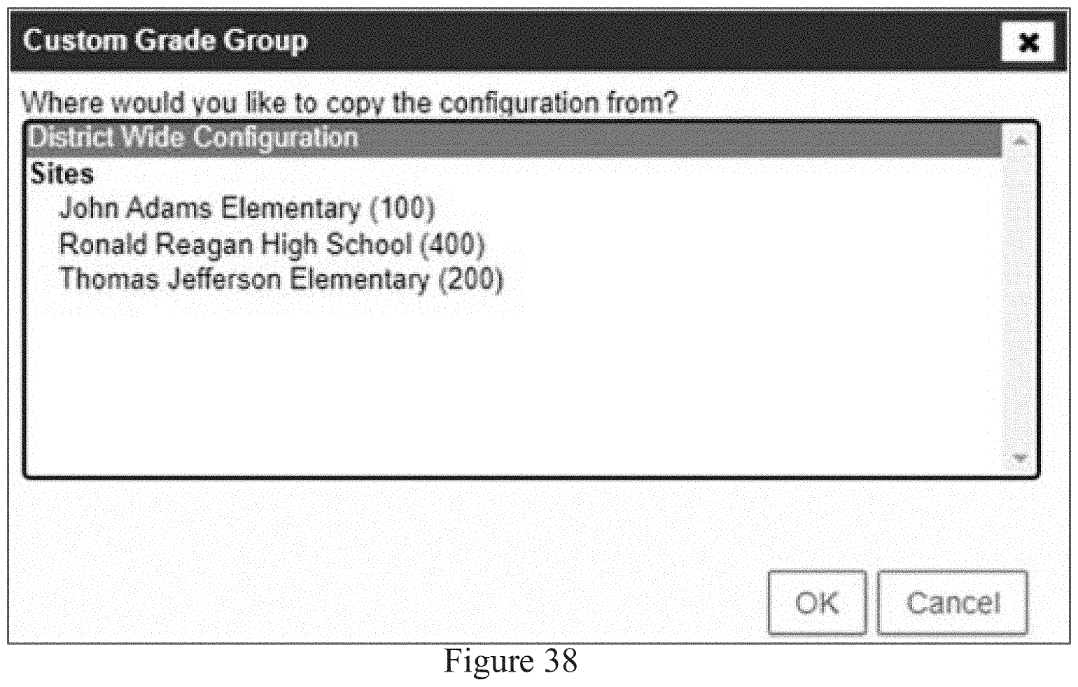

Referring now to FIG. 38, when viewing a site that is not using a custom configuration, the user can enable the ‘Use Custom’ checkbox, and a screen will appear. This will allow the user to select the site they would like to copy. This option is available for Grade Level Configuration and Attendance Codes sections. This feature will apply to grade groups. When copying a configuration from a site that has grade level configurations, all the configurations will copy.

Configurator: Daily Period Equivalency

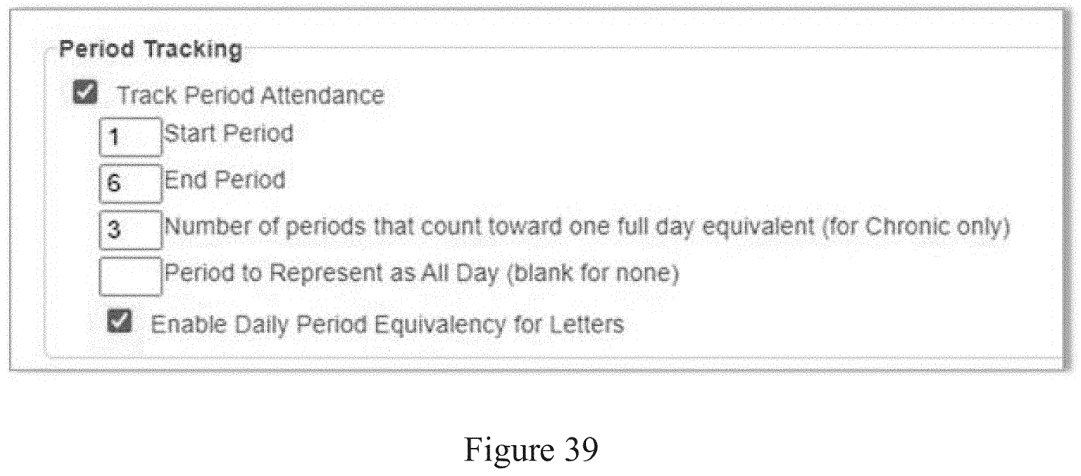

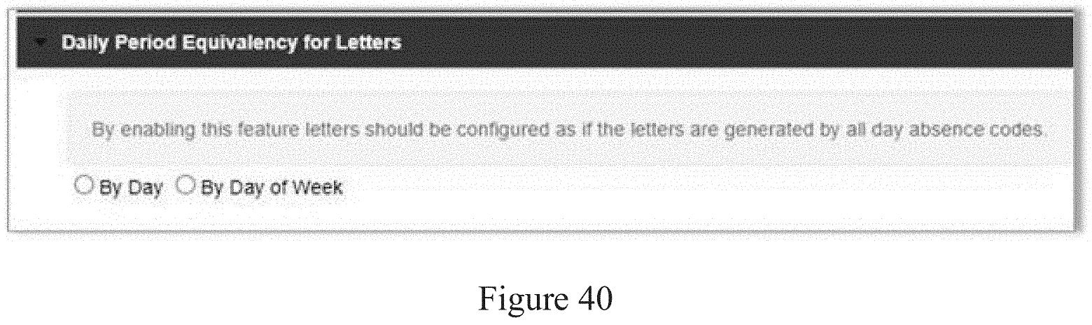

Referring now to FIGS. 39-40, some clients would like to only send letters based on full day absences. Additionally, they would only like to count full day absences as days where a student has missed a certain number of periods or more in a given day. We now have the ability to accommodate these requests. Within the configurator, we have a ‘Daily Period Equivalency for Letters’ menu. This will allow us to set the minimum number of periods a student must miss in order to qualify for an all-day absence. In the ‘Period Tracking’ section of the ‘Triggers’ accordion menu, there is a new checkbox to ‘Enable Daily Period Equivalency for Letters’. This checkbox will enable the ‘Daily Period Equivalency for Letters’ accordion menu. The district can set a single threshold for all days. The district can also configure a different threshold for each day of the week:

Texting

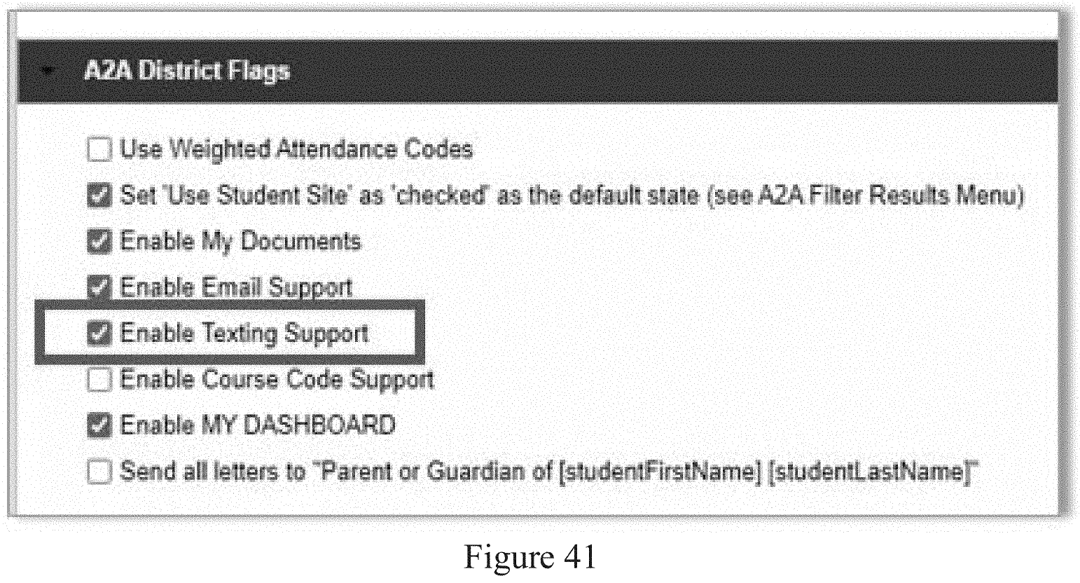

FIGS. 41 through 48 illustrate the additional features and enhancements for the texting features supported by an example embodiment. An example embodiment has the enhanced ability to send TEXT message notifications (users can send individual text messages via the UI as well). A description of the texting features of an example embodiment is provided below.

Configuration

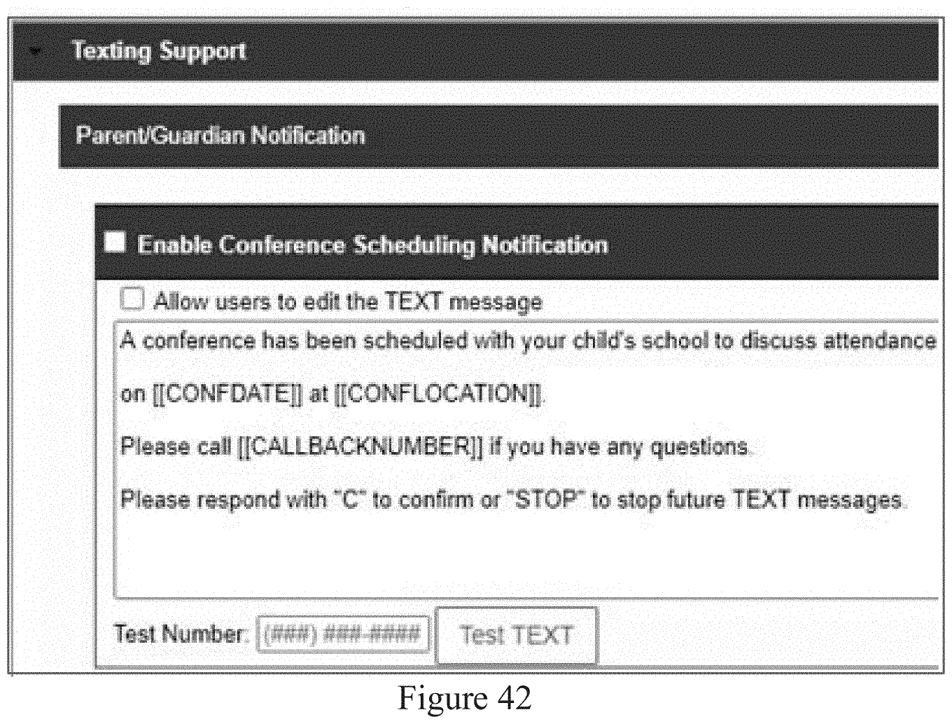

TEXT message notifications are configured at a district level in the Configurator. This will enable the ‘Texting Support’ accordion menu with the following features (see FIGS. 41-42):
The district can enable the Conference Scheduling Notification
Create a custom TEXT message if the default version does not meet their needs
Enable users to be able to edit the content of the TEXT message within the UI
Test the TEXT message notification prior to sending it to parents/guardians

Mobile Phone Numbers for User Accounts

In order to help troubleshoot potential issues with TEXT message notifications, a ‘Mobile Phone Number’ field has been added to the User Account Settings page in the various applications. This information will also appear in the user account page in the Users Admin UI next to a ‘Validate’ button. This button can be used to send a validation code to a specific user, to test the number's ability to receive TEXT messages. The validation code that was sent to the respective number will appear on the screen.

Scheduling a Conference

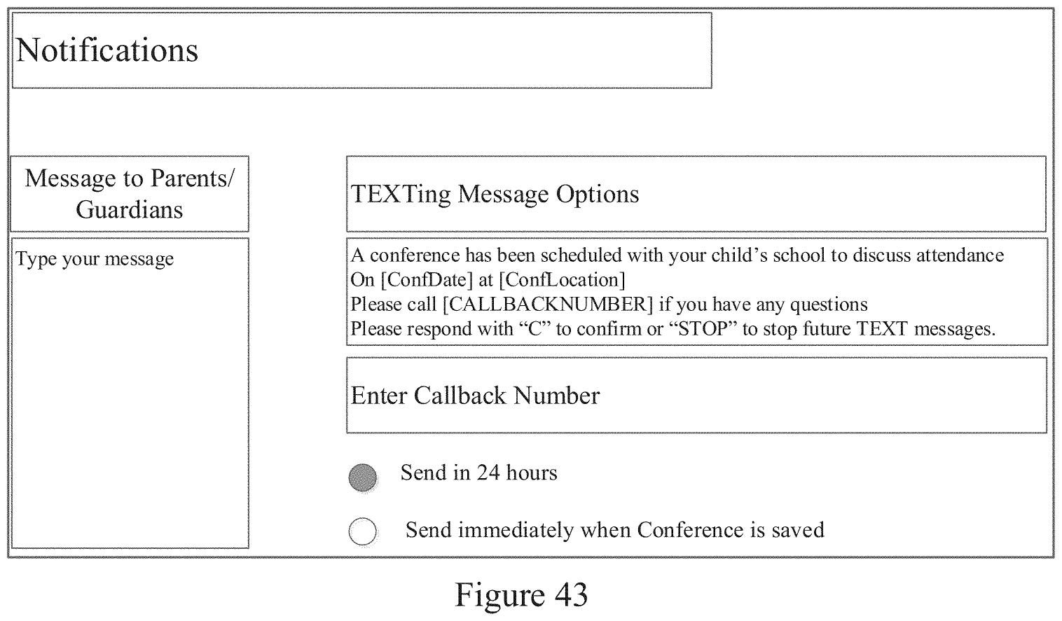

Referring to FIGS. 43 through 45, when a district has enabled TEXT message notifications, and one or more of the students have a guardian that can receive TEXT messages, the conferencing page with show a new notifications section to texting. The ‘Texting Message Option’ screen will appear gray if users are not enabled to edit the TEXT message content in the UI. It will appear white, and editable if the district enables users to edit the content of TEXT messages in the UI. Regardless of configuration, users will be able to decide if they would like to send the TEXT message 24 hours after the conference is scheduled, or immediately after the conference is saved.

Changes to the Student Overview Page

Any student who has received a letter, has a conference scheduled, or has an associated TEXT message, will see a ‘Communications’ box in the upper right-hand side of the student overview page. When a guardian responds to a TEXT message, the box will turn navy blue.

Communications Dialogue Box

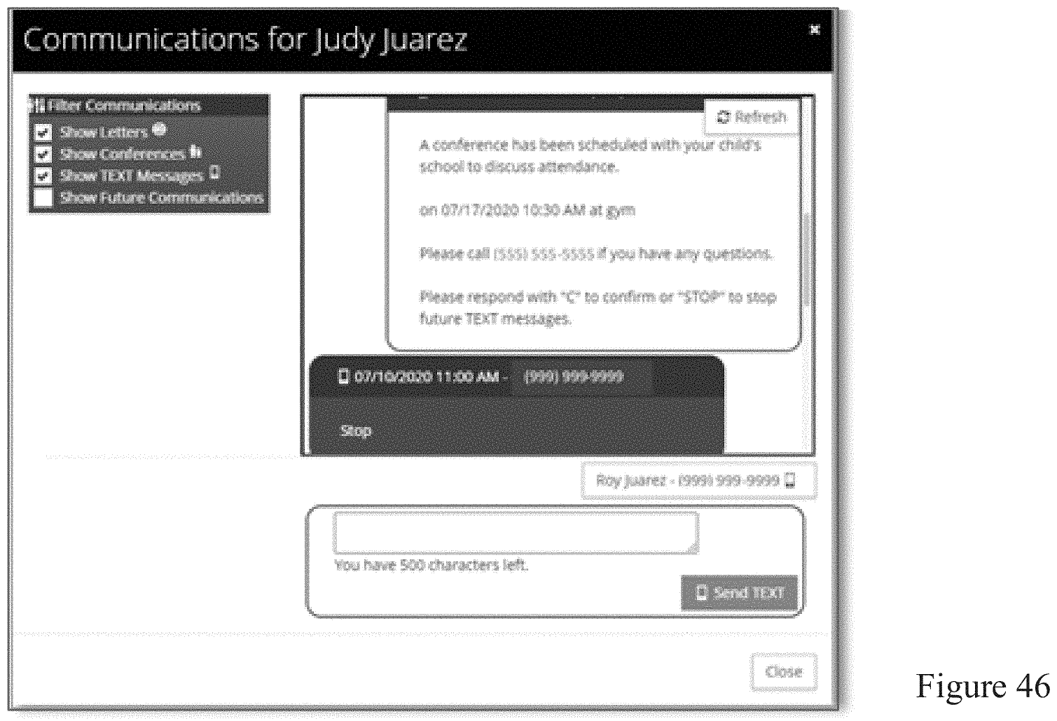

Referring to FIG. 46, users can view and filter the history of all communications by clicking on the ‘Communications’ box in the student details page or clicking on the phone icon on Letters, Conferences, or Students list page. Within this screen, users can select the communication type they would like to view from the filter options at the top. Instead of using personal devices to respond to guardians, users can reply to guardians directly from the Communications dialogue box. They can simply type their response in the space provided below, and click ‘Send TEXT’.

Export Lists

Any of the exports on the Letters, Conferences, and Students list pages will now include information for any student that has an associated TEXT message.

Student Overview Report

This report will now include any TEXT message correspondence. The information can be found at the end of this report.

Filtering Students with TEXT Messages

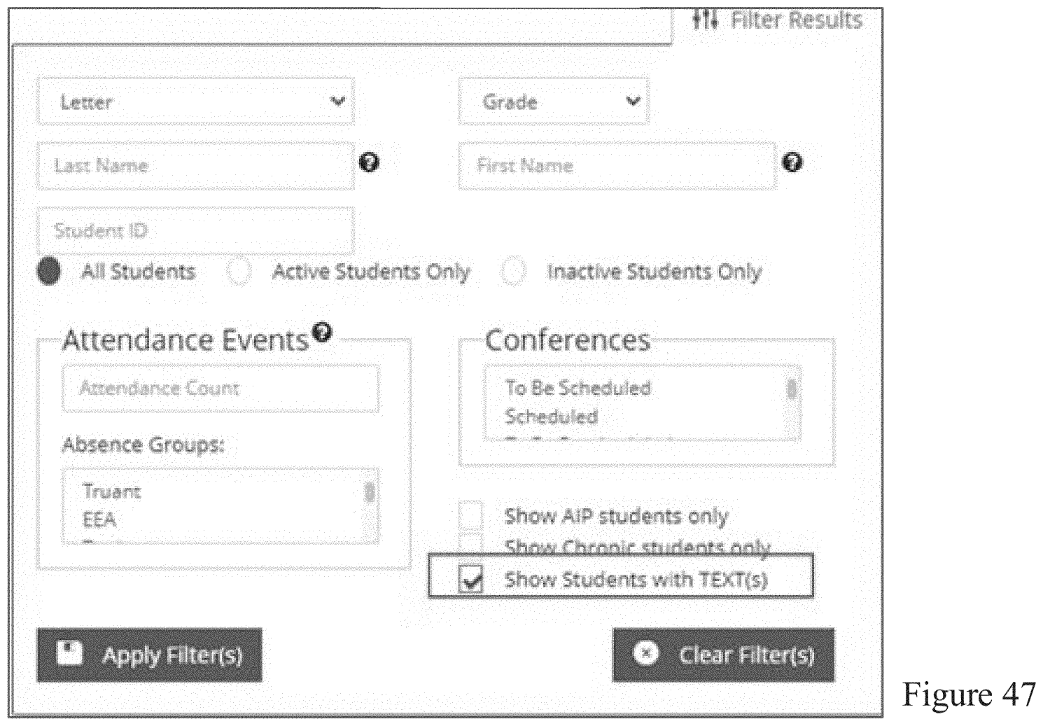

Referring to FIG. 47, when a student has a guardian who received a TEXT message, a phone icon will appear under the ‘Actions’ section of the student list. The icon will appear as one of these three colors:
Blue—If the student's guardian has received a TEXT, but has not responded
Gold—If the student's guardian has received a TEXT and has responded to the TEXT message
Red—If the student's guardian has opted-out of future TEXT notifications

Users can easily filter for students who have an associated TEXT message by selecting the new option in the Filter Results dropdown.

Texting—Opt-Out Logic

Guardians have the choice to opt-out of receiving future TEXT message notifications. This can be done by responding to the message with the word ‘STOP’. The system will flag this number and prevent TEXT message notifications from being sent out, unless they are re-enabled to receive TEXT messages. This can be done two different ways:
1. The guardian can once again respond to the TEXT message chain with the word ‘START’
2. A user in A2A can re-enable the guardian to receive TEXT messages

When a guardian opts-out of TEXT messages, the system will send an automatic response message. The red phone icon will appear next to the guardian name with a tooltip. If a user would like to re-enable a guardian for TEXT message notifications, they can do so by clicking the ‘Edit’ button on the respective guardian tile, and click on the ‘Enable Texting’ button. A confirmation box will appear. When ‘Ok’ is clicked, an automated message will be sent to the respective guardian. The system will track which user account re-enabled texting, and can be viewed by hovering over the phone icon in the response message.

Changes to Texting Framework—Separating Text Message Chains for Siblings

We have modified the existing texting framework to assign a specific outgoing number to individual students. This means that students who share the same guardian will have text messages sent from the system, to that guardian, using different numbers. Example: Three siblings with the same guardian in the system:
Any text message for Sibling 1 will be sent from modem phone number 1 to the guardian.
Any text message for Sibling 2 will be sent from modem phone number 2 to the guardian.
Any text message for Sibling 3 will be sent from modem phone number 3 to the guardian.

This eliminates the possibility of a guardian receiving text messages for multiple students, from the same number. This is dependent on the number of modem phone numbers we have available. Since we only have eight different numbers, any guardian that has more than eight students could receive messages about different students from the same number.

Change to Default Text Message Content

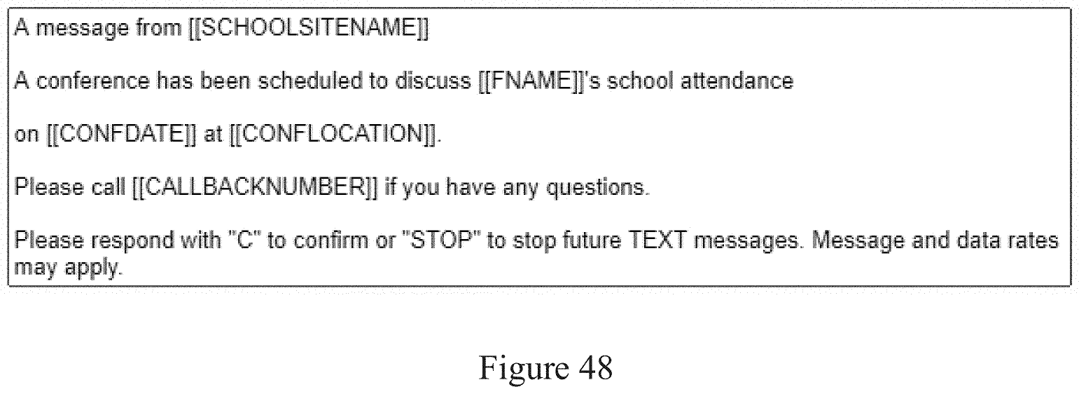

Referring to FIG. 48, we have changed the content of the default text message used for conference text message notifications. The values in double brackets (see FIG. 48) will be filled in with the respective student information when the message is sent.

Changes to Enable Communications Box for all Students

When a district has texting enabled, students no longer need at least one notification (i.e., printed letter) to have the ‘Communications’ button to appear on the Student details page. When a district is configured for texting, and the student has at least one guardian enabled for texting, the communications box will appear. Users will be able to send messages to the respective student's guardian from this screen.

Changes to the Communications Box Filters

Now when users access the communications dialogue box, the filters on the left-hand side of the screen will only display when the student has two or more types of communications (i.e., Letters, AI Letters, Conferences, and Text Messages).

Student Tags

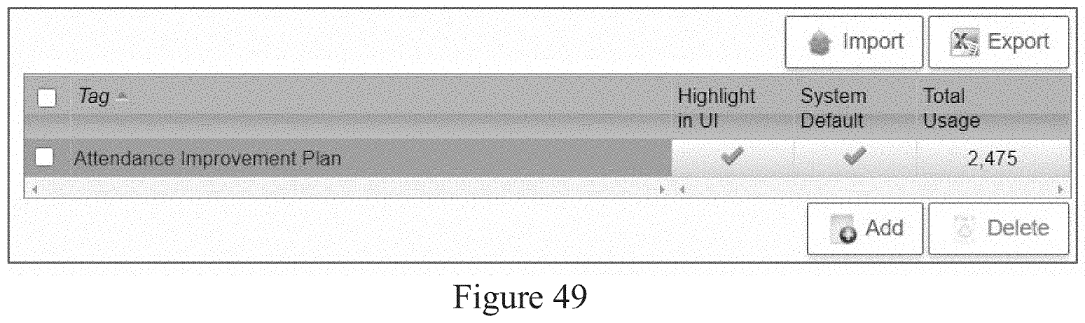

Referring to FIGS. 49 through 57, districts now have the ability to assign tags to individual students in the UI of an example embodiment. These tags can be customized to fit the needs of the district, and will help track the progress of specific groups of students. Student tags can be configured at a system level, as well as at a district level.

System Defaults

Referring now to FIG. 49, these tags will be available to all districts. These tags should be reserved for attributes used by many districts, to reduce the amount of individual district level configurations. This system level tags configuration screen (see FIG. 49) can be found in a new “System Defaults” node in the Configurator. On this screen, a user can Add, Delete, or edit tag values. Any edits made on this page will impact all districts, so changes should be made with great caution.

District Level Configuration

The system of an example embodiment also provides the ability to add tag values specific to a district. This can be configured via the individual district node in the Configurator. This screen is similar to the system default menu, however, from this page we can determine which tags values will be displayed in the dropdown menu in the UI. This will also show the individual tag usage for the respective district. A given tag can be selected to highlight in the UI. When a student is assigned one of these tags, the tag icon will change from blue to green.
This District Visible—This field determines which tag values are visible within the UI for users to select.
System Default—This field identifies if the tag is a system default. If this is not selected, the tag value is specific to the respective district.
Total Usage—The count of times this tag has been used by any system client.
This District Usage—The count of times this tag has been used within the given district.

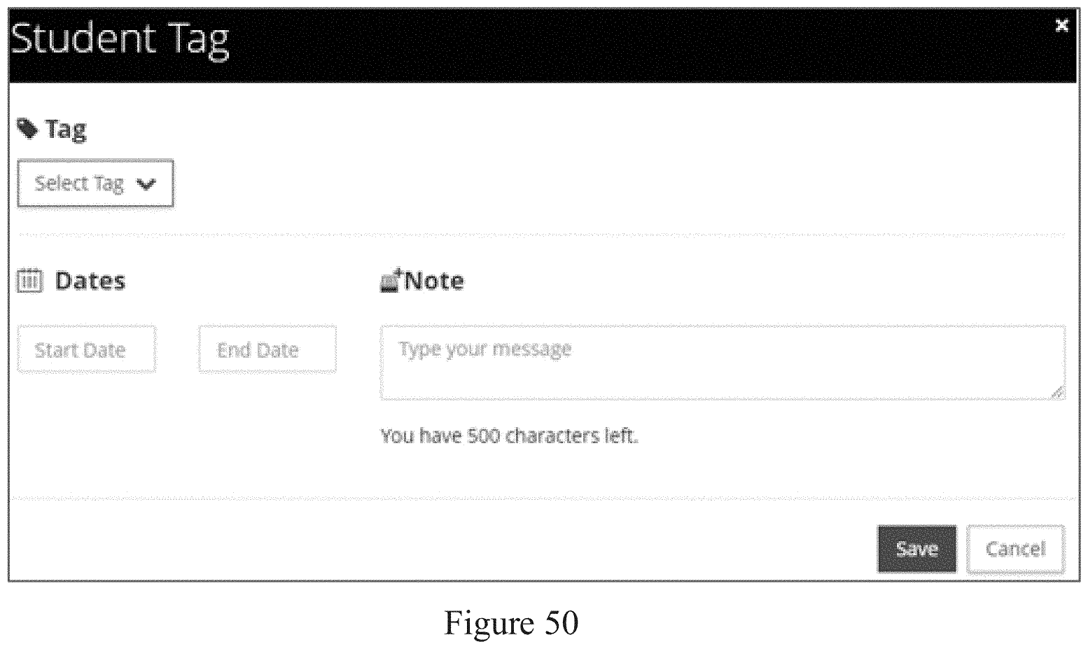

Referring now to FIG. 50, in order to add a tag to an individual student, a user can access the ‘Tags’ tab on the student details page and click on the ‘+ Add’ button at the bottom right hand side of the tab. This will pull up a dialogue box where users can select the tag from a dropdown menu, select the date ranges for the tag (start and end dates if applicable), and add a note. The user can assign the same tag to a student multiple times, but the date range cannot overlap. This will allow us to track if a student has been assigned a tag more than once. When a new tag is added, an additional count will be added to the icon next to the student's name. If this is the first tag assigned to a student, a circle icon will appear next to the name. The color is based on whether the student has a tag configured to be highlighted in the UI. The tag information will also show up in the ‘Tags’ tab, along with any additional tags that were assigned to the student.

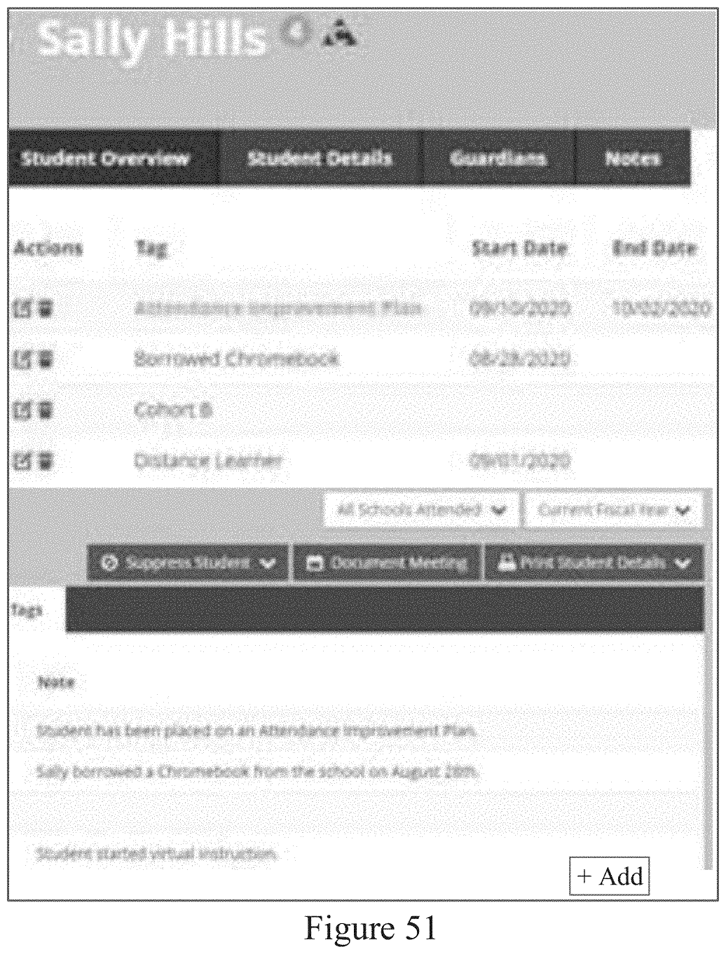

Referring now to FIGS. 51 through 53, when users hover over the tags icon in any area of the UI, a tool tip will display the list of assigned tags, as well as associated start and end dates. If the student is assigned a tag that is highlighted, the font color of that tag will display as green in the tooltip. This tags icon will display in any of the student lists pages, thereby allowing users to filter students in the UI based on specific tags.

Assigning Tags Via a Bulk Import in the Configurator

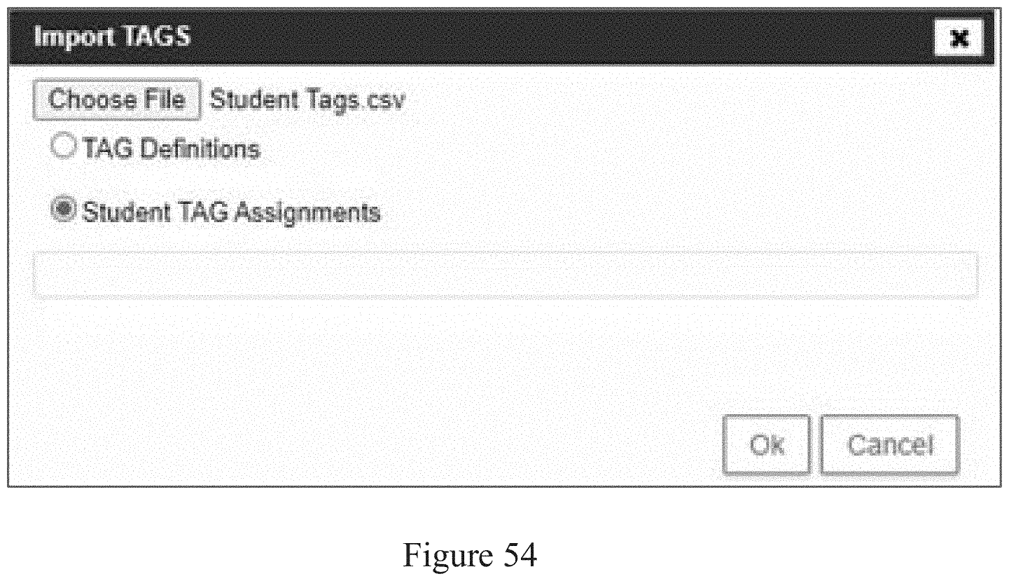

Referring now to FIG. 54, in addition to adding tags to individual students in the UI, an example embodiment also provides the ability for employees (e.g., Account Reps, Intervention Managers, etc.) to assign tags to a list of students. The user must first create the desired tag (if it has not already been created). Then the user can import the list of students. This can be done in the Configurator on the TAGS accordion menu. The system will allow an upload of a CSV file with the following headers.
#STUDENT_CODE—The student code for every student to which you would like to assign a tag
TAG_ID—This can be left blank when importing a list
TAG—The name of the tag (the tag must be created prior to importing the list of students)
START_DATE—A start date if applicable
END_DATE—An end date if applicable
DELETE—This will be FALSE for imports

When the file is done importing, the system presents a message stating that the import is 100% complete. This screen will also show the number of tags assigned to students (this will help us validate that all the students on the list received a tag).

Student Tags: Active Inactive Indicator

We have included logic to mark a tag as ‘active’ or ‘inactive’, in order to help the users distinguish between student tags that are actively being used and student tags assigned to students for documentation or historical purposes. The student tag status is set based on the start and end dates.

Active Student Tag Criteria:
Have no start or end date
Have a start date that has already passed and an end date that has not yet passed
Have a start date that has already passed and no end date

Inactive Student Tag Criteria:
Have a start and end date in the past.
Have a start and end date in the future.

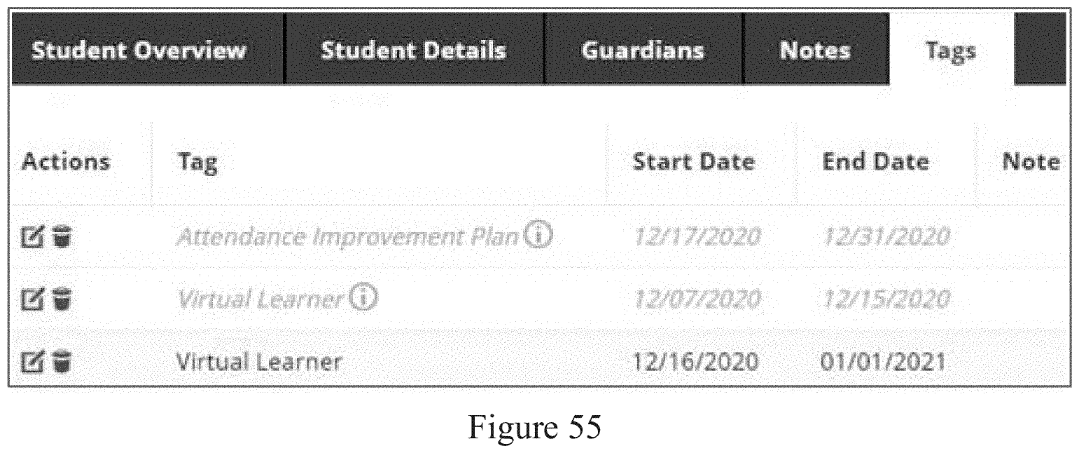

Referring now to FIG. 55, within an individual student page in in the system of an example embodiment, the Tags icon next to the student name will only count active student tags. The tool tip that appears when hovering over the Tags icon will also only display active student tags. On the ‘Tags’ tab in the individual student page, the system will display all tags assigned to a student. However, the ‘inactive’ tags will have an italicized grey font, as well as an inactive icon to help easily distinguish between active and inactive student tags. As part of the changes for the student tags enhancement, the Tags filter found on the various student list pages throughout the UI will also only filter on active student tags.

My Dashboard—Add Tags Filter

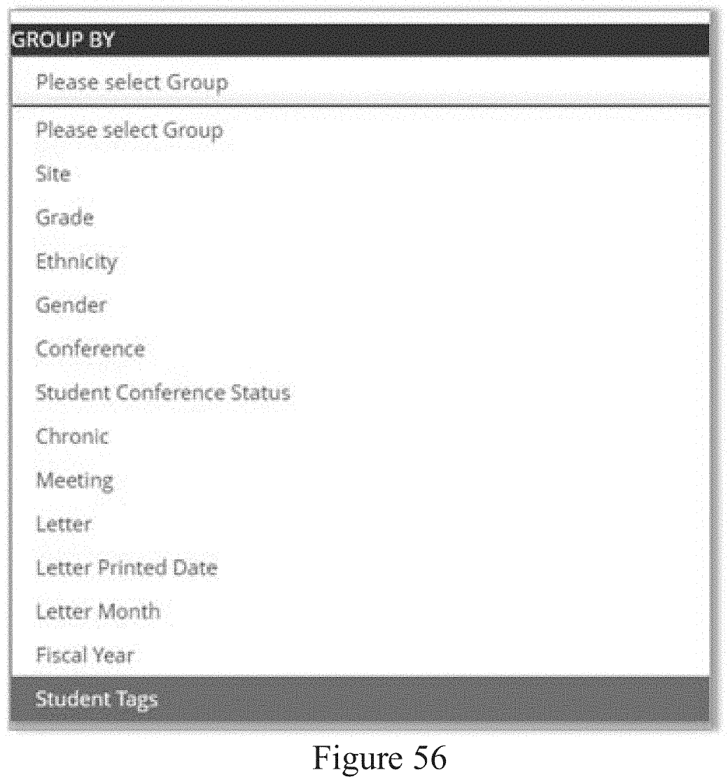

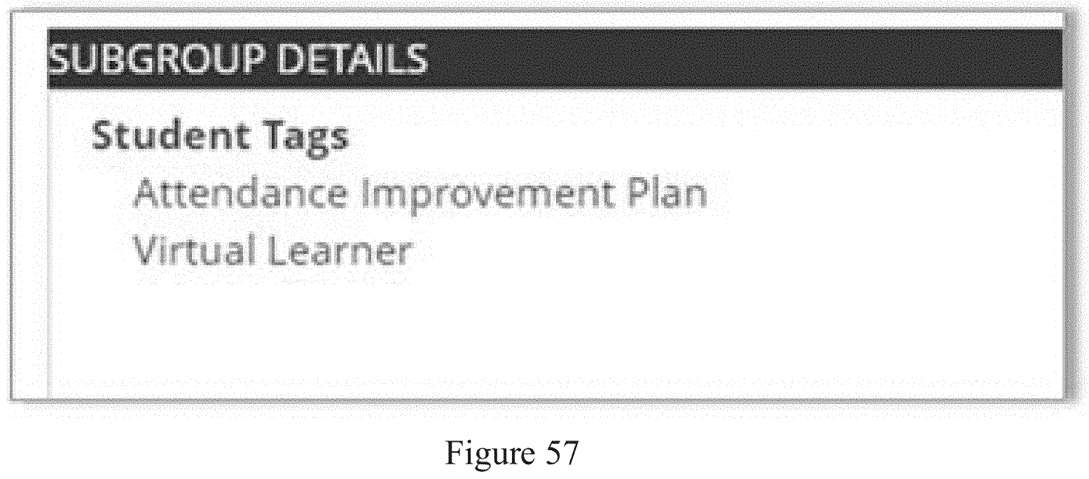

Referring now to FIGS. 56-57, since more districts are starting to use the tags feature, we have added a Student Tags filter to the Report Builder in My Dashboard. This will allow the users to create visualizations to monitor specific student populations. A ‘Student Tags’ filter has been added to the Group and Subgroup sections of the Report Builder. The available student will be determined by the student tags configured in the configurator.

Reports

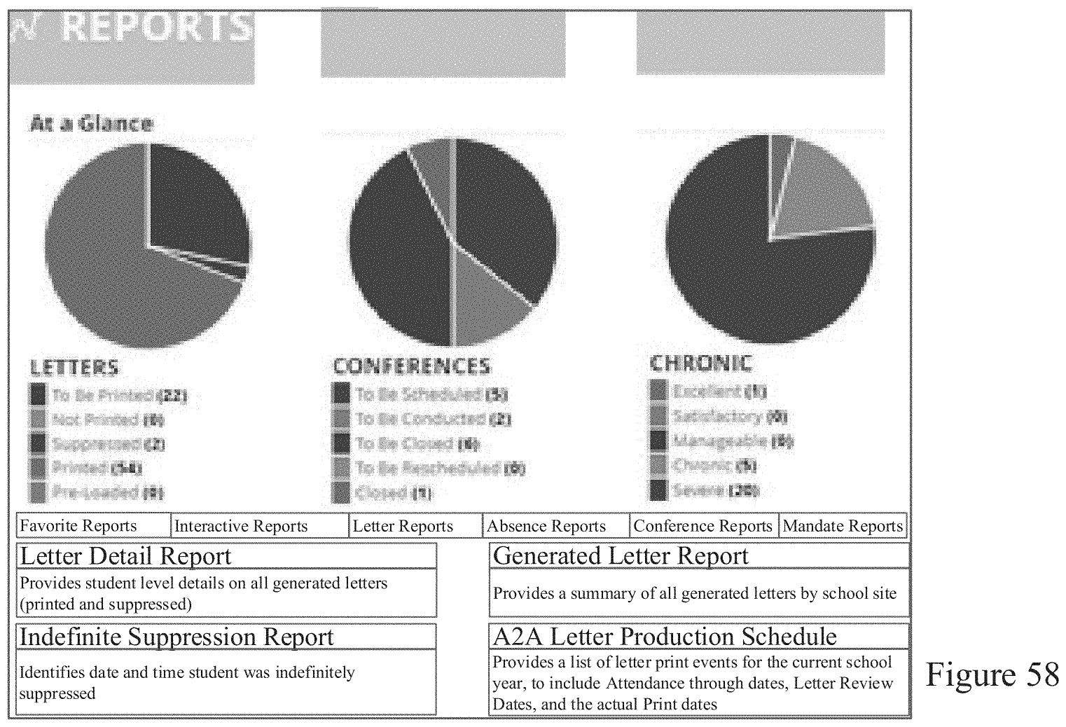

FIGS. 58 through 65 illustrate the additional features and enhancements for the reports and letter generation features supported by an example embodiment

New Internal SQL Server Reporting Services (SSRS) Report—Attendance Summary (Subgroup Info)

This new report includes all information found in the Attendance Summary Report in the UI. Additionally, we have added student level flags regarding subgroup information (i.e., English Language Learners, Free & Reduced Lunch, Foster Care, Homeless, etc.). The filter options in this report also allow internal users to run this report using various different attendance code options, and for a specific period of time. All of the values will be calculated based on the selected filters. This will allow us to utilize this report for various different report requests.

Split Site Breakout for Top 20 Absence Days and Total Absence Calendar

Users associated with a split site can now easily view their split site information in the Top 20 Absence Days and the Total Absence Calendar. We provided logic in the report filters to ensure that the split sites were not rolled up to the parent site. Now that split sites can be selected from the drop down menu, users only tied to split site will have the ability to view that information.

End-of-Year Status Report Changes

The End-of-Year status report template was changed to include letter counts for districts who sent distance learning letters, as well as subgroup breakouts for that population of students. In addition to the report template changes, the data load for the Report Repository was changed to allow data to be loaded based on a specific attendance through date. This was in response to districts' transition to a distance learning framework at different times this past spring. These changes will allow us to provide useful reporting, based on the individual district's needs.

Client District Site Report—Allow Report Section Selection

Users now have the ability to select which section of the Client District Site Report to export. A multi-select filter has been added to the report.

Reports Page Redesign

Referring now to FIG. 58, the Reports page has a new look and feel. The reports page will now display interactive visualizations at the top of the page, as well as reports sorted into different tabs based on category.

Interactive ‘at a Glance’ Visualizations

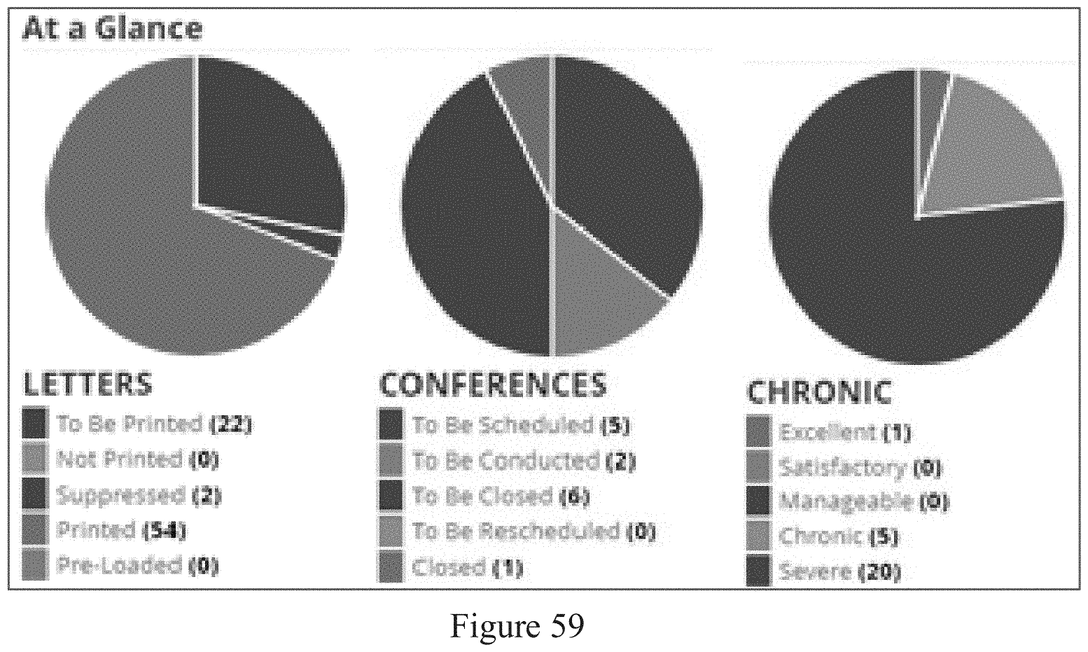

Referring now to FIG. 59, the visualizations at the top of the page display letter, conference, and chronic category information. These are intended to give high level view of a district's progress throughout the year. These visualizations will display the number of letters, conferences, or students in each respective category. Each pie piece and corresponding name in the legend act as links to various pages in the UI. As shown in FIG. 59 for an example embodiment, the page includes the following elements:
Letters
   To Be Printed category will take users to the ‘To Be Printed’ letters tab on the Letters page.
   Not Printed category will take users to the ‘Not Printed’ letters tab on the Letters page.
   Suppressed category will take users to the ‘Suppressed’ letters tab on the Letters page.
   Printed category will take users to the ‘Printed/Mailed’ letters tab on the Letters page.
   Pre-Loaded category will take users to the ‘Pre-Loaded’ letters tab on the Letters page.
Conferences
   To Be Scheduled category will take users to the ‘To Be Scheduled’ tab on the Conferences page.
   To Be Conducted category will take users to the ‘To Be Conducted’ tab on the Conferences page.
   To Be Closed category will take users to the ‘To Be Closed’ tab on the Conferences page.
   To Be Rescheduled category will take users to the ‘To Be Rescheduled’ tab on the Conferences page.
   Closed category will take users to the ‘Closed’ tab on the conferences page.
Chronic
   Excellent category will take users to the student list on the Students page, with the filter applied for students with an ‘Excellent’ absence category.
   Satisfactory category will take users to the student list on the Students page, with the filter applied for student with a ‘Satisfactory’ absence category.
   Manageable category will take users to the student list on the Students page, with the filter applied for students with a ‘Manageable’ absence category.
   Chronic category will take users to the student list on the Students page, with the filter applied for students with a ‘Chronic’ absence category.
   Severe category will take users to the student list on the Students page, with the filter applied for students with a ‘Severe’ absence category.

Previously, the ‘At a Glance’ pie charts on the Reports page only displayed the counts of letters, conferences, and students within their respective categories. These charts have been modified to show the corresponding percentage of the pie. If users would like to know the count of letters, conferences, or students for the given pie piece, they can simply hover over the desired pie slice. The tool tip will display the category, count, and corresponding percentage.

Favorites

We have given users the ability to bookmark their favorite reports. Users can mark a specific report as a ‘Favorite’ by clicking on a heart icon in top right-hand side of the individual report tile. Reports marked as ‘Favorite’ will show up in the ‘Favorites’ tab on the main reports page. If a user does not have any reports marked as ‘Favorite’ the ‘Favorites’ tab will not display. Users can also add reports to their ‘Favorites’ tab using the ‘Customize’ button.

Customize Button

There is a ‘Customize’ button on the top right-hand corner of the reports page. These settings only impact the reports on the ‘Favorites’ tab. From this button, users can perform among the following actions:
Change the order in which the reports appear on their ‘Favorites’ tab.
Add/Remove multiple reports to/from the ‘Favorites’ page.
Provide users with the option to display or not display the ‘At a Glance’ pie charts.
Provide users with the option to show the reports page when logging into the system.

New Filter on the Students Page

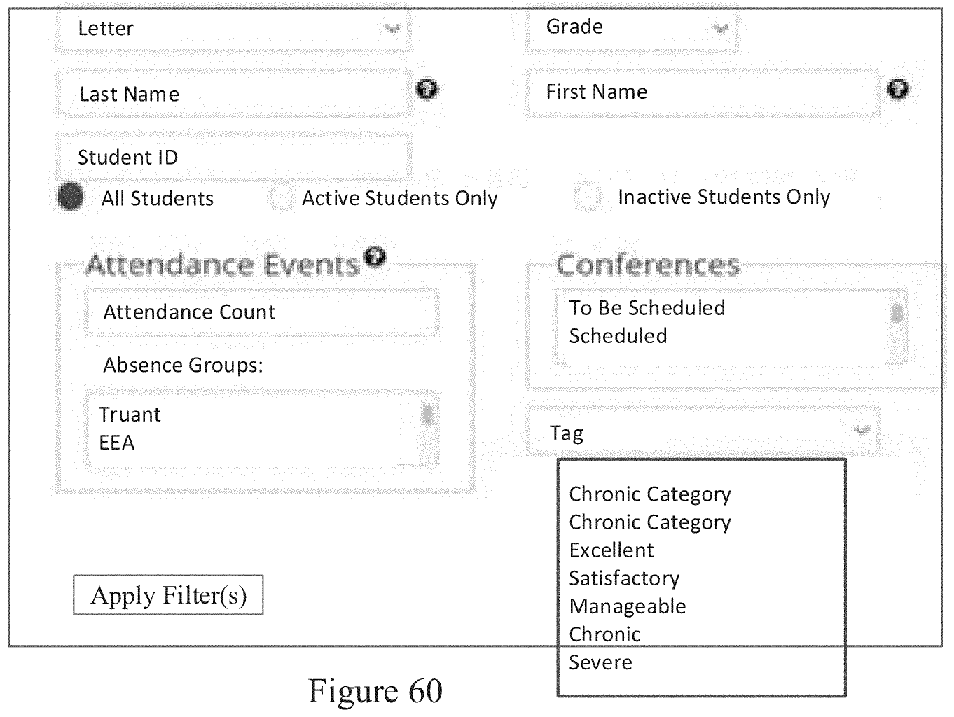

Referring now to FIG. 60, we have also added the ability to filter on the Students page, based on the chronic category. This can be done by selecting a chronic category from the dropdown filter options.

Interactive Code Usage Report

We have a new interactive report displaying excused and unexcused absence code usage that will allow users to drill down to a list of students using a respective absence code. This new report is located in the ‘Interactive Reports’ tab on the Reports page.

Filters (Part of the Interactive Code Usage Report)

Filters will default to the current fiscal year and Excused and Unexcused absences. Users can run this report for all, one, or several sites (site filter is multi-select). Attendance type can be Excused, Unexcused, or Excused and Unexcused. An Equivalent Day Threshold allows users to run the report for students who have missed a specified number of equivalent days or more. This feature allows users to run this report for students who have missed a large number of equivalent days due to excused and/or unexcused codes. If the user simply wants to view code usage, this threshold can be set to zero.

Report Chart (Part of the Interactive Code Usage Report)

The report displays the percent of students who meet the filter criteria (as well as the number of actual students). This report displays the code usage based on the filters. Each code can be clicked on to get the student level detail.

Student Level Detail (Part of the Interactive Code Usage Report)

In order to access student level information, the user can click on one of the codes listed in the bar chart. The selected code is listed at the top left-hand corner of the screen. The student level detail can show among the following information:
Student name
ID
Grade
Ethnicity
Code Usage: Number of times a student used the selected code
Total Code Usage: Number of times a student used any absence code
Proportion of Code Usage: Shows if this one code represents a large or small percentage of the student's overall code usage.

When exporting this report to Excel, the information included in the exported document is dependent on the page that was exported. For example, if exporting from the page with the chart, the document will include the chart. When exporting from the page with the student detail, the document will include the list of students and corresponding information.

UI Reports Changes

Because the ‘Interactive Reports’ and the ‘Absence Reports’ are the most frequently used reports, these reports are now the first two tabs on the Reports page in the example embodiment. We have renamed the pie chart and the severe category to match the attendance summary chart found in the reporting. Originally, the first three columns of the ‘Attendance Summary Report’ CSV export displayed ‘Textbox43’, ‘Textbox44’, ‘textbox45’. Those have been removed.

New Internal SSRS Report—Student Tags (Subgroup Info)

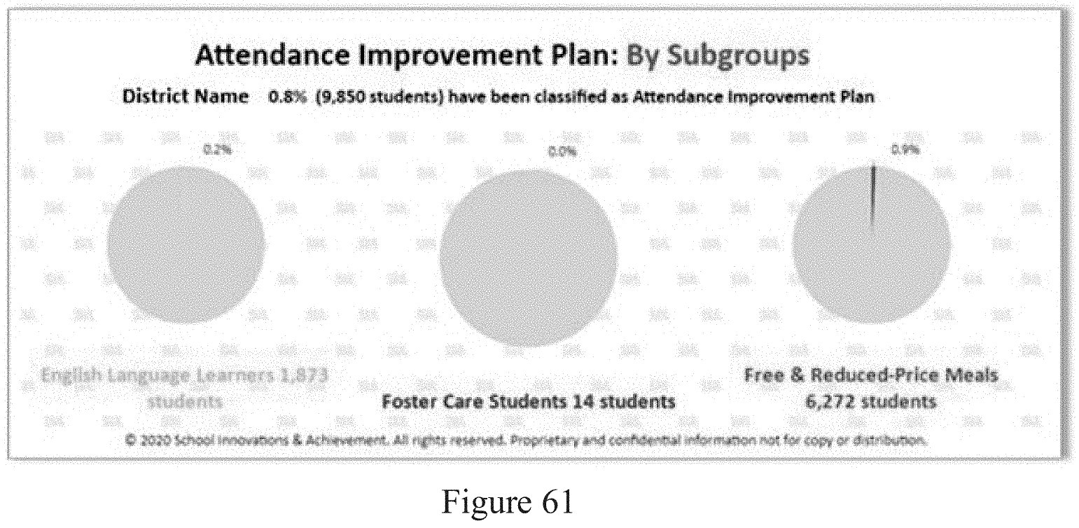

We created a new report to show the distribution of students who are assigned a student tag, who are also classified as a student in a subgroup. Referring to now FIG. 61, an example of an Attendance Improvement Plan report is shown. The report title will change based on the selected tag and the subgroups included in the report are based on the selected filters. This report will show the unique proportion of students in the respective subgroup that has the selected tag assigned to them (one or more times). The student count underneath each pie chart represents the total number of students within the respective subgroup population.

We have added a Student Tags filter to the ‘Attendance Summary (Subgroup Info)’ Report on the internal SSRS Report server. The filter will display the student tags currently used by the district. If the district is not using a student tag, this filter will only have ‘All Students’ available for filter selection.

New Internal SSRS Report—Student Chronic (Tagged Vs not-Tagged)

We now have a new internal SSRS report available. The report is titled ‘Student Chronic (Tagged vs. Not-Tagged)’. This report was created in response to various ad hoc report requests asking for chronic rates for a population using a specific tag, compared to the population not using that tag. This will allow the clients to determine if the population with a specific student tag has a higher or lower chronic rate compared to students without that tag.

In an example embodiment, the set of Report Filters can include:
Fiscal Year
District
Student Tag

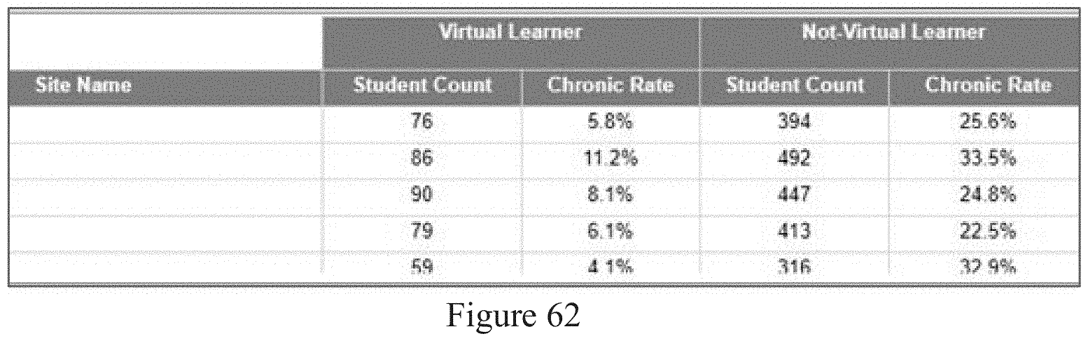

Referring to now FIG. 62, an example report is illustrated. The sample report, generated by an example embodiment, can show chronic information by site for the selected tag population and any student who has not been assigned the selected tag. The student count displays the active number of students who have been assigned a ‘Virtual Learner’ tag at the given site. (In the ‘Not-Virtual Learner’ column, the student count displays the active number of students who have not been assigned a ‘Virtual Learner’ tag). The report also shows corresponding chronic rates calculated for each population. There is also a district level calculation. If a tag has been assigned to students but is not currently active, they will be included in the ‘Tagged’ column.

Chronic By Subgroup (Model SARB) Report—SpEd Group Data and District Total Added

We have made an enhancement to the existing Chronic by Subgroup (Model SARB) internal SSRS Report. We have added a district level total. This will show the overall district level chronic rate for each of the respective subgroups. We have also included columns for Special Ed data. These new columns are labeled ‘Special Ed.’ and ‘Mainstream’. If we are not pulling these data elements for the respective district, the values in these columns are replaced with a dash ‘-’.

Mid-Year Report Template Changes

The mid-year report template of an example embodiment has been updated to include chronic rate of change metrics. The new slides display the chronic rate of change between the current year and the previous year for various populations. Also included in the template changes are breakouts, specific to the district's chronic student population. These slides display metrics like missed learning time and the number of students who can be saved from ending the year as a chronic student.

Concerns Detail Report

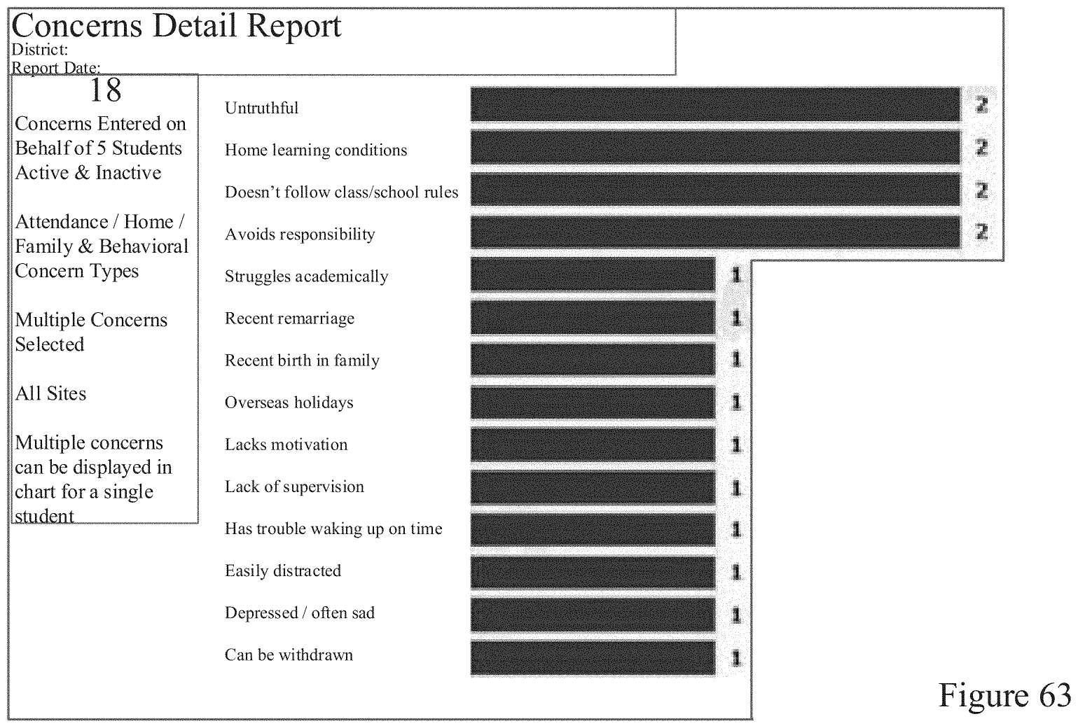

Referring to now FIG. 63, an example report is illustrated. The report is a new Student ‘Concerns Detail Report’ provided in the Interactive Reports tab in the system of an example embodiment. This report provides an overview of concerns code usage, while providing the corresponding list of students to help users monitor their progress. Users have the following filter options:
Fiscal year
Site Name
Student Status
Concern Type
Concern

The report will display the overall count of concerns that have been marked for students, the number of students who have one or more student concerns, and the respective usage. Individual student information will be listed below the chart. The report filter options will determine which students are shown in the report. All associated concerns for those students will be displayed in the chart, regardless of the specific concern or concern type filter selection. In the example visualization shown in FIG. 63, users will see the respective list of students, with their corresponding student information.

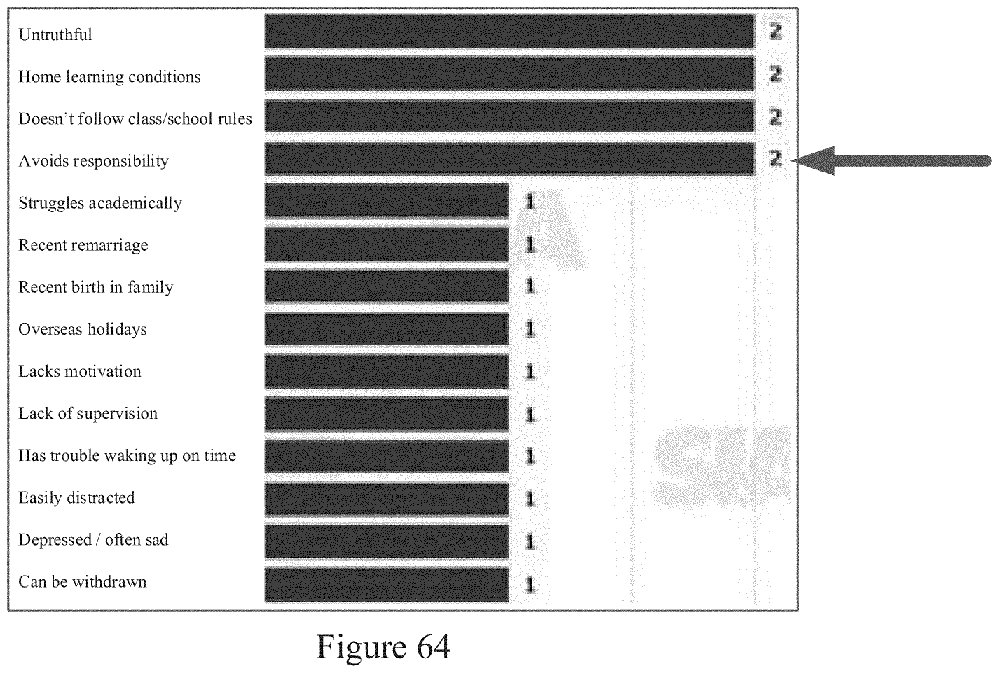

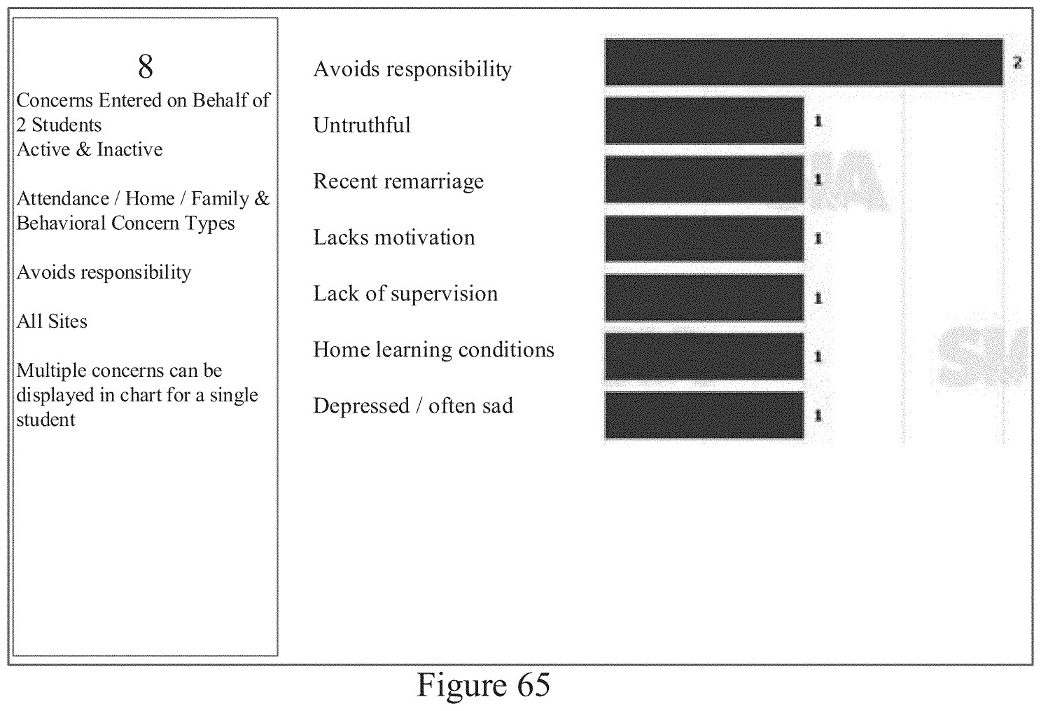

Referring to now FIGS. 64 and 65, another set of example reports is illustrated. Once a report is generated, users may want the ability to only focus on students who have a particular student concern. Users can simply click on the bar for the desired concern. The report will then filter only the students that have that respective concern. The newly filtered report will show the overall student concern count, student count, and respective student level information. When users wish to return to the main report, they can simply click on the ‘Back to Main Report’ button. The student concern information in this report will update as the student concerns are edited in the UI of the example embodiment. Any concern that is added to or removed from a student will be reflected in this report after the change is saved.

Student Overview Page

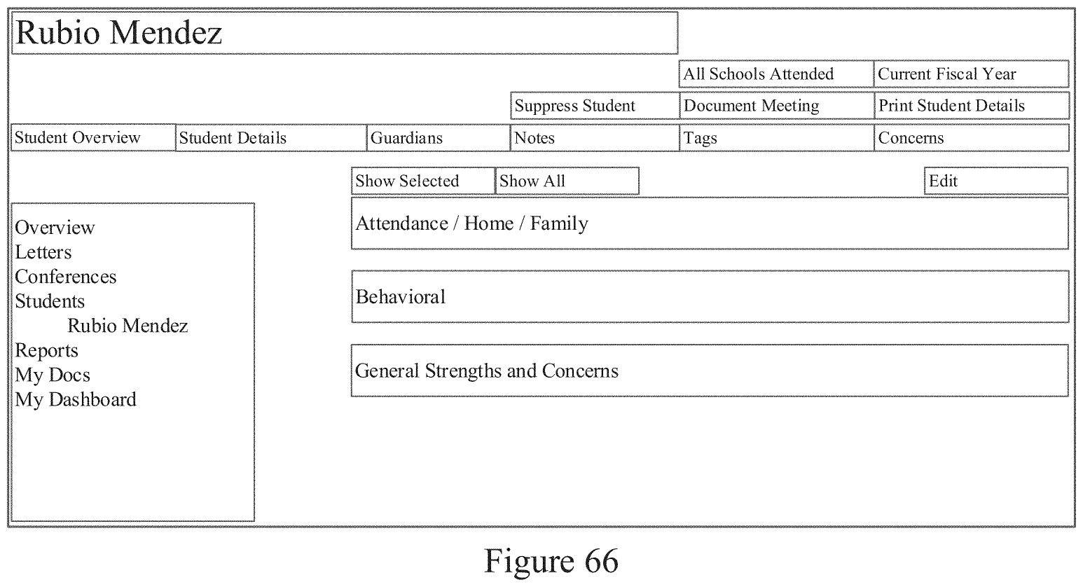

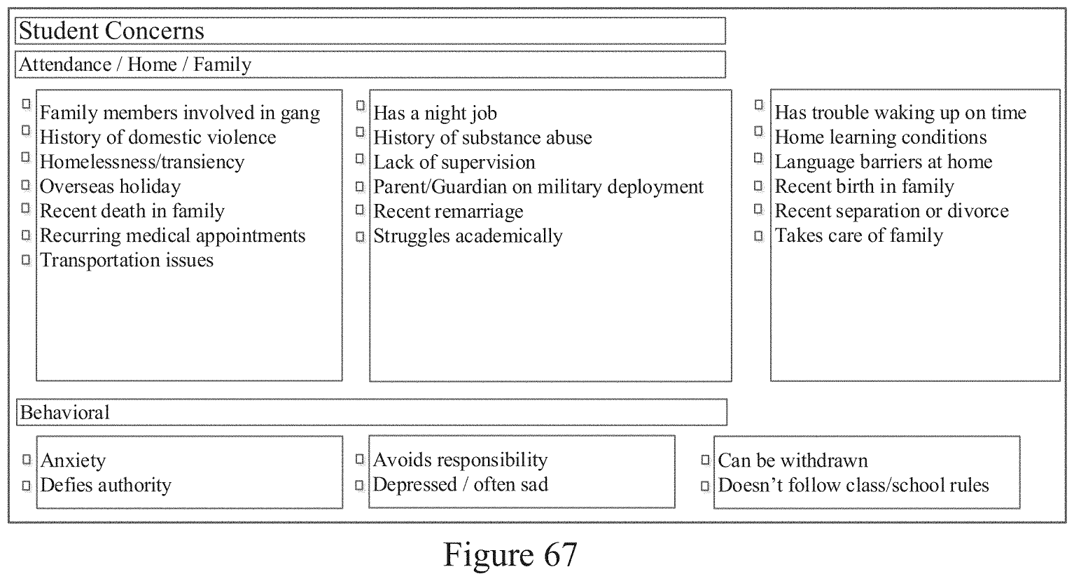

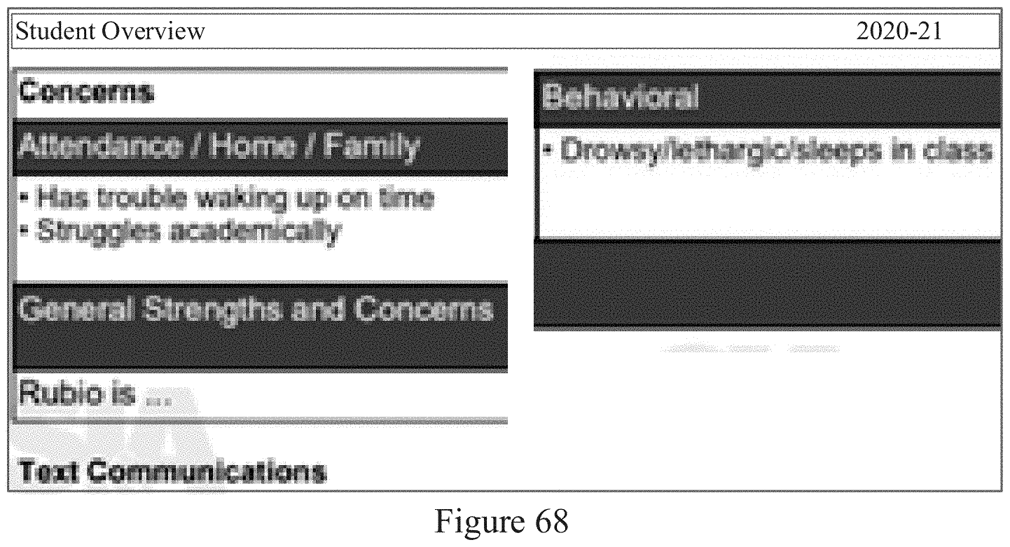

FIGS. 66 through 68 illustrate the additional features and enhancements for the Student Overview features supported by an example embodiment. In the example embodiment, we added a new “Concerns” section within the system, giving the end-users the option to complete additional information about their student that may have an impact on their attendance problems. The concern options placed in the application are more specific to Attendance/Home/Family as well as Behavioral and are editable by any authorized application user. A new Tab named “Concerns” has been added with a section to display the Student Concern(s) information on the student details page. An end-user can create, edit, and save any student specific data that they would like to include regarding the student and their attendance related concerns. In the system of an example embodiment, there are three built-in accordion sections: Attendance/Home/Family, Behavioral, and a General Strengths and Concerns section for the end-user to type in a short narrative when needed. For example, the sample screenshot shown in FIG. 66 is how the new page will initially look when the ‘Show Selected’ option is selected and there is no concern data entered and saved for the selected student. Referring to the sample screenshot shown in FIG. 67, this screenshot shows an example of the dialogue box that will appear upon selecting the ‘Edit’ button found in the upper right area of the Concerns section page. Once the Student Concerns have been marked, comments made and saved, the UI page will show what has been selected. The fields in this new Student Concerns section are optional for the end-user (e.g. Attendance Clerk, Counselor, Site Administrator, etc.) to complete. The UI will show the ‘Last modified by’ and ‘Last modified date’. The “Show All” button will allow the end-user to view all of the options within each accordion section. Upon selecting the “Show All” button, the General Strengths & Concerns section, originally programmed to be collapsed by default so the end-user is encouraged to complete the applicable checkboxes first, will show all data. The General Strengths & Concerns narrative section character maximum is 500. The end of the Student Overview Report will now include a “Concerns” section. For example, the sample screenshot shown in FIG. 68 captures the selected Concerns and General Strengths and Concerns notated in the UI about the student.

Conferencing

When a user schedules a conference less than eight days in the future, the UI will now display a red warning flag saying, ‘Will Not Mail Letter’ instead of ‘Don't Send’. This was an aesthetic change that did not modify the existing logic. The conference workflow will work as expected. In an effort to improve performance in the conferencing pages in example embodiment, we have modified the queries on various conferencing pages to decrease the number of times the page needs to access and pull data from the database.

Letter Print

As part of the efforts to improve the performance of the letter print process, we have made changes to how the district data is processed. Previously, our districts would process letters one at a time. If one district threw an error, the process would stop until the error was corrected, and the job restarted. Therefore, any district that threw an error would prevent the remaining districts from processing until it was corrected. In an example embodiment, a new bulk processing method is provided. We have rewritten the letter print procedure to process districts simultaneously. This will cut down the processing time substantially by running multiple districts at the same time. This also has the added benefit of allowing the remaining districts to continue processing if one or more districts run into an error. This implementation provides performance enhancements due to this new bulk letter process for attendance letters, conference notifications, and optional letters. The day-to-day steps performed by the operations will not change, the letters should simply process faster.

We have made changes to the data load and optional letter processes to identify and generate Distance Learning Letters for students. Regardless of whether or not a district tracks distance learning information, we have the ability to flag students the district wishes to receive a letter. We will change their student status and generate these letters using the optional letter process of an example embodiment. This will ensure that we do not interfere with the regular attendance letter generation process. These letters are displayed in the UI under the Achievement Initiative letter section on the student details page. Changes to the Optional Letter Module include: 1) Distance Learning Letter option from Letter Type drop down menu, and 2) New student filter for specific di stance learning letter.

We no longer have to manually add site level contact information into the optional letter module. We can use the new bulk option to import contact information instantly. The new import option is found under the ‘Sites and Signatures’ area of the new letter configuration page. These new options are listed in a drop down menu at the bottom right-hand corner of the page. The two new options are found out the bottom of the list and, once selected, will populate level one contact information for each site. This new feature will substantially reduce the time it takes to build an optional letter configuration.

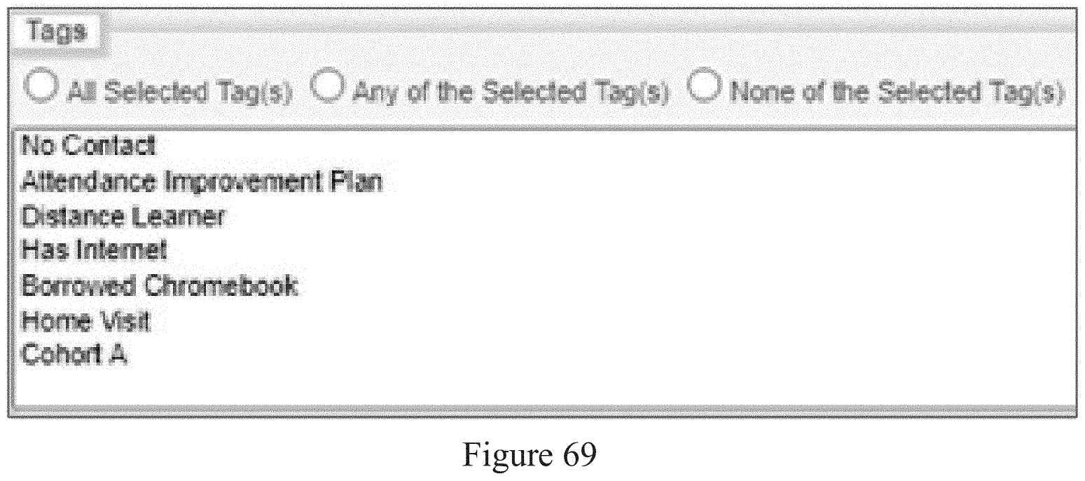

FIG. 69 illustrates the additional features and enhancements for the Student Tags Filter for Optional Letters features supported by an example embodiment. We now have the ability to trigger optional letters off of specific student tags. This will serve as a great option for the No Contact letter, as districts will be able to select the exact students whom they wish to receive the letter. This will help avoid complicated letter trigger configurations. New filters have been added to the ‘Student and Letter Criteria’. All tags available to the selected district will be listed in the filter box on the bottom right-hand side of the accordion menu. In the example embodiment shown in FIG. 69, there are three option to select:
All Selected Tag(s)—The student must have all of the selected tags in order to be receive the letter (Use this option if you are only selecting one tag, or the district would like to select students who have a specific combination of tags)
Any of the Selected Tag(s)—The student must have at least one of the selected tags in order to receive the letter (Use this option if the district would like to send the letter to students who have one tag or another)
None of the Selected Tag(s)—The student must NOT HAVE any of the selected tags in order to receive the letter (Use this option if the district would like to send the letter to any students who do not have a given tag)

The filter only considers ‘Active Tags’. This includes students with tags that:
Have no start or end dates
Have a start date that falls before the date this letter is generated, and have no end date
Have a start date that falls before the date this letter is generated, and have an end date that falls after the letter is generated

All other filters and functionality remains the same. When configuring these specific letters, the user may want to select ‘Other’ for letter type. This will allow the user to type in the specific letter description.

Ghost Student Logic

Ghost Student is a term that indicates that we received data for these students at some point during the year (usually during the initial test pull for the year), but we are not currently receiving data for them. The student has been removed from the district's data. Because we no longer received data for these students, we did not have a way to update their student status records to ‘Inactive’. Therefore, they were incorrectly included in optional letter mailings and chronic calculations. We now have a systematic approach to handling these ghost students. For any student identified as a ‘ghost student’, we will change their student status to a unique internal code mapped as ‘inactive.’ The system will check for these students each time district data is uploaded into the system. In the UI, these students will be shown as inactive and a small icon will be displayed next to their student status. A tooltip stating that the student is missing from the latest upload will also appear when users hover over the ghost icon. These students will no longer run the risk of mistakenly receiving an optional letter, and the district no longer has to go back and modify the dataset they provide. This change will help streamline the process and improve the accuracy of letter mailings and district level chronic calculations.

Additionally, we now have logic in place that will remove generated letters if a student is indefinitely suppressed. There are times when a user indefinitely suppresses a student, but does not realize that they have generated a letter in that same review period. This logic will remove those letters when the student is suppressed.

In the various embodiments described herein, a system and method for student attendance management are disclosed. The various embodiments provide the ability to detect chronic absenteeism early, and then intervene or deter chronic absenteeism. The various embodiments standardize student attendance records of all schools within a school district and all districts in a given area, automatically track absences on a daily basis, and provide automatic and prompt notification when an individual student's truancy reaches a threshold requiring a response.

In various embodiments described herein, a software application program is used to gather, process, and distribute school information, including attendance data, using a computer system, a web appliance, a mobile device, and a data network. As described in more detail herein, the computer or computing system on which the described embodiments can be implemented can include personal computers (PCs), portable computing devices, laptops, tablet computers, personal digital assistants (PDAs), personal communication devices (e.g., cellular telephones, smartphones, or other wireless devices), network computers, set-top boxes, consumer electronic devices, or any other type of computing, data processing, communication, networking, or electronic system. In the described embodiments, a data network ecosystem enabled via a wide area data network (e.g., the Internet) enables the various components of the system to communicate internally via a conventional wide area data network and/or an intranet or local area network (LAN). As a result, the various embodiments described herein are necessarily rooted in computer and network technology and serve to improve these technologies when applied in the manner as presently claimed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computer-implemented method comprising:
installing a site-resident data collection module in a site location, the site-resident data collection module including instructions executing within an executable environment of the site location, the site-resident data collection module further including a first data interface enabling data communication between the site-resident data collection module and a legacy data processing system of the site location;
using the site-resident data collection module to collect student information, attendance data, and other site data from the site location;
transferring the site data to a host location;
performing, by a data processor, data transformation and normalization operations on the site data to convert the site data to a common format, the data transformation and normalization operations including district-specific data transformation rules;
performing, by the data processor, district configuration operations to configure rules specifying how and when alerts can be sent to recipients based on the site data;
performing, by the data processor, scheduling and reporting operations to generate and distribute alerts, including attendance letters, to recipients based on the site data and the configured rules; and
creating and sending custom text messages to recipients based on the site data.

2. The method of claim 1 including enabling the editing of content of a text message via a user interface.

3. The method of claim 1 including using a text message to schedule a conference.

4. The method of claim 1 including providing a student overview page including information related to concerns corresponding to a particular student.

5. The method of claim 1 including providing a student overview page including information related to concerns corresponding to a particular student, the student overview page including text message correspondence with the student.

6. The method of claim 1 including providing a student oversight dashboard including information related to student attendance trends on a periodic basis.

7. The method of claim 1 including providing a student oversight dashboard including information related to student attendance trends on a periodic basis, the dashboard providing a drill down feature enabling access to more detailed information for a specific topic.

8. The method of claim 1 including providing a virtual meeting type for scheduling virtual meetings.

9. The method of claim 1 including enabling a user to copy a chart to the user's clipboard.

10. A system comprising:
a data processor;
a network interface, in data communication with the data processor, for communication on a data network; and
a student attendance management system, executable by the data processor, to:
cause installation of a site-resident data collection module in a site location, the site-resident data collection module including instructions executing within an executable environment of the site location, the site-resident data collection module further including a first data interface enabling data communication between the site-resident data collection module and a legacy data processing system of the site location;
interface with the site-resident data collection module to collect student information, attendance data, and other site data from the site location;
cause transfer of the site data to a host location;
perform data transformation and normalization operations on the site data to convert the site data to a common format, the data transformation and normalization operations including district-specific data transformation rules;
perform district configuration operations to configure rules specifying how and when alerts can be sent to recipients based on the site data;
perform scheduling and reporting operations to generate and distribute alerts, including attendance letters, to recipients based on the site data and the configured rules; and
create and send custom text messages to recipients based on the site data.

11. The system of claim 10 being further configured to enable the editing of content of a text message via a user interface.

12. The system of claim 10 being further configured to use a text message to schedule a conference.

13. The system of claim 10 being further configured to provide a student overview page including information related to concerns corresponding to a particular student.

14. The system of claim 10 being further configured to provide a student overview page including information related to concerns corresponding to a particular student, the student overview page including text message correspondence with the student.

15. The system of claim 10 being further configured to provide a student oversight dashboard including information related to student attendance trends on a periodic basis.

16. The system of claim 10 being further configured to provide a student oversight dashboard including information related to student attendance trends on a periodic basis, the dashboard providing a drill down feature enabling access to more detailed information for a specific topic.

17. The system of claim 10 being further configured to provide a virtual meeting type for scheduling virtual meetings.

18. The system of claim 10 being further configured to enable a user to copy a chart to the user's clipboard.

19. A non-transitory machine-useable storage medium embodying instructions which, when executed by a machine, cause the machine to:
cause installation of a site-resident data collection module in a site location, the site-resident data collection module including instructions executing within an executable environment of the site location, the site-resident data collection module further including a first data interface enabling data communication between the site-resident data collection module and a legacy data processing system of the site location;
interface with the site-resident data collection module to collect student information, attendance data, and other site data from the site location;
cause transfer of the site data to a host location;
perform data transformation and normalization operations on the site data to convert the site data to a common format, the data transformation and normalization operations including district-specific data transformation rules;
perform district configuration operations to configure rules specifying how and when alerts can be sent to recipients based on the site data;
perform scheduling and reporting operations to generate and distribute alerts, including attendance letters, to recipients based on the site data and the configured rules; and
create and send custom text messages to recipients based on the site data.

20. The machine-useable storage medium of claim 19 being further configured to provide a student overview page including information related to concerns corresponding to a particular student.
